(19) United States
(12) Patent Application Publication
(10) Pub. No.: US 2025/0356618 A1
(43) Pub. Date: Nov. 20, 2025

(54) COMPUTERIZED SYSTEMS AND METHODS FOR ELECTRONIC IMAGE ANALYSIS FOR IDENTIFYING CELLS

(71) Applicant: Singular Genomics Systems, Inc., San Diego, CA (US)

(72) Inventors: Eli N. Glezer, Del Mar, CA (US); Kenneth Howard Gouin, III, Oceanside, CA (US)

(21) Appl. No.: 19/206,493

(22) Filed: May 13, 2025

Related U.S. Application Data
(60) Provisional application No. 63/647,308, filed on May 14, 2024.
(60) Provisional application No. 63/652,827, filed on May 29, 2024.
(60) Provisional application No. 63/680,321, filed on Aug. 7, 2024.
(60) Provisional application No. 63/691,175, filed on Sep. 5, 2024.

(51) Int. Cl. G06V 10/762; G06T 7/00; G06V 10/40; G06V 10/774; G06V 10/82; G06V 20/69

(52) U.S. Cl. CPC G06V 10/762; G06T 7/0012; G06V 10/40; G06V 10/774; G06V 10/82; G06V 20/69

(57) ABSTRACT

Disclosed herein, inter alia, are computer-implemented methods for analyzing electronic images of a tissue sample.

### CROSS-REFERENCES TO RELATED APPLICATIONS

This application claims the benefit of U.S. Provisional Application No. 63/691,175, filed Sep. 5, 2024, U.S. Provisional Application No. 63/680,321, filed Aug. 7, 2024, U.S. Provisional Application No. 63/652,827, filed May 29, 2024, and U.S. Provisional Application No. 63/647,308, filed May 14, 2024, each of which are incorporated herein by reference in their entirety and for all purposes.

### BACKGROUND

In the quest to unravel the complexities of spatial biology, current research aims to address the challenge of achieving whole-transcriptome (WT) tissue analysis with single-cell resolution. Interest in whole transcriptome analysis, particularly in the context of spatial biology, stems from the desire to understand the complex dynamics of gene expression within the native architectural context of tissues. Gaining insight into the WT for a tissue section crucial for unraveling the mechanisms of development, disease progression, and response to treatments at a resolution that was not previously accessible. Spatial biology technologies integrate gene expression data with the precise locations of those expressions within a tissue, enabling an understanding of how cells interact within their microenvironment and how these interactions contribute to tissue function, development, and disease pathology. Indeed, the ability to localize hundreds of macromolecules to discrete locations, structures, and cell types in a tissue is a powerful approach to understand the cellular and spatial organization of an organ. The push to increase the number of genes analyzed by in situ platforms is met with a key limitation of current technologies: the balance between breadth (number of genes analyzed) and resolution (spatial and/or cellular detail). The volume of a cell represents a finite constraint limiting detection of all 20,000-25,000 protein-coding genes. Disclosed herein, inter alia, are solutions to these and other problems in the art.

### BRIEF SUMMARY

In view of the foregoing, there is a need for an effective solution to these and other problems in the art. In an aspect is provided a system for analyzing a sample (e.g., a tissue sample) including a plurality of cells. In another aspect is provided a method (e.g., a computer-implemented method) of analyzing a tissue sample including a plurality of cells. In yet another aspect is provided a method (e.g., a computer-implemented method) for analyzing the transcriptome of a tissue sample.

### BRIEF DESCRIPTION OF THE DRAWINGS

FIGS. 1A-1C. Illustrated is a tissue sample detected with a typical spatial barcode method, FIG. 1A, wherein each circle represents a 100 μm patch of barcoded capture oligonucleotides. Using existing spatial barcoding techniques (e.g., Visium™), the aggregation of the sequencing reads from the single 100 μm patch blurs the boundary of two distinct cell types, depicted as a light and dark shaded collection of cells, and would incorrectly assign the transcript information from the dominant cell type. For example, FIG. 1B, illustrations spatial barcoding as applied to a kidney tissue section, where all cells within the barcoded spot area (˜100 um diameter) get lumped together, resulting in features from collecting tubules would be averaged together with reads from distal tubules, and glomeruli would be lumped together with blood vessels and proximal tubules. This contrasts with the methods described herein, illustrated in FIG. 1C.

FIGS. 2A-2C. A tissue sample is probed with a high depth cell gene panel (i.e., a cell classification panel) targeting genes useful at identifying cell phenotypes. Following binding and detection, the probes and cells may be classified using unsupervised clustering techniques such as UMAP and tSNE, to identify regions of similarity. Each region of similarity is contained by a dashed line within the tissue in FIG. 2A. FIG. 2B shows the same tissue section being probed and detected with a whole-transcriptome panel, wherein one region identified with the cell classification panel is magnified to illustrate cells containing dots indicative of illuminated targets from the WT panel. Collectively, the information gained from the cell classification panel and the whole transcriptome panel enables an in depth understanding of the whole transcriptome of the tissue sample, illustrated in FIG. 2C.

FIG. 3 provides an embodiment for aggregation based on spatial proximity. The process starts with a comprehensive cell-typing phase where individual cells (depicted as grey circles) are analyzed using a small panel that provides deep coverage and is useful for identifying cell types or states based on a selected subset of genes that are informative of cell identity. Next, the cells undergo whole transcriptome analysis with shallow coverage. This is depicted by transitioning from the initial grey circles to colored circles, where each color represents a different cell type (e.g., cell types A, B, and C). This step aims to broaden the genetic information obtained by capturing a wider array of gene expressions across all cells but with lesser depth compared to the first panel. Cells are then grouped into neighborhoods based on spatial proximity and possibly other phenotypic or transcriptional similarities. This is represented by cells of the same or related types clustering together within delineated neighborhoods (e.g., Neighborhood 1 with blue and green cells; Neighborhood 2 with pink and green cells). For each neighborhood, data from cells of the same type are aggregated to enhance the statistical power and reliability of the data analysis. For example, in Neighborhood 1, data from 9 cells of type B and 6 cells of type A are aggregated. Similarly, in Neighborhood 2, data from 8 cells of type B and 6 cells of type C are aggregated. The aggregated data enables a more robust analysis of each cell type within its respective neighborhood, facilitating insights into how different cell types interact and function together in a tissue-specific context.

FIG. 4 provides an embodiment for aggregation based on cell-to-cell interactions. The first panel (left) shows cells typed using a small panel with deep coverage. This involves detailed analysis of a limited number of gene sequences (e.g., 20-500), providing high-resolution data on relatively few markers. The second panel (middle) represents cells after being subjected to whole transcriptome analysis (i.e., the second probe set) with shallow coverage, which expands the scope of genetic analysis but with less depth per gene compared to the first panel and helps in identifying broader genetic activity across more genes. The third panel (right) shows the aggregation process where cells of similar types or those showing specific interactions (like cell type B interacting with cell type A) are grouped together. The numbers (10 and 2) indicate the count of individual cells contributing to each aggregated data point, providing insights into the frequency and strength of these interactions.

FIG. 5 depicts an example system that may execute techniques and methods presented herein.

FIG. 6 is a flowchart illustrating a non-limiting exemplary method, using machine learning, according to an embodiment of the present disclosure.

FIG. 7 is a flowchart illustrating an exemplary method, using machine learning, according to an embodiment of the present disclosure.

### DETAILED DESCRIPTION

The aspects and embodiments described herein relate to analyzing a tissue sample, which includes distinct steps designed to profile and understand cellular compositions based on at least gene expression.

### I. Definitions

All patents, patent applications, articles and publications mentioned herein, both supra and infra, are hereby expressly incorporated herein by reference in their entireties, including but not limited to Application No. 63/647,308, filed May 14, 2024; Application No. 63/652,827, filed May 29, 2024; and Application No. 63/680,321, filed Aug. 7, 2024. The practice of the technology described herein will employ, unless indicated specifically to the contrary, conventional methods of chemistry, biochemistry, organic chemistry, molecular biology, bioinformatics, microbiology, recombinant DNA techniques, genetics, immunology, and cell biology that are within the skill of the art, many of which are described below for the purpose of illustration. Examples of such techniques are available in the literature. See, e.g., Singleton et al., DICTIONARY OF MICROBIOLOGY AND MOLECULAR BIOLOGY 2nd ed., J. Wiley & Sons (New York, NY 1994); and Sambrook and Green, Molecular Cloning: A Laboratory Manual, 4th Edition (2012). Methods, devices and materials similar or equivalent to those described herein can be used in the practice of this invention.

Unless defined otherwise herein, all technical and scientific terms used herein have the same meaning as commonly understood by one of ordinary skill in the art to which this disclosure belongs. Various scientific dictionaries that include the terms included herein are well known and available to those in the art. Although any methods and materials similar or equivalent to those described herein find use in the practice or testing of the disclosure, some preferred methods and materials are described. Accordingly, the terms defined immediately below are more fully described by reference to the specification as a whole. It is to be understood that this disclosure is not limited to the particular methodology, protocols, and reagents described, as these may vary, depending upon the context in which they are used by those of skill in the art. The following definitions are provided to facilitate understanding of certain terms used frequently herein and are not meant to limit the scope of the present disclosure.

As used herein, the singular terms “a”, “an”, and “the” include the plural reference unless the context clearly indicates otherwise. Reference throughout this specification to, for example, “one embodiment”, “an embodiment”, “another embodiment”, “a particular embodiment”, “a related embodiment”, “a certain embodiment”, “an additional embodiment”, or “a further embodiment” or combinations thereof means that a particular feature, structure or characteristic described in connection with the embodiment is included in at least one embodiment of the present disclosure. Thus, the appearances of the foregoing phrases in various places throughout this specification are not necessarily all referring to the same embodiment. Furthermore, the particular features, structures, or characteristics may be combined in any suitable manner in one or more embodiments.

As used herein, the term “about” means a range of values including the specified value, which a person of ordinary skill in the art would consider reasonably similar to the specified value. In embodiments, the term “about” means within a standard deviation using measurements generally acceptable in the art. In embodiments, about means a range extending to +/−10% of the specified value. In embodiments, about means the specified value.

Throughout this specification, unless the context requires otherwise, the words “comprise”, “comprises” and “comprising” will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

As used herein, the term “control” or “control experiment” is used in accordance with its plain and ordinary meaning and refers to an experiment in which the subjects or reagents of the experiment are treated as in a parallel experiment except for omission of a procedure, reagent, or variable of the experiment. In some instances, the control is used as a standard of comparison in evaluating experimental effects.

As used herein, the term “complement” is used in accordance with its plain and ordinary meaning and refers to a nucleotide (e.g., RNA nucleotide or DNA nucleotide) or a sequence of nucleotides capable of base pairing with a complementary nucleotide or sequence of nucleotides (e.g., Watson-Crick base pairing). As described herein and commonly known in the art the complementary (matching) nucleotide of adenosine is thymidine and the complementary (matching) nucleotide of guanosine is cytosine. Thus, a complement may include a sequence of nucleotides that base paired with corresponding complementary nucleotides of a second nucleic acid sequence. The nucleotides of a complement may partially or completely match the nucleotides of the second nucleic acid sequence. Where the nucleotides of the complement completely match each nucleotide of the second nucleic acid sequence, the complement forms base pairs with each nucleotide of the second nucleic acid sequence. Where the nucleotides of the complement partially match the nucleotides of the second nucleic acid sequence only some of the nucleotides of the complement form base pairs with nucleotides of the second nucleic acid sequence. Examples of complementary sequences include coding and non-coding sequences, wherein the non-coding sequence contains complementary nucleotides to the coding sequence and thus forms the complement of the coding sequence. Another example of complementary sequences are a template sequence and an amplicon sequence polymerized by a polymerase along the template sequence. “Duplex” means at least two oligonucleotides and/or polynucleotides that are fully or partially complementary undergo Watson-Crick type base pairing among all or most of their nucleotides so that a stable complex is formed. Complementary single stranded nucleic acids and/or substantially complementary single stranded nucleic acids can hybridize to each other under hybridization conditions, thereby forming a nucleic acid that is partially or fully double stranded. When referring to a double-stranded polynucleotide including a first strand hybridized to a second strand, it is understood that each of the first strand and the second strand are independently single-stranded polynucleotides. All or a portion of a nucleic acid sequence may be substantially complementary to another nucleic acid sequence, in some embodiments. As referred to herein, “substantially complementary” refers to nucleotide sequences that can hybridize with each other under suitable hybridization conditions. Hybridization conditions can be altered to tolerate varying amounts of sequence mismatch within complementary nucleic acids that are substantially complementary. Substantially complementary portions of nucleic acids that can hybridize to each other can be 75% or more, 76% or more, 77% or more, 78% or more, 79% or more, 80% or more, 81% or more, 82% or more, 83% or more, 84% or more, 85% or more, 86% or more, 87% or more, 88% or more, 89% or more, 90% or more, 91% or more, 92% or more, 93% or more, 94% or more, 95% or more, 96% or more, 97% or more, 98% or more or 99% or more complementary to each other. In some embodiments substantially complementary portions of nucleic acids that can hybridize to each other are 100% complementary. Nucleic acids, or portions thereof, that are configured to hybridize to each other often include nucleic acid sequences that are substantially complementary to each other.

As described herein, the complementarity of sequences may be partial, in which only some of the nucleic acids match according to base pairing, or complete, where all the nucleic acids match according to base pairing. Thus, two sequences that are complementary to each other, may have a specified percentage of nucleotides that complement one another (e.g., about 60%, preferably 65%, 70%, 75%, 80%, 85%, 90%, 91%, 92%, 93%, 94%, 95%, 96%, 97%, 98%, 99%, or higher complementarity over a specified region). In embodiments, two sequences are complementary when they are completely complementary, having 100% complementarity. In embodiments, sequences in a pair of complementary sequences form portions of a single polynucleotide with non-base-pairing nucleotides (e.g., as in a hairpin or loop structure, with or without an overhang) or portions of separate polynucleotides. In embodiments, one or both sequences in a pair of complementary sequences form portions of longer polynucleotides, which may or may not include additional regions of complementarity.

As used herein, the term “contacting” is used in accordance with its plain ordinary meaning and refers to the process of allowing at least two distinct species (e.g., chemical compounds including biomolecules, particles, solid supports, or cells) to become sufficiently proximal to react, interact or physically touch. It should be appreciated, however, that the resulting reaction product can be produced directly from a reaction between the added reagents or from an intermediate from one or more of the added reagents which can be produced in the reaction mixture. The term “contacting” may include allowing two species to react, interact, or physically touch, wherein the two species may be a compound as described herein and a protein or enzyme.

As may be used herein, the terms “nucleic acid,” “nucleic acid molecule,” “nucleic acid sequence,” “strand,” “nucleic acid fragment” and “polynucleotide” are used interchangeably and are intended to include, but are not limited to, a polymeric form of nucleotides covalently linked together that may have various lengths, either deoxyribonucleotides or ribonucleotides, or analogs, derivatives or modifications thereof. Different polynucleotides may have different three-dimensional structures, and may perform various functions, known or unknown. Non-limiting examples of polynucleotides include a gene, a gene fragment, an exon, an intron, intergenic DNA (including, without limitation, heterochromatic DNA), messenger RNA (mRNA), transfer RNA, ribosomal RNA, a ribozyme, cDNA, a recombinant polynucleotide, a branched polynucleotide, a plasmid, a vector, isolated DNA of a sequence, isolated RNA of a sequence, a nucleic acid probe, and a primer. Polynucleotides useful in the methods of the disclosure may include natural nucleic acid sequences and variants thereof, artificial nucleic acid sequences, or a combination of such sequences. As may be used herein, the terms “nucleic acid oligomer” and “oligonucleotide” are used interchangeably and are intended to include, but are not limited to, nucleic acids having a length of 200 nucleotides or less. In some embodiments, an oligonucleotide is a nucleic acid having a length of 2 to 200 nucleotides, 2 to 150 nucleotides, 5 to 150 nucleotides or 5 to 100 nucleotides. The terms “polynucleotide,” “oligonucleotide,” “oligo” or the like refer, in the usual and customary sense, to a linear sequence of nucleotides. Oligonucleotides are typically from about 5, 6, 7, 8, 9, 10, 12, 15, 25, 30, 40, 50 or more nucleotides in length, up to about 100 nucleotides in length. In some embodiments, an oligonucleotide is a primer configured for extension by a polymerase when the primer is annealed completely or partially to a complementary nucleic acid template. A primer is often a single stranded nucleic acid. In certain embodiments, a primer, or portion thereof, is substantially complementary to a portion of an adapter. In some embodiments, a primer has a length of 200 nucleotides or less. In certain embodiments, a primer has a length of 10 to 150 nucleotides, 15 to 150 nucleotides, 5 to 100 nucleotides, 5 to 50 nucleotides or 10 to 50 nucleotides. In some embodiments, an oligonucleotide may be immobilized to a solid support. In some embodiments, a polynucleotide may be a circular polynucleotide. The terms “circular polynucleotide” or “circular oligonucleotide” refer to a contiguous polynucleotide lacking a free 5′ and a free 3′ end.

As used herein, the terms “polynucleotide primer” and “primer” refers to any polynucleotide molecule that may hybridize to a polynucleotide template, be bound by a polymerase, and be extended in a template-directed process for nucleic acid synthesis (e.g., amplification and/or sequencing). The primer may be a separate polynucleotide from the polynucleotide template, or both may be portions of the same polynucleotide (e.g., as in a hairpin structure having a 3′ end that is extended along another portion of the polynucleotide to extend a double-stranded portion of the hairpin). Primers (e.g., forward or reverse primers) may be attached to a solid support. A primer can be of any length depending on the particular technique it will be used for. For example, PCR primers are generally between 10 and 40 nucleotides in length. The length and complexity of the nucleic acid fixed onto the nucleic acid template may vary. In some embodiments, a primer has a length of 200 nucleotides or less. In certain embodiments, a primer has a length of 10 to 150 nucleotides, 15 to 150 nucleotides, 5 to 100 nucleotides, 5 to 50 nucleotides or 10 to 50 nucleotides. In certain embodiments, a primer has a length of 10 to 150 nucleotides, 15 to 150 nucleotides, 5 to 100 nucleotides, 5 to 50 nucleotides or 10 to 50 nucleotides. A primer typically has a length of 10 to 50 nucleotides. For example, a primer may have a length of 10 to 40, 10 to 30, 10 to 20, 25 to 50, 15 to 40, 15 to 30, 20 to 50, 20 to 40, or 20 to 30 nucleotides. In some embodiments, a primer has a length of 18 to 24 nucleotides. One of skill can adjust these factors to provide optimum hybridization and signal production for a given hybridization procedure. The primer permits the addition of a nucleotide residue thereto, or oligonucleotide or polynucleotide synthesis therefrom, under suitable conditions. In an embodiment the primer is a DNA primer, i.e., a primer consisting of, or largely consisting of, deoxyribonucleotide residues. The primers are designed to have a sequence that is the complement of a region of template/target DNA to which the primer hybridizes. The addition of a nucleotide residue to the 3′ end of a primer by formation of a phosphodiester bond results in a DNA extension product. The addition of a nucleotide residue to the 3′ end of the DNA extension product by formation of a phosphodiester bond results in a further DNA extension product. In another embodiment the primer is an RNA primer. In embodiments, a primer is hybridized to a target polynucleotide. A “primer” is complementary to a polynucleotide template, and complexes by hydrogen bonding or hybridization with the template to give a primer/template complex for initiation of synthesis by a polymerase, which is extended by the addition of covalently bonded bases linked at its 3′ end complementary to the template in the process of DNA synthesis. A “splint oligonucleotide” is used in accordance with its plain and ordinary meaning and refers to an oligonucleotide having 2 or more sequences complementary to two or more portions of a polynucleotide. An “oligonucleotide probe” or “oligonucleotide primer”, as used herein, refers to a primer including a sequence (e.g., a target hybridization sequence) at a 3′ end complementary to a sequence (e.g., a probe hybridization sequence) of a target polynucleotide (e.g., a target mRNA molecule). In embodiments, the oligonucleotide probe includes one or more sequences located 5′ (i.e., upstream) of the target hybridization sequence, for example, one or more primer binding sequences. An “extended oligonucleotide probe” or “extended oligonucleotide primer”, as used herein, refers to an oligonucleotide probe that has had one or more nucleotides incorporated into the 3′ end by a polymerase, for example, a reverse transcriptase. In embodiments, an extended oligonucleotide probe includes a region of cDNA (e.g., a cDNA sequence complementary to a portion of an mRNA molecule) located 3′ (i.e., downstream) of the target hybridization sequence. A “target hybridization sequence” as used herein refers to a sequence at a 3′ end of an oligonucleotide probe that is complementary to a sequence in a target polynucleotide (e.g., complementary to a probe hybridization sequence of the target polynucleotide).

The term “messenger RNA” or “mRNA” refers to an RNA that is without introns and is capable of being translated into a polypeptide. The term “RNA” refers to any ribonucleic acid, including but not limited to mRNA, tRNA (transfer RNA), rRNA (ribosomal RNA), and/or noncoding RNA (such as lncRNA (long noncoding RNA)). The term “cDNA” refers to a DNA that is complementary or identical to an RNA, in either single stranded or double stranded form.

A polynucleotide is typically composed of a specific sequence of four nucleotide bases: adenine (A); cytosine (C); guanine (G); and thymine (T) (uracil (U) for thymine (T) when the polynucleotide is RNA). Thus, the term “polynucleotide sequence” is the alphabetical representation of a polynucleotide molecule; alternatively, the term may be applied to the polynucleotide molecule itself. This alphabetical representation can be input into databases in a computer having a central processing unit and used for bioinformatics applications such as functional genomics and homology searching. Polynucleotides may optionally include one or more non-standard nucleotide(s), nucleotide analog(s) and/or modified nucleotides.

As used herein, the term “associated” or “associated with” can mean that two or more species are identifiable as being co-located at a point in time. An association can mean that two or more species are or were within a similar container. An association can be an informatics association, where for example digital information regarding two or more species is stored and can be used to determine that one or more of the species were co-located at a point in time. An association can also be a physical association. In some instances two or more associated species are “tethered”, “coated”, “attached”, or “immobilized” to one another or to a common solid or semisolid support (e.g. a receiving substrate). An association may refer to a relationship, or connection, between two entities. For example, a barcode sequence may be associated with a particular target by binding a probe including the barcode sequence to the target. In embodiments, detecting the associated barcode provides detection of the target. Associated may refer to the relationship between a sample and the DNA molecules, RNA molecules, or polynucleotides originating from or derived from that sample. These relationships may be encoded in oligonucleotide barcodes, as described herein. A polynucleotide is associated with a sample if it is an endogenous polynucleotide, i.e., it occurs in the sample at the time the sample is obtained, or is derived from an endogenous polynucleotide. For example, the RNAs endogenous to a cell are associated with that cell. cDNAs resulting from reverse transcription of these RNAs, and DNA amplicons resulting from PCR amplification of the cDNAs, contain the sequences of the RNAs and are also associated with the cell. The polynucleotides associated with a sample need not be located or synthesized in the sample, and are considered associated with the sample even after the sample has been destroyed (for example, after a cell has been lysed). Barcoding can be used to determine which polynucleotides in a mixture are associated with a particular sample. In embodiments, a proximity probe is associated with a particular barcode, such that identifying the barcode identifies the probe with which it is associated. Because the proximity probe specifically binds to a target, identifying the barcode thus identifies the target.

As used herein, the terms “analogue” and “analog”, in reference to a chemical compound, refers to compound having a structure similar to that of another one, but differing from it in respect of one or more different atoms, functional groups, or substructures that are replaced with one or more other atoms, functional groups, or substructures. In the context of a nucleotide, a nucleotide analog refers to a compound that, like the nucleotide of which it is an analog, can be incorporated into a nucleic acid molecule (e.g., an extension product) by a suitable polymerase, for example, a DNA polymerase in the context of a nucleotide analogue. The terms also encompass nucleic acids containing known nucleotide analogs or modified backbone residues or linkages, which are synthetic, naturally occurring, or non-naturally occurring, which have similar binding properties as the reference nucleic acid, and which are metabolized in a manner similar to the reference nucleotides. Examples of such analogs include, without limitation, phosphodiester derivatives including, e.g., phosphoramidate, phosphorodiamidate, phosphorothioate (also known as phosphorothioate having double bonded sulfur replacing oxygen in the phosphate), phosphorodithioate, phosphonocarboxylic acids, phosphonocarboxylates, phosphonoacetic acid, phosphonoformic acid, methyl phosphonate, boron phosphonate, or O-methylphosphoroamidite linkages (see, e.g., see Eckstein, OLIGONUCLEOTIDES AND ANALOGUES: A PRACTICAL APPROACH, Oxford University Press) as well as modifications to the nucleotide bases such as in 5-methyl cytidine or pseudouridine; and peptide nucleic acid backbones and linkages. Other analog nucleic acids include those with positive backbones; non-ionic backbones, modified sugars, and non-ribose backbones (e.g. phosphorodiamidate morpholino oligos or locked nucleic acids (LNA)), including those described in U.S. Pat. Nos. 5,235,033 and 5,034,506, and Chapters 6 and 7. Nucleic acids containing one or more carbocyclic sugars are also included within one definition of nucleic acids. Modifications of the ribose-phosphate backbone may be done for a variety of reasons, e.g., to increase the stability and half-life of such molecules in physiological environments or as probes on a biochip. Mixtures of naturally occurring nucleic acids and analogs can be made; alternatively, mixtures of different nucleic acid analogs, and mixtures of naturally occurring nucleic acids and analogs may be made. In embodiments, the internucleotide linkages in DNA are phosphodiester, phosphodiester derivatives, or a combination of both.

In some embodiments, a nucleic acid includes a label. As used herein, the term “label” or “labels” is used in accordance with their plain and ordinary meanings and refer to molecules that can directly or indirectly produce or result in a detectable signal either by themselves or upon interaction with another molecule. Non-limiting examples of detectable labels include fluorescent dyes, biotin, digoxin, haptens, and epitopes. In general, a dye is a molecule, compound, or substance that can provide an optically detectable signal, such as a colorimetric, luminescent, bioluminescent, chemiluminescent, phosphorescent, or fluorescent signal. In embodiments, the label is a dye. In embodiments, the dye is a fluorescent dye. Non-limiting examples of dyes, some of which are commercially available, include CF dyes (Biotium, Inc.), Alexa Fluor dyes (Thermo Fisher), DyLight dyes (Thermo Fisher), Cy dyes (GE Healthscience), IRDyes (Li-Cor Biosciences, Inc.), and HiLyte dyes (Anaspec, Inc.). In embodiments, a particular nucleotide type is associated with a particular label, such that identifying the label identifies the nucleotide with which it is associated. In embodiments, the label is luciferin that reacts with luciferase to produce a detectable signal in response to one or more bases being incorporated into an elongated complementary strand, such as in pyrosequencing. In embodiment, a nucleotide includes a label (such as a dye). In embodiments, the label is not associated with any particular nucleotide, but detection of the label identifies whether one or more nucleotides having a known identity were added during an extension step (such as in the case of pyrosequencing). Examples of detectable agents (i.e., labels) include imaging agents, including fluorescent and luminescent substances, molecules, or compositions, including, but not limited to, a variety of organic or inorganic small molecules commonly referred to as “dyes,” “labels,” or “indicators.” Examples include fluorescein, rhodamine, acridine dyes, Alexa dyes, and cyanine dyes. In embodiments, the detectable moiety is a fluorescent molecule (e.g., acridine dye, cyanine, dye, fluorine dye, oxazine dye, phenanthridine dye, or rhodamine dye). In embodiments, the detectable moiety is a fluorescent molecule (e.g., acridine dye, cyanine, dye, fluorine dye, oxazine dye, phenanthridine dye, or rhodamine dye). The term “cyanine” or “cyanine moiety” as described herein refers to a detectable moiety containing two nitrogen groups separated by a polymethine chain. In embodiments, the cyanine moiety has 3 methine structures (i.e., cyanine 3 or Cy3). In embodiments, the cyanine moiety has 5 methine structures (i.e., cyanine 5 or Cy5). In embodiments, the cyanine moiety has 7 methine structures (i.e., cyanine 7 or Cy7).

The terms “identical” or percent “identity,” in the context of two or more nucleic acids or polypeptide sequences, refer to two or more sequences or subsequences that are the same or have a specified percentage of amino acid residues or nucleotides that are the same (i.e., about 60% identity, preferably 65%, 70%, 75%, 80%, 85%, 90%, 91%, 92%, 93%, 94%, 95%, 96%, 97%, 98%, 99%, or higher identity over a specified region, when compared and aligned for maximum correspondence over a comparison window or designated region) as measured using a BLAST or BLAST 2.0 sequence comparison algorithms with default parameters described below, or by manual alignment and visual inspection (see, e.g., NCBI web site www.ncbi.nlm.nih.gov/BLAST/ or the like). Such sequences are then said to be “substantially identical.” This definition also refers to, or may be applied to, the complement of a test sequence. The definition also includes sequences that have deletions and/or additions, as well as those that have substitutions. As described below, the preferred algorithms can account for gaps and the like. Preferably, identity exists over a region that is at least about 25 amino acids or nucleotides in length, or more preferably over a region that is 50-100 amino acids or nucleotides in length.

As used herein, the term “removable” group, e.g., a label or a blocking group or protecting group, is used in accordance with its plain and ordinary meaning and refers to a chemical group that can be removed from a nucleotide analogue such that a DNA polymerase can extend the nucleic acid (e.g., a primer or extension product) by the incorporation of at least one additional nucleotide. Removal may be by any suitable method, including enzymatic, chemical, or photolytic cleavage. Removal of a removable group, e.g., a blocking group, does not require that the entire removable group be removed, only that a sufficient portion of it be removed such that a DNA polymerase can extend a nucleic acid by incorporation of at least one additional nucleotide using a nucleotide or nucleotide analogue. In general, the conditions under which a removable group is removed are compatible with a process employing the removable group (e.g., an amplification process or sequencing process).

As used herein, the terms “reversible blocking groups” and “reversible terminators” are used in accordance with their plain and ordinary meanings and refer to a blocking moiety located, for example, at the 3′ position of a modified nucleotide and may be a chemically cleavable moiety such as an allyl group, an azidomethyl group or a methoxymethyl group, or may be an enzymatically cleavable group such as a phosphate ester. Non-limiting examples of nucleotide blocking moieties are described in applications WO 2004/018497, WO 96/07669, U.S. Pat. Nos. 7,057,026, 7,541,444, 5,763,594, 5,808,045, 5,872,244 and 6,232,465 the contents of which are incorporated herein by reference in their entirety. The nucleotides may be labelled or unlabeled. They may be modified with reversible terminators useful in methods provided herein and may be 3′-O-blocked reversible or 3′-unblocked reversible terminators. In nucleotides with 3′-O-blocked reversible terminators, the blocking group —OR [reversible terminating (capping) group] is linked to the oxygen atom of the 3′-OH of the pentose, while the label is linked to the base, which acts as a reporter and can be cleaved. The 3′-O-blocked reversible terminators are known in the art, and may be, for instance, a 3′-ONH₂ reversible terminator, a 3′-O-allyl reversible terminator, or a 3′-O-azidomethyl reversible terminator. In embodiments, the reversible terminator moiety is attached to the 3′-oxygen of the nucleotide, having the formula:

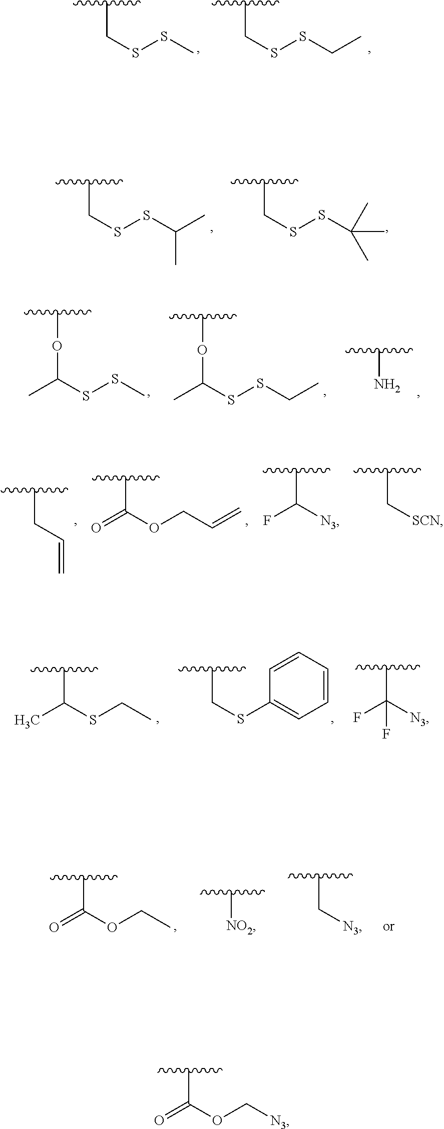

wherein the 3′ oxygen of the nucleotide is not shown in the formulae above. The term “allyl” as described herein refers to an unsubstituted methylene attached to a vinyl group (i.e., —CH═CH₂). In embodiments, the reversible terminator moiety is

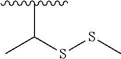 [SMILES: *C(C)SSC]

as described in U.S. Pat. No. 10,738,072, which is incorporated herein by reference for all purposes. For example, a nucleotide including a reversible terminator moiety may be represented by the formula:

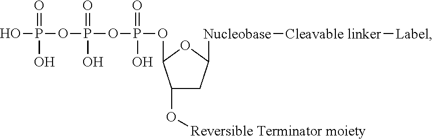

where the nucleobase is adenine or adenine analogue, thymine or thymine analogue, guanine or guanine analogue, or cytosine or cytosine analogue.

In some embodiments, a nucleic acid (e.g., a probe or a primer) includes a molecular identifier or a molecular barcode. As used herein, the term “molecular barcode” (which may be referred to as a “tag”, a “barcode”, a “molecular identifier”, an “identifier sequence” or a “unique molecular identifier” (UMI)) refers to a material e.g., a nucleotide sequence, a nucleic acid mole feature) that is capable of distinguishing an individual molecule in a large heterogeneous population of molecules. In embodiments, a barcode is unique in a pool of barcodes that differ from one another in sequence, or is uniquely associated with a particular sample polynucleotide in a pool of sample polynucleotides. In embodiments, every barcode in a pool of adapters is unique, such that sequencing reads including the barcode can be identified as originating from a single sample polynucleotide molecule on the basis of the barcode alone. In other embodiments, individual barcode sequences may be used more than once, but molecules including the duplicate barcodes are associated with different sequences and/or in different combinations of barcoded molecules, such that sequence reads may still be uniquely distinguished as originating from a single sample polynucleotide molecule on the basis of a barcode and adjacent sequence information (e.g., sample polynucleotide sequence, and/or one or more adjacent barcodes). In embodiments, barcodes are about or at least about 5, 6, 7, 8, 9, 10, 15, 20, 25, 30, 40, 50, 75 or more nucleotides in length. In embodiments, barcodes are shorter than 20, 15, 10, 9, 8, 7, 6, or 5 nucleotides in length. In embodiments, barcodes are about 10 to about 50 nucleotides in length, such as about 15 to about 40 or about 20 to about 30 nucleotides in length. In a pool of different barcodes, barcodes may have the same or different lengths. In general, barcodes are of sufficient length and include sequences that are sufficiently different to allow the identification of sequencing reads that originate from the same sample polynucleotide molecule. In embodiments, each barcode in a plurality of barcodes differs from every other barcode in the plurality by at least three nucleotide positions, such as at least 3, 4, 5, 6, 7, 8, 9, 10, or more nucleotide positions. In some embodiments, substantially degenerate barcodes may be known as random. In some embodiments, a barcode may include a nucleic acid sequence from within a pool of known sequences. In some embodiments, the barcodes may be pre-defined. In embodiments, the barcodes are selected to form a known set of barcodes, e.g., the set of barcodes may be distinguished by a particular Hamming distance. In embodiments, each barcode sequence is unique within the known set of barcodes. In embodiments, each barcode sequence is associated with a particular oligonucleotide probe. In embodiments, a nucleic acid includes a sample barcode. In general, a “sample barcode” is a nucleotide sequence that is sufficiently different from other sample barcode to allow the identification of the sample source based on sample barcode sequence(s) with which they are associated. In embodiments, a plurality of nucleotides (e.g., all oligonucleotides from a particular subset) are joined to a first sample barcode, while a different plurality of nucleotides (e.g., all nucleotides from a different sample source, or different subsample) are joined to a second sample barcode, thereby associating each plurality of polynucleotides with a different sample barcode indicative of sample source. In embodiments, each sample barcode in a plurality of sample barcodes differs from every other sample barcode in the plurality by at least three nucleotide positions, such as at least 3, 4, 5, 6, 7, 8, 9, 10, or more nucleotide positions. In some embodiments, substantially degenerate sample barcodes may be known as random. In some embodiments, a sample barcode may include a nucleic acid sequence from within a pool of known sequences. In some embodiments, the sample barcodes may be pre-defined. In embodiments, the sample barcode includes about 1 to about 10 nucleotides. In embodiments, the sample barcode includes about 3, 4, 5, 6, 7, 8, 9, or about 10 nucleotides. In embodiments, the sample barcode includes about 3 nucleotides. In embodiments, the sample barcode includes about 5 nucleotides. In embodiments, the sample barcode includes about 7 nucleotides. In embodiments, the sample barcode includes about 10 nucleotides. In embodiments, the sample barcode includes about 6 to about 10 nucleotides.

As used herein, the term “incorporating” or “chemically incorporating,” when used in reference to a primer and cognate nucleotide, refers to the process of joining the cognate nucleotide to the primer or extension product thereof by formation of a phosphodiester bond.

As used herein, the term “selective” or “selectivity” or the like of a compound refers to the compound's ability to discriminate between molecular targets. For example, a chemical reagent may selectively modify one nucleotide type in that it reacts with one nucleotide type (e.g., cytosines) and not other nucleotide types (e.g., adenine, thymine, or guanine). When used in the context of sequencing, such as in “selectively sequencing,” this term refers to sequencing one or more target polynucleotides from an original starting population of polynucleotides, and not sequencing non-target polynucleotides from the starting population. Typically, selectively sequencing one or more target polynucleotides involves differentially manipulating the target polynucleotides based on known sequence. For example, target polynucleotides may be hybridized to a probe oligonucleotide that may be labeled (such as with a member of a binding pair) or bound to a surface. In embodiments, hybridizing a target polynucleotide to a probe oligonucleotide includes the step of displacing one strand of a double-stranded nucleic acid. Probe-hybridized target polynucleotides may then be separated from non-hybridized polynucleotides, such as by removing probe-bound polynucleotides from the starting population or by washing away polynucleotides that are not bound to a probe. The result is a selected subset of the starting population of polynucleotides, which is then subjected to sequencing, thereby selectively sequencing the one or more target polynucleotides.

As used herein, the term “template polynucleotide” refers to any polynucleotide molecule that may be bound by a polymerase and utilized as a template for nucleic acid synthesis. A template polynucleotide may be a target polynucleotide. In general, the term “target polynucleotide” refers to a nucleic acid molecule or polynucleotide in a starting population of nucleic acid molecules having a target sequence whose presence, amount, and/or nucleotide sequence, or changes in one or more of these, are desired to be determined. The target sequence may be a portion of a gene, a regulatory sequence, genomic DNA, cDNA, RNA including mRNA, rRNA, or others. The target sequence may be a target sequence from a sample or a secondary target such as a product of an amplification reaction. A target polynucleotide is not necessarily any single molecule or sequence. For example, a target polynucleotide may be any one of a plurality of target polynucleotides in a reaction, or all polynucleotides in a given reaction, depending on the reaction conditions. For example, in a nucleic acid amplification reaction with random primers, all polynucleotides in a reaction may be amplified. As a further example, a collection of targets may be simultaneously assayed using polynucleotide primers directed to a plurality of targets in a single reaction. As yet another example, all or a subset of polynucleotides in a sample may be modified by the addition of a primer-binding sequence (such as by the ligation of adapters containing the primer binding sequence), rendering each modified polynucleotide a target polynucleotide in a reaction with the corresponding primer polynucleotide(s). In embodiments, the template polynucleotide includes a target nucleic acid sequence and one or more barcode sequences. In embodiments, the template polynucleotide is a barcode sequence. A “target sequence”, as used herein, refers to a sequence of a splint oligonucleotide that is the same, or substantially the same, as a sequence in a target polynucleotide (i.e., the target sequence of the splint oligonucleotide is the same, or substantially the same, as the target sequence in the target polynucleotide). In embodiments, the target sequence is a known sequence. In embodiments, the target sequence is selected from a set of known target sequences. In embodiments, the target sequence is located 5′ of the probe hybridization sequence of the target polynucleotide. A “subject sequence”, as used herein, refers to the sequence of interest in a target polynucleotide. For example, an oligonucleotide probe may be hybridized upstream of a subject sequence of a target polynucleotide and extending the oligonucleotide probe incorporates a sequence complementary to the subject sequence (i.e., a subject sequence complement) into the oligonucleotide probe. The extended oligonucleotide probe may then be processed further (e.g., circularized and/or amplified), and the subject sequence detected by, e.g., sequencing.

As used herein, the terms “specific”, “specifically”, “specificity”, or the like of a compound refers to the compound's ability to cause a particular action, such as binding, to a particular molecular target with minimal or no action to other proteins in the cell.

The terms “attached,” “bind,” and “bound” as used herein are used in accordance with their plain and ordinary meanings and refer to an association between atoms or molecules. The association can be direct or indirect. For example, attached molecules may be directly bound to one another, e.g., by a covalent bond or non-covalent bond (e.g. electrostatic interactions (e.g. ionic bond, hydrogen bond, halogen bond), van der Waals interactions (e.g. dipole-dipole, dipole-induced dipole, London dispersion), ring stacking (pi effects), hydrophobic interactions and the like). As a further example, two molecules may be bound indirectly to one another by way of direct binding to one or more intermediate molecules, thereby forming a complex.

“Specific binding” is where the binding is selective between two molecules. A particular example of specific binding is that which occurs between an antibody and an antigen. Typically, specific binding can be distinguished from non-specific when the dissociation constant (KD) is less than about 1×10⁻⁵ M or less than about 1×10⁻⁶ M or 1×10⁻⁷ M. Specific binding can be detected, for example, by ELISA, immunoprecipitation, coprecipitation, with or without chemical crosslinking, two-hybrid assays and the like. In embodiments, the KD (equilibrium dissociation constant) between two specific binding molecules is less than 10-6 M, less than 10⁻⁷ M, less than 10⁻⁸ M, less than 10⁻⁹ M, less than 10⁻⁹ M, less than 10⁻¹¹ M, or less than about 10⁻¹² M or less.

As used herein, the terms “sequencing”, “sequence determination”, “determining a nucleotide sequence”, and the like include determination of a partial or complete sequence information (e.g., a sequence) of a polynucleotide being sequenced, and particularly physical processes for generating such sequence information. That is, the term includes sequence comparisons, consensus sequence determination, contig assembly, fingerprinting, and like levels of information about a target polynucleotide, as well as the express identification and ordering of nucleotides in a target polynucleotide. The term also includes the determination of the identification, ordering, and locations of one, two, or three of the four types of nucleotides within a target polynucleotide. In some embodiments, a sequencing process described herein includes contacting a template and an annealed primer with a suitable polymerase under conditions suitable for polymerase extension and/or sequencing.

As used herein, the term “polymer” refers to macromolecules having one or more structurally unique repeating units. The repeating units are referred to as “monomers,” which are polymerized for the polymer. Typically, a polymer is formed by monomers linked in a chain-like structure. A polymer formed entirely from a single type of monomer is referred to as a “homopolymer.” A polymer formed from two or more unique repeating structural units may be referred to as a “copolymer.” A polymer may be linear or branched, and may be random, block, polymer brush, hyperbranched polymer, bottlebrush polymer, dendritic polymer, or polymer micelles. The term “polymer” includes homopolymers, copolymers, tripolymers, tetra polymers and other polymeric molecules made from monomeric subunits. Copolymers include alternating copolymers, periodic copolymers, statistical copolymers, random copolymers, block copolymers, linear copolymers and branched copolymers. The term “polymerizable monomer” is used in accordance with its meaning in the art of polymer chemistry and refers to a compound that may covalently bind chemically to other monomer molecules (such as other polymerizable monomers that are the same or different) to form a polymer. Polymers can be hydrophilic, hydrophobic or amphiphilic, as known in the art. Thus, “hydrophilic polymers” are substantially miscible with water and include, but are not limited to, polyethylene glycol and the like. “Hydrophobic polymers” are substantially immiscible with water and include, but are not limited to, polyethylene, polypropylene, polybutadiene, polystyrene, polymers disclosed herein, and the like. “Amphiphilic polymers” have both hydrophilic and hydrophobic properties and are typically copolymers having hydrophilic segment(s) and hydrophobic segment(s). Polymers include homopolymers, random copolymers, and block copolymers, as known in the art. The term “homopolymer” refers, in the usual and customary sense, to a polymer having a single monomeric unit. The term “copolymer” refers to a polymer derived from two or more monomeric species. The term “random copolymer” refers to a polymer derived from two or more monomeric species with no preferred ordering of the monomeric species. The term “block copolymer” refers to polymers having two or homopolymer subunits linked by covalent bond. Thus, the term “hydrophobic homopolymer” refers to a homopolymer which is hydrophobic. The term “hydrophobic block copolymer” refers to two or more homopolymer subunits linked by covalent bonds and which is hydrophobic.

As used herein, the term “substrate” refers to a solid support material. The substrate can be non-porous or porous. The substrate can be rigid or flexible. As used herein, the terms “solid support” and “solid surface” refers to discrete solid or semi-solid surface. A solid support may encompass any type of solid, porous, or hollow sphere, ball, cylinder, or other similar configuration composed of plastic, ceramic, metal, or polymeric material (e.g., hydrogel) onto which a nucleic acid may be immobilized (e.g., covalently or non-covalently). A nonporous substrate generally provides a seal against bulk flow of liquids or gases. Exemplary solid supports include, but are not limited to, glass and modified or functionalized glass, plastics (including acrylics, polystyrene and copolymers of styrene and other materials, polypropylene, polyethylene, polybutylene, polyurethanes, Teflon™, cyclic olefin copolymers, polyimides etc.), nylon, ceramics, resins, Zeonor, silica or silica-based materials including silicon and modified silicon, carbon, metals, inorganic glasses, optical fiber bundles, photopatternable dry film resists, UV-cured adhesives and polymers. Particularly useful solid supports for some embodiments have at least one surface located within a flow cell. Solid surfaces can also be varied in their shape depending on the application in a method described herein. For example, a solid surface useful herein can be planar, or contain regions which are concave or convex. In embodiments, the geometry of the concave or convex regions (e.g., wells) of the solid surface conform to the size and shape of the particle to maximize the contact between as substantially circular particle. In embodiments, the wells of an array are randomly located such that nearest neighbor features have random spacing between each other. Alternatively, in embodiments the spacing between the wells can be ordered, for example, forming a regular pattern. The term solid substrate is encompassing of a substrate (e.g., a flow cell) having a surface including a polymer coating covalently attached thereto. In embodiments, the solid substrate is a flow cell. The term “flow cell” as used herein refers to a chamber including a solid surface across which one or more fluid reagents can be flowed. Examples of flow cells and related fluidic systems and detection platforms that can be readily used in the methods of the present disclosure are described, for example, in Bentley et al., Nature 456:53-59 (2008). In certain embodiments a substrate includes a surface (e.g., a surface of a flow cell, a surface of a tube, a surface of a chip), for example a metal surface (e.g., steel, gold, silver, aluminum, silicon and copper). In embodiments a substrate (e.g., a substrate surface) is coated and/or includes functional groups and/or inert materials. In certain embodiments a substrate includes a bead, a chip, a capillary, a plate, a membrane, a wafer (e.g., silicon wafers), a comb, or a pin for example. In some embodiments a substrate includes a bead and/or a nanoparticle. A substrate can be made of a suitable material, non-limiting examples of which include a plastic or a suitable polymer (e.g., polycarbonate, poly(vinyl alcohol), poly(divinylbenzene), polystyrene, polyamide, polyester, polyvinylidene difluoride (PVDF), polyethylene, polyurethane, polypropylene, and the like), borosilicate, glass, nylon, Wang resin, Merrifield resin, metal (e.g., iron, a metal alloy, sepharose, agarose, polyacrylamide, dextran, cellulose and the like or combinations thereof. In embodiments a substrate includes a magnetic material (e.g., iron, nickel, cobalt, platinum, aluminum, and the like). In embodiments a substrate includes a magnetic bead (e.g., DYNABEADS®, hematite, AMPure XP). Magnets can be used to purify and/or capture nucleic acids bound to certain substrates (e.g., substrates including a metal or magnetic material). The flow cell is typically a glass slide containing small fluidic channels (e.g., a glass slide 75 mm×25 mm×1 mm having one or more channels), through which sequencing solutions (e.g., polymerases, nucleotides, and buffers) may traverse. Though typically glass, suitable flow cell materials may include polymeric materials, plastics, silicon, quartz (fused silica), Borofloat® glass, silica, silica-based materials, carbon, metals, an optical fiber or optical fiber bundles, sapphire, or plastic materials such as COCs and epoxies. The particular material can be selected based on properties desired for a particular use. For example, materials that are transparent to a desired wavelength of radiation are useful for analytical techniques that will utilize radiation of the desired wavelength. Conversely, it may be desirable to select a material that does not pass radiation of a certain wavelength (e.g., being opaque, absorptive, or reflective). In embodiments, the material of the flow cell is selected due to the ability to conduct thermal energy. In embodiments, a flow cell includes inlet and outlet ports and a flow channel extending there between.

The term “surface” is intended to mean an external part or external layer of a substrate. The surface can be in contact with another material such as a gas, liquid, gel, polymer, organic polymer, second surface of a similar or different material, metal, or coat. The surface, or regions thereof, can be substantially flat. The substrate and/or the surface can have surface features such as wells, pits, channels, ridges, raised regions, pegs, posts or the like.

The term “microplate”, or “multiwell container” as used herein, refers to a substrate including a surface, the surface including a plurality of reaction chambers separated from each other by interstitial regions on the surface. In embodiments, the microplate has dimensions as provided and described by American National Standards Institute (ANSI) and Society for Laboratory Automation And Screening (SLAS); for example the tolerances and dimensions set forth in ANSI SLAS 1-2004 (R2012); ANSI SLAS 2-2004 (R2012); ANSI SLAS 3-2004 (R2012); ANSI SLAS 4-2004 (R2012); and ANSI SLAS 6-2012, which are incorporated herein by reference. The dimensions of the microplate as described herein and the arrangement of the reaction chambers may be compatible with an established format for automated laboratory equipment. In embodiments, the device described herein provides methods for high-throughput screening. High-throughput screening (HTS) refers to a process that uses a combination of modern robotics, data processing and control software, liquid handling devices, and/or sensitive detectors, to efficiently process a large amount of (e.g., thousands, hundreds of thousands, or millions) samples in biochemical, genetic, or pharmacological experiments, either in parallel or in sequence, within a reasonably short period of time (e.g., days). Preferably, the process is amenable to automation, such as robotic simultaneous handling of 96 samples, 384 samples, 1536 samples or more. A typical HTS robot tests up to 100,000 to a few hundred thousand compounds per day. The samples are often in small volumes, such as no more than 1 mL, 500 μl, 200 μl, 100 μl, 50 μl or less. Through this process, one can rapidly identify active compounds, small molecules, antibodies, proteins or polynucleotides in a cell.

The reaction chambers may be provided as wells of a multiwell container (alternatively referred to as reaction chambers), for example a microplate may contain 2, 4, 6, 12, 24, 48, 96, 384, or 1536 sample wells. In embodiments, the 96 and 384 wells are arranged in a 2:3 rectangular matrix. In embodiments, the 24 wells are arranged in a 3:8 rectangular matrix. In embodiments, the 48 wells are arranged in a 3:4 rectangular matrix. In embodiments, the reaction chamber is a microscope slide (e.g., a glass slide about 75 mm by about 25 mm). In embodiments the slide is a concavity slide (e.g., the slide includes a depression). In embodiments, the slide includes a coating for enhanced cell adhesion (e.g., poly-L-lysine, silanes, carbon nanotubes, polymers, epoxy resins, or gold). In embodiments, the microplate is about 5 inches by about 3.33 inches, and includes a plurality of 5 mm diameter wells. In embodiments, the microplate is about 5 inches by about 3.33 inches, and includes a plurality of 6 mm diameter wells. In embodiments, the microplate is about 5 inches by about 3.33 inches, and includes a plurality of 7 mm diameter wells. In embodiments, the microplate is about 5 inches by about 3.33 inches, and includes a plurality of 7.5 mm diameter wells. In embodiments, the microplate is 5 inches by 3.33 inches, and includes a plurality of 7.5 mm diameter wells. In embodiments, the microplate is about 5 inches by about 3.33 inches, and includes a plurality of 8 mm diameter wells. In embodiments, the microplate is a flat glass or plastic tray in which an array of wells are formed, wherein each well can hold between from a few microliters to hundreds of microliters of fluid reagents and samples. In embodiments, the microplate has a rectangular shape that measures 127.7 mm±0.5 mm in length by 85.4 mm±0.5 mm in width, and includes 6, 12, 24, 48, or 96 wells, wherein each well has an average diameter of about 5-7 mm. In embodiments, the microplate has a rectangular shape that measures 127.7 mm±0.5 mm in length by 85.4 mm±0.5 mm in width, and includes 6, 12, 24, 48, or 96 wells, wherein each well has an average diameter of about 6 mm.

The term “well” refers to a discrete concave feature in a substrate having a surface opening that is completely surrounded by interstitial region(s) of the surface. Wells can have any of a variety of shapes at their opening in a surface including but not limited to round, elliptical, square, polygonal, or star shaped (i.e., star shaped with any number of vertices). The cross section of a well taken orthogonally with the surface may be curved, square, polygonal, hyperbolic, conical, or angular. The wells of a microplate are available in different shapes, for example F-Bottom: flat bottom; C-Bottom: bottom with minimal rounded edges; V-Bottom: V-shaped bottom; or U-Bottom: U-shaped bottom. In embodiments, the well is substantially square. In embodiments, the well is square. In embodiments, the well is F-bottom. In embodiments, the microplate includes 24 substantially round flat bottom wells. In embodiments, the microplate includes 48 substantially round flat bottom wells. In embodiments, the microplate includes 96 substantially round flat bottom wells. In embodiments, the microplate includes 384 substantially square flat bottom wells.

The discrete regions (i.e., features, wells) of the microplate may have defined locations in a regular array, which may correspond to a rectilinear pattern, circular pattern, hexagonal pattern, or the like. In embodiments, the pattern of wells includes concentric circles of regions, spiral patterns, rectilinear patterns, hexagonal patterns, and the like. In embodiments, the pattern of wells is arranged in a rectilinear or hexagonal pattern A regular array of such regions is advantageous for detection and data analysis of signals collected from the arrays during an analysis. These discrete regions are separated by interstitial regions. As used herein, the term “interstitial region” refers to an area in a substrate or on a surface that separates other areas of the substrate or surface. For example, an interstitial region can separate one concave feature of an array from another concave feature of the array. The two regions that are separated from each other can be discrete, lacking contact with each other. In another example, an interstitial region can separate a first portion of a feature from a second portion of a feature. In embodiments the interstitial region is continuous whereas the features are discrete, for example, as is the case for an array of wells in an otherwise continuous surface. The separation provided by an interstitial region can be partial or full separation. In embodiments, interstitial regions have a surface material that differs from the surface material of the wells (e.g., the interstitial region contains a photoresist and the surface of the well is glass). In embodiments, interstitial regions have a surface material that is the same as the surface material of the wells (e.g., both the surface of the interstitial region and the surface of well contain a polymer or copolymer).

As used herein, the term “sequencing cycle” is used in accordance with its plain and ordinary meaning and refers to incorporating one or more nucleotides (e.g., nucleotide analogues) to the 3′ end of a polynucleotide with a polymerase, and detecting one or more labels that identify the one or more nucleotides incorporated. In embodiments, one nucleotide (e.g., a modified nucleotide) is incorporated per sequencing cycle. The sequencing may be accomplished by, for example, sequencing by synthesis, pyrosequencing, and the like. In embodiments, a sequencing cycle includes extending a complementary polynucleotide by incorporating a first nucleotide using a polymerase, wherein the polynucleotide is hybridized to a template nucleic acid, detecting the first nucleotide, and identifying the first nucleotide. In embodiments, to begin a sequencing cycle, one or more differently labeled nucleotides and a DNA polymerase can be introduced. Following nucleotide addition, signals produced (e.g., via excitation and emission of a detectable label) can be detected to determine the identity of the incorporated nucleotide (based on the labels on the nucleotides). Reagents can then be added to remove the 3′ reversible terminator and to remove labels from each incorporated base. Reagents, enzymes, and other substances can be removed between steps by washing. Cycles may include repeating these steps, and the sequence of each cluster is read over the multiple repetitions.

As used herein, the term “extension” or “elongation” is used in accordance with their plain and ordinary meanings and refer to synthesis by a polymerase of a new polynucleotide strand complementary to a template strand by adding free nucleotides (e.g., dNTPs) from a reaction mixture that are complementary to the template in the 5′-to-3′ direction. Extension includes condensing the 5′-phosphate group of the dNTPs with the 3′-hydroxy group at the end of the nascent (elongating) DNA strand.

As used herein, the term “sequencing read” is used in accordance with its plain and ordinary meaning and refers to an inferred sequence of nucleotide bases (or nucleotide base probabilities) corresponding to all or part of a single polynucleotide fragment. A sequencing read may include 10, 20, 30, 40, 50, 60, 70, 80, 90, 100, 150, 200, 250, or more nucleotide bases. In embodiments, a sequencing read includes reading a barcode sequence and a template nucleotide sequence. In embodiments, a sequencing read includes reading a template nucleotide sequence. In embodiments, a sequencing read includes reading a barcode and not a template nucleotide sequence. Reads of length 20-40 base pairs (bp) are referred to as ultra-short. Typical sequencers produce read lengths in the range of 100-500 bp. Read length is a factor which can affect the results of biological studies. For example, longer read lengths improve the resolution of de novo genome assembly and detection of structural variants. In embodiments, a sequencing read includes reading a barcode and a template nucleotide sequence. In embodiments, a sequencing read includes reading a template nucleotide sequence. In embodiments, a sequencing read includes reading a barcode and not a template nucleotide sequence. In embodiments, a sequencing read includes a computationally derived string corresponding to the detected label. In some embodiments, a sequencing read may include 300, 400, 500, 600, 700, 800, 900, 1,000, 1,100, 1,200, 1,300, 1,400, 1,500, or more nucleotide bases.

The term “multiplexing” as used herein refers to an analytical method in which the presence and/or amount of multiple targets, e.g., multiple nucleic acid target sequences, can be assayed simultaneously by using the methods and devices as described herein, each of which has at least one different detection characteristic, e.g., fluorescence characteristic (for example excitation wavelength, emission wavelength, emission intensity, FWHM (full width at half maximum peak height), or fluorescence lifetime) or a unique nucleic acid or protein sequence characteristic. As used herein, the term “multiplex” is used to refer to an assay in which multiple (i.e. at least two) different biomolecules are assayed at the same time, and more particularly in the same aliquot of the sample, or in the same reaction mixture. In embodiments, more than two different biomolecules are assayed at the same time. In embodiments, at least 2, 4, 6, 8, 10, 20, 50, 100, 200, 300, 400, 500, 600, 700, 800, 900, 1000, 1100, 1200, 1300, 1400 or 1500 or more biomolecules are detected according to the present method.

As used herein, the term “adjacent,” refers to two nucleotide sequences in a nucleic acid, can refer to nucleotide sequences separated by 0 to about 20 nucleotides, more specifically, in a range of about 1 to about 10 nucleotides, or to sequences that directly abut one another. As those of skill in the art appreciate, two nucleotide sequences that that are to ligated together will generally directly abut one another.

A nucleic acid can be amplified by a suitable method. The term “amplification,” “amplified” or “amplifying” as used herein refers to subjecting a target nucleic acid in a sample to a process that linearly or exponentially generates amplicon nucleic acids having the same or substantially the same (e.g., substantially identical) nucleotide sequence as the target nucleic acid, or segment thereof, and/or a complement thereof (which may be referred to herein as an “amplification product” or “amplification products”). In some embodiments an amplification reaction includes a suitable thermal stable polymerase. Thermal stable polymerases are known and are stable for prolonged periods of time, at temperature greater than 80° C. when compared to common polymerases found in most mammals. In certain embodiments the term “amplification,” “amplified” or “amplifying” refers to a method that includes a polymerase chain reaction (PCR). Conditions conducive to amplification (i.e., amplification conditions) are known and often include at least a suitable polymerase, a suitable template, a suitable primer or set of primers, suitable nucleotides (e.g., dNTPs), a suitable buffer, and application of suitable annealing, hybridization and/or extension times and temperatures. In certain embodiments an amplified product (e.g., an amplicon) can contain one or more additional and/or different nucleotides than the template sequence, or portion thereof, from which the amplicon was generated (e.g., a primer can contain “extra” nucleotides (such as a 5′ portion that does not hybridize to the template), or one or more mismatched bases within a hybridizing portion of the primer).

Provided herein are methods, systems, and compositions for analyzing a sample (e.g., sequencing nucleic acids within a sample) in situ. The term “in situ” is used in accordance with its ordinary meaning in the art and refers to a sample surrounded by at least a portion of its native environment, such as may preserve the relative position of two or more elements. For example, an extracted human cell obtained is considered in situ when the cell is retained in its local microenvironment so as to avoid extracting the target (e.g., nucleic acid molecules or proteins) away from their native environment. An in situ sample (e.g., a cell) can be obtained from a suitable subject. An in situ cell sample may refer to a cell and its surrounding milieu, or a tissue. A sample can be isolated or obtained directly from a subject or part thereof. In embodiments, the methods described herein (e.g., sequencing a plurality of target nucleic acids of a cell in situ) are applied to an isolated cell (i.e., a cell not surrounded by least a portion of its native environment). For the avoidance of any doubt, when the method is performed within a cell (e.g., an isolated cell) the method may be considered in situ. In some embodiments, a sample is obtained indirectly from an individual or medical professional. A sample can be any specimen that is isolated or obtained from a subject or part thereof. A sample can be any specimen that is isolated or obtained from multiple subjects. Non-limiting examples of specimens include fluid or tissue from a subject, including, without limitation, blood or a blood product (e.g., serum, plasma, platelets, buffy coats, or the like), umbilical cord blood, chorionic villi, amniotic fluid, cerebrospinal fluid, spinal fluid, lavage fluid (e.g., lung, gastric, peritoneal, ductal, ear, arthroscopic), a biopsy sample, celocentesis sample, cells (blood cells, lymphocytes, placental cells, stem cells, bone marrow derived cells, embryo or fetal cells) or parts thereof (e.g., mitochondrial, nucleus, extracts, or the like), urine, feces, sputum, saliva, nasal mucous, prostate fluid, lavage, semen, lymphatic fluid, bile, tears, sweat, breast milk, breast fluid, the like or combinations thereof. Non-limiting examples of tissues include organ tissues (e.g., liver, kidney, lung, thymus, adrenals, skin, bladder, reproductive organs, intestine, colon, spleen, brain, the like or parts thereof), epithelial tissue, hair, hair follicles, ducts, canals, bone, eye, nose, mouth, throat, ear, nails, the like, parts thereof or combinations thereof. A sample may include cells or tissues that are normal, healthy, diseased (e.g., infected), and/or cancerous (e.g., cancer cells). A sample obtained from a subject may include cells or cellular material (e.g., nucleic acids) of multiple organisms (e.g., virus nucleic acid, fetal nucleic acid, bacterial nucleic acid, parasite nucleic acid). A sample may include a cell and RNA transcripts. A sample can include nucleic acids obtained from one or more subjects. In some embodiments a sample includes nucleic acid obtained from a single subject. A subject can be any living or non-living organism, including but not limited to a human, non-human animal, plant, bacterium, fungus, virus, or protist. A subject may be any age (e.g., an embryo, a fetus, infant, child, adult). A subject can be of any sex (e.g., male, female, or combination thereof). A subject may be pregnant. In some embodiments, a subject is a mammal. In some embodiments, a subject is a plant. In some embodiments, a subject is a human subject. A subject can be a patient (e.g., a human patient). In some embodiments a subject is suspected of having a genetic variation or a disease or condition associated with a genetic variation.

As used herein, the term “disease state” is used in accordance with its plain and ordinary meaning and refers to any abnormal biological or aberrant state of a cell. The presence of a disease state may be identified by the same collection of biological constituents used to determine the cell's biological state. In general, a disease state will be detrimental to a biological system. A disease state may be a consequence of, inter alia, an environmental pathogen, for example a viral infection (e.g., HIV/AIDS, hepatitis B, hepatitis C, influenza, measles, etc.), a bacterial infection, a parasitic infection, a fungal infection, or infection by some other organism. A disease state may also be the consequence of some other environmental agent, such as a chemical toxin or a chemical carcinogen. As used herein, a disease state further includes genetic disorders wherein one or more copies of a gene is altered or disrupted, thereby affecting its biological function. Exemplary genetic diseases include, but are not limited to polycystic kidney disease, familial multiple endocrine neoplasia type I, neurofibromatoses, Tay-Sachs disease, Huntington's disease, sickle cell anemia, thalassemia, and Down's syndrome, as well as others (see, e.g., The Metabolic and Molecular Bases of Inherited Diseases, 7th ed., McGraw-Hill Inc., New York). Other exemplary diseases include, but are not limited to, cancer, hypertension, Alzheimer's disease, neurodegenerative diseases, and neuropsychiatric disorders such as bipolar affective disorders or paranoid schizophrenic disorders. Disease states are monitored to determine the level or severity (e.g., the stage or progression) of one or more disease states of a subject and, more specifically, detect changes in the biological state of a subject which are correlated to one or more disease states (see, e.g., U.S. Pat. No. 6,218,122, which is incorporated by reference herein in its entirety). In embodiments, methods provided herein are also applicable to monitoring the disease state or states of a subject undergoing one or more therapies. Thus, the present disclosure also provides, in some embodiments, methods for determining or monitoring efficacy of a therapy or therapies (i.e., determining a level of therapeutic effect) upon a subject. In embodiments, methods of the present disclosure can be used to assess therapeutic efficacy in a clinical trial, e.g., as an early surrogate marker for success or failure in such a clinical trial. Within eukaryotic cells, there are hundreds to thousands of signaling pathways that are interconnected. For this reason, perturbations in the function of proteins within a cell have numerous effects on other proteins and the transcription of other genes that are connected by primary, secondary, and sometimes tertiary pathways. This extensive interconnection between the function of various proteins means that the alteration of any one protein is likely to result in compensatory changes in a wide number of other proteins. In particular, the partial disruption of even a single protein within a cell, such as by exposure to a drug or by a disease state which modulates the gene copy number (e.g., a genetic mutation), results in characteristic compensatory changes in the transcription of enough other genes that these changes in transcripts can be used to define a “signature” of particular transcript alterations which are related to the disruption of function, e.g., a particular disease state or therapy, even at a stage where changes in protein activity are undetectable.

The terms “polypeptide,” “peptide” and “protein” are used interchangeably herein to refer to a polymer of amino acid residues, wherein the polymer may optionally be conjugated to a moiety that does not consist of amino acids. The terms apply to amino acid polymers in which one or more amino acid residue is an artificial chemical mimetic of a corresponding naturally occurring amino acid, as well as to naturally occurring amino acid polymers and non-naturally occurring amino acid polymer. A protein may refer to a protein expressed in a cell.

As used herein, a “single cell” refers to one cell. Single cells useful in the methods described herein can be obtained from a tissue of interest, or from a biopsy, blood sample, or cell culture. Additionally, cells from specific organs, tissues, tumors, neoplasms, or the like can be obtained and used in the methods described herein. In general, cells from any population can be used in the methods, such as a population of prokaryotic or eukaryotic organisms, including bacteria or yeast.

The term “cellular component” is used in accordance with its ordinary meaning in the art and refers to any organelle, nucleic acid, protein, or analyte that is found in a prokaryotic, eukaryotic, archaeal, or other organismic cell type. Examples of cellular components (e.g., a component of a cell) include RNA transcripts, proteins, membranes, lipids, and other analytes.

A “gene” refers to a polynucleotide that is capable of conferring biological function after being transcribed and/or translated.

As used herein, the terms “biomolecule” or “analyte” refer to an agent (e.g., a compound, macromolecule, or small molecule), and the like derived from a biological system (e.g., an organism, a cell, or a tissue). The biomolecule may contain multiple individual components that collectively construct the biomolecule, for example, in embodiments, the biomolecule is a polynucleotide wherein the polynucleotide is composed of nucleotide monomers. The biomolecule may be or may include DNA, RNA, organelles, carbohydrates, lipids, proteins, or any combination thereof. These components may be extracellular. In some examples, the biomolecule may be referred to as a clump or aggregate of combinations of components. In some instances, the biomolecule may include one or more constituents of a cell but may not include other constituents of the cell. In embodiments, a biomolecule is a molecule produced by a biological system (e.g., an organism). The biomolecule may be any substance (e.g. molecule) or entity that is desired to be detected by the method of the invention. In embodiments, the biomolecule is the “target” of the assay methods described herein. The biomolecule may accordingly be any compound that may be desired to be detected, for example a peptide or protein, or nucleic acid molecule or a small molecule, including organic and inorganic molecules. The biomolecule may be a cell or a microorganism, including a virus, or a fragment or product thereof. Biomolecules of particular interest may thus include proteinaceous molecules such as peptides, polypeptides, proteins or prions or any molecule which includes a protein or polypeptide component, etc., or fragments thereof. The biomolecule may be a single molecule or a complex that contains two or more molecular subunits, which may or may not be covalently bound to one another, and which may be the same or different. Thus, in addition to cells or microorganisms, such a complex biomolecule may also be a protein complex. Such a complex may thus be a homo- or hetero-multimer. Aggregates of molecules e.g., proteins may also be target analytes, for example aggregates of the same protein or different proteins. The biomolecule may also be a complex between proteins or peptides and nucleic acid molecules such as DNA or RNA. Of particular interest may be the interactions between proteins and nucleic acids, e.g., regulatory factors, such as transcription factors, and interactions between DNA or RNA molecules.

As used herein, “biomaterial” refers to any biological material produced by an organism. In some embodiments, biomaterial includes secretions, extracellular matrix, proteins, lipids, organelles, membranes, cells, portions thereof, and combinations thereof. In some embodiments, cellular material includes secretions, extracellular matrix, proteins, lipids, organelles, membranes, cells, portions thereof, and combinations thereof. In some embodiments, biomaterial includes viruses. In some embodiments, the biomaterial is a replicating virus and thus includes virus infected cells. In embodiments, a biological sample includes biomaterials.

In some embodiments, a sample includes one or more nucleic acids, or fragments thereof. A sample can include nucleic acids obtained from one or more subjects. In some embodiments a sample includes nucleic acid obtained from a single subject. In some embodiments, a sample includes a mixture of nucleic acids. A mixture of nucleic acids can include two or more nucleic acid species having different nucleotide sequences, different fragment lengths, different origins (e.g., genomic origins, cell or tissue origins, subject origins, the like or combinations thereof), or combinations thereof. A sample may include synthetic nucleic acid.

A subject can be any living or non-living organism, including but not limited to a human, non-human animal, plant, bacterium, fungus, virus or protist. A subject may be any age (e.g., an embryo, a fetus, infant, child, adult). A subject can be of any sex (e.g., male, female, or combination thereof). A subject may be pregnant. In some embodiments, a subject is a mammal. In some embodiments, a subject is a human subject. A subject can be a patient (e.g., a human patient). In some embodiments a subject is suspected of having a genetic variation or a disease or condition associated with a genetic variation.

As used herein, the term “kit” refers to any delivery system for delivering materials. In the context of reaction assays, such delivery systems include systems that allow for the storage, transport, or delivery of reaction reagents (e.g., oligonucleotides, enzymes, etc. in the appropriate containers) and/or supporting materials (e.g., packaging, buffers, written instructions for performing a method, etc.) from one location to another. For example, kits include one or more enclosures (e.g., boxes) containing the relevant reaction reagents and/or supporting materials. As used herein, the term “fragmented kit” refers to a delivery system including two or more separate containers that each contain a subportion of the total kit components. The containers may be delivered to the intended recipient together or separately. For example, a first container may contain an enzyme for use in an assay, while a second container contains oligonucleotides. In contrast, a “combined kit” refers to a delivery system containing all of the components of a reaction assay in a single container (e.g., in a single box housing each of the desired components). The term “kit” includes both fragmented and combined kits.

As used herein the term “determine” can be used to refer to the act of ascertaining, establishing or estimating. A determination can be probabilistic. For example, a determination can have an apparent likelihood of at least 50%, 75%, 90%, 95%, 98%, 99%, 99.9% or higher. In some cases, a determination can have an apparent likelihood of 100%. An exemplary determination is a maximum likelihood analysis or report. As used herein, the term “identify,” when used in reference to a thing, can be used to refer to recognition of the thing, distinction of the thing from at least one other thing or categorization of the thing with at least one other thing. The recognition, distinction or categorization can be probabilistic. For example, a thing can be identified with an apparent likelihood of at least 50%, 75%, 90%, 95%, 98%, 99%, 99.9% or higher. A thing can be identified based on a result of a maximum likelihood analysis. In some cases, a thing can be identified with an apparent likelihood of 100%.

An “antibody” (Ab) is a protein that binds specifically to a particular substance, known as an “antigen” (Ag). An “antibody” or “antigen-binding fragment” is an immunoglobulin that binds a specific “epitope.” The term encompasses polyclonal, monoclonal, and chimeric antibodies. In nature, antibodies are generally produced by lymphocytes in response to immune challenge, such as by infection or immunization. An “antigen” (Ag) is any substance that reacts specifically with antibodies or T lymphocytes (T cells). An antibody may include the entire antibody as well as any antibody fragments capable of binding the antigen or antigenic fragment of interest. Examples include complete antibody molecules, antibody fragments, such as Fab, F(ab′)2, CDRs, VL, VH, and any other portion of an antibody which is capable of specifically binding to an antigen. Antibodies used herein are immunospecific for, and therefore specifically and selectively bind to, for example, proteins either detected (e.g., biological targets of interest) or used for detection (e.g., probes containing oligonucleotide barcodes) in the methods and devices as described herein.

The term “covalent linker” is used in accordance with its ordinary meaning and refers to a divalent moiety which connects at least two moieties to form a molecule. The term “non-covalent linker” is used in accordance with its ordinary meaning and refers to a divalent moiety which includes at least two molecules that are not covalently linked to each other but are capable of interacting with each other via a non-covalent bond (e.g., electrostatic interactions (e.g., ionic bond, hydrogen bond, halogen bond) or van der Waals interactions (e.g., dipole-dipole, dipole-induced dipole, London dispersion). In embodiments, the non-covalent linker is the result of two molecules that are not covalently linked to each other that interact with each other via a non-covalent bond.

As used herein a “genetically modifying agent” is a substance that alters the genetic sequence of a cell following exposure to the cell, resulting in an agent-mediated nucleic acid sequence. In embodiments, the genetically modifying agent is a small molecule, protein, pathogen (e.g., virus or bacterium), toxin, oligonucleotide, or antigen. In embodiments, the genetically modifying agent is a virus (e.g., influenza) and the agent-mediated nucleic acid sequence is the nucleic acid sequence that develops within a T-cell upon cellular exposure and contact with the virus. In embodiments, the genetically modifying agent modulates the expression of a nucleic acid sequence in a cell relative to a control (e.g., the absence of the genetically modifying agent).

Where a range of values is provided, it is understood that each intervening value, to the tenth of the unit of the lower limit unless the context clearly indicates otherwise, between the upper and lower limit of that range, and any other stated or unstated intervening value in, or smaller range of values within, that stated range is encompassed within the invention. The upper and lower limits of any such smaller range (within a more broadly recited range) may independently be included in the smaller ranges, or as particular values themselves, and are also encompassed within the invention, subject to any specifically excluded limit in the stated range. Where the stated range includes one or both of the limits, ranges excluding either or both of those included limits are also included in the invention.

As used herein, the term “upstream” refers to a region in the nucleic acid sequence that is towards the 5′ end of a particular reference point, and the term “downstream” refers to a region in the nucleic acid sequence that is toward the 3′ end of the reference point.

As used herein, the terms “incubate,” and “incubation” refer collectively to altering the temperature of an object in a controlled manner such that conditions are sufficient for conducting the desired reaction. Thus, it is envisioned that the terms encompass heating a receptacle (e.g., a microplate) to a desired temperature and maintaining such temperature for a fixed time interval. Also included in the terms is the act of subjecting a receptacle to one or more heating and cooling cycles (i.e., “temperature cycling” or “thermal cycling”). While temperature cycling typically occurs at relatively high rates of change in temperature, the term is not limited thereto, and may encompass any rate of change in temperature.

As used herein, “biological activity” may include the in vivo activities of a compound or physiological responses that result upon in vivo administration of a compound, composition or other mixture. Biological activity, thus, may encompass therapeutic effects and pharmaceutical activity of such compounds, compositions and mixtures. Biological activities may be observed in vitro systems designed to test or use such activities.

The term “isolated” means altered or removed from the natural state. For example, a nucleic acid or a polypeptide naturally present in a living animal is not isolated, but the same nucleic acid or polypeptide partially or completely separated from the coexisting materials of its natural state is isolated. An isolated nucleic acid or protein can exist in substantially purified form, or can exist in a non-native environment such as, for example, a host cell. In embodiments, “isolated” refers to a nucleic acid, polynucleotide, polypeptide, protein, or other component that is partially or completely separated from components with which it is normally associated (other proteins, nucleic acids, cells, etc.).

The term “synthetic target” as used herein refers to a modified protein or nucleic acid such as those constructed by synthetic methods. In embodiments, a synthetic target is artificial or engineered, or derived from or contains an artificial or engineered protein or nucleic acid (e.g., non-natural or not wild type). For example, a polynucleotide that is inserted or removed such that it is not associated with nucleotide sequences that normally flank the polynucleotide as it is found in nature is a synthetic target polynucleotide.

The term “image” is used according to its ordinary meaning and refers to a representation of all or part of an object. The representation may be an optically detected reproduction. For example, an image can be obtained from fluorescent, luminescent, scatter, or absorption signals. The part of the object that is present in an image can be the surface or other xy plane of the object. Typically, an image is a 2 dimensional representation of a 3 dimensional object. An image may include signals at differing intensities (i.e., signal levels). An image can be provided in a computer readable format or medium. An image is derived from the collection of focus points of light rays coming from an object (e.g., the sample), which may be detected by any image sensor. In embodiments, the image comprises pixel-based data representing signal intensities spatially resolved across a detection plane, where each pixel encodes optical information corresponding to a discrete region of the object. In embodiments, the image may be captured using image sensors including charge-coupled devices (CCDs), complementary metal-oxide-semiconductor (CMOS) detectors, photomultiplier tubes (PMTs), or scientific cameras configured for optical microscopy, flow imaging, or spectral detection. In embodiments, the image may be formed by sequential or simultaneous acquisition of multiple signal channels, each corresponding to a different excitation or emission wavelength, enabling multiplexed detection of fluorescently labeled targets. In embodiments, image data may include metadata such as acquisition time, spatial resolution, channel configuration, focal depth, or instrument settings, and may be encoded in standardized file formats including TIFF, JPEG2000, DICOM, or OME-TIFF. In embodiments, the image serves as a substrate for downstream computational analysis, including segmentation, feature extraction, intensity quantification, or machine learning-based classification. In embodiments, the image may represent a single time point or form part of a time-lapse series for dynamic analysis of sample behavior, such as cellular motility, morphological changes, or signaling kinetics.

As used herein, the term “signal” is intended to include, for example, fluorescent, luminescent, scatter, or absorption impulse or electromagnetic wave transmitted or received. Signals can be detected in the ultraviolet (UV) range (about 200 to 390 nm), visible (VIS) range (about 391 to 770 nm), infrared (IR) range (about 0.771 to 25 microns), or other range of the electromagnetic spectrum. The term “signal level” refers to an amount or quantity of detected energy or coded information. For example, a signal may be quantified by its intensity, wavelength, energy, frequency, power, luminance, or a combination thereof. Other signals can be quantified according to characteristics such as voltage, current, electric field strength, magnetic field strength, frequency, power, temperature, etc. Absence of signal is understood to be a signal level of zero or a signal level that is not meaningfully distinguished from noise.

The term “xy coordinates” refers to information that specifies location, size, shape, and/or orientation in an xy plane. The information can be, for example, numerical coordinates in a Cartesian system. The coordinates can be provided relative to one or both of the x and y axes or can be provided relative to another location in the xy plane (e.g., a fiducial). The term “xy plane” refers to a 2 dimensional area defined by straight line axes x and y. When used in reference to a detecting apparatus and an object observed by the detector, the xy plane may be specified as being orthogonal to the direction of observation between the detector and object being detected.

As used herein, the term “tissue section” refers to a piece of tissue that has been obtained from a subject, optionally fixed and attached to a surface, e.g., a microscope slide.

The term “spatial proximity” as used herein refers to a criterion or metric that groups cells based on their physical locations relative to each other. For example, cells that are geographically closer are more likely to be grouped together, suggesting that their spatial arrangement may reflect underlying biological or functional similarities. Spatial proximity may be reported as a value or vector indicating the relative distance between two or more cells. In embodiments, spatial proximity may be represented or quantified by creating a frequency vector, v_{SP}, where each element of the vector represents the distance between a cell and other cells.

The term “transcriptional similarity” as used herein refers to a criterion or metric that clusters cells based on the similarity of their gene expression profiles (e.g., as identified by a shared or similar signature). For example, cells that exhibit similar sets or levels of genes are grouped together, indicating shared functional states or developmental lineages. Transcriptional similarity may be reported as a value or vector indicating the similarity between two or more cells. In embodiments, transcriptional similarity may be represented or quantified by creating a frequency vector, v_{TS}, where each component of the vector represents the expression of a gene as a fraction of the maximum observed expression level, scaled from 0.0 (no expression) to 1.0 (maximum expression).

The term “phenotypic similarity” as used herein refers to a criterion or metric that involves grouping cells that share similar observable characteristics, such as size, shape, or morphological elements, and/or similar quantities of biomarkers. This phenotypic similarity can reflect shared roles in tissue structure or function. Phenotypic similarity may be reported as a value or vector indicating the similarity between two or more cells. In embodiments, phenotypic similarity may be represented or quantified by creating a frequency vector, v_{PS}, where each vector component is a normalized value representing the extent of a particular phenotypic trait, scaled between 0.0 and 1.0 to reflect the relative intensity or prevalence of that trait compared to the maximum observed.

The term “morphological element” or “morphological feature” as used herein generally refers to the form, structure, and/or configuration of the cell or cells. The morphological features of a cell or cells may include spatial proximity, spatial statistics, geometric or topological analysis, cluster density, connectivity within a defined radius, aspects of a cell's appearance (e.g., shape (e.g., circular, elliptic, shmoo-like, dumbbell, star-like, flat, scale-like, columnar, invaginated, having one or more concavely formed walls, having one or more convexly formed walls, prolongated, having appendices, having cilia, having angle(s), having corner(s), etc.), phenotypic similarity, cell-to-cell interaction similarity, size, irregularities in shape and/or size, membrane roughness, cytoplasmic texture, nucleus-to-cytoplasm ratio arrangement, form, structure, patterns of internal and/or external parts, shade (e.g., color, greyscale, etc.).

The term “cell-to-cell interaction similarity” as used herein refers to a criterion or metric that groups cells based on similarities in their interaction patterns with other cells. Cells that participate in similar interaction networks or signaling pathways are likely to influence each other's behavior and function. Cell-to-cell interaction similarity may be reported as a value or vector indicating the level of interaction between two or more cells. In embodiments, the cell-to-cell interaction similarity may be represented or quantified by creating a frequency vector, v_{CC}, where each vector element is normalized to range from 0.0, indicating no interaction, to 1.0, representing the strongest observed interaction, facilitating comparisons of interaction intensity across cells. n embodiments, cell-to-cell interaction similarity is derived from empirical measurements of proximity, contact duration, or correlated molecular activity, as obtained from spatial transcriptomics, fluorescence imaging, or time-lapse microscopy. In embodiments, the v_{CC} vector may be constructed using measurements from known interaction-mediating molecules, such as ligand-receptor co-expression pairs, adhesion molecules, or paracrine signaling factors. In embodiments, the similarity metric may be calculated using cosine similarity, Euclidean distance, or other statistical or geometric comparisons between v_{CC} vectors of different cells. In embodiments, cells exhibiting high cell-to-cell interaction similarity are grouped into shared communication neighborhoods or multicellular phenotypes for purposes of classification, annotation, or functional modeling. In embodiments, cell-to-cell interaction similarity can be used to identify emergent tissue behaviors, characterize immune infiltration patterns, map tumor-stroma interactions, or track differentiation states in organoid or co-culture systems. In embodiments, the v_{CC} vector may serve as a feature space for clustering algorithms or machine learning models, thereby enabling computational identification of interaction-based cell states or dynamic network motifs.

The term “metabolic profile” refers to a categorization scheme based on the analysis of metabolic activities or compound concentrations within cells. Cells are grouped according to their metabolic functions, such as metabolites detected or levels of key metabolic enzymes. n embodiments, the metabolic profile is generated through the detection and quantification of fluorescence intensity, localization, or spectral properties associated with specific dyes, probes, or tagged biomolecules indicative of metabolic state. In embodiments, nucleic acid staining may reflect cell cycle phase or transcriptional activity; protein-associated fluorescence may indicate enzymatic abundance, stress response, or biosynthetic load; and organelle-specific markers may reveal mitochondrial activity, lysosomal content, or endoplasmic reticulum stress, each contributing to the inferred metabolic function. In embodiments, the metabolic profile comprises one or more metrics derived from fluorescence microscopy, flow cytometry, or spectrofluorometric techniques, optionally coupled with computational classification or clustering algorithms to distinguish cellular subpopulations or metabolic phenotypes. In embodiments, a metabolic profile may serve as a surrogate biomarker panel for classifying cells into functional categories such as quiescent, proliferative, apoptotic, or activated, based on their biosynthetic and energy-associated phenotypic features.

The term “immunophenotyping” as used herein refers to a categorization scheme or criterion that classifies cells based on the presence and abundance of specific surface markers characteristic of different immune cell types. For example, differentiating types of immune cells, such as T cells, B cells, and macrophages, helps to elucidate their roles in immune responses and their relevance in disease mechanisms and treatment responses. In embodiments, immunophenotyping is performed by detecting binding interactions between labeled antibodies and target antigens expressed on the exterior of immune cells, wherein the binding events are quantified using fluorescence or other signal-emitting modalities. In embodiments, immunophenotyping includes the detection of canonical immune markers such as CD3, CD4, CD8, CD19, CD56, and HLA-DR, which serve to resolve major immune lineages and functional states within heterogeneous cell populations. In embodiments, immunophenotyping may be conducted using technologies such as flow cytometry, mass cytometry, fluorescence microscopy, or microfluidic-based immunoassays that enable multiparametric analysis at the single-cell level. In embodiments, the results of immunophenotyping are used to determine the composition, activation status, or pathological involvement of immune subsets in contexts including immunotherapy, infection, inflammation, autoimmunity, and cancer.

The term “genetic profile” refers to a categorization scheme that groups cells based on their genetic characteristics, such as mutations, gene deletions, amplification of particular sequences, and histone modifications. In embodiments, a genetic profile comprises data obtained through molecular assays that detect structural or sequence-level alterations in nucleic acids, including single-nucleotide variants (SNVs), insertions and deletions (indels), copy number variations (CNVs), and chromosomal rearrangements. In embodiments, the genetic profile includes epigenetic marks such as histone modifications or DNA methylation patterns, which influence gene expression without altering the primary nucleotide sequence. In embodiments, cells are grouped based on shared genetic features, enabling classification according to oncogenic drivers, susceptibility to targeted therapies, lineage origin, or developmental stage. In embodiments, a genetic profile may be used to guide diagnostic stratification, prognostic modeling, or therapeutic decision-making in the context of personalized medicine, cancer genomics, or developmental biology.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware and systems used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In embodiments, the functions of the systems described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The term “computing device” is used herein to refer to an electronic device equipped with at least a processor. Examples of computing devices may include system or device described herein, mobile devices (e.g., cellular telephones, wearable devices, smartphones, smartwatches, web-pads, tablet computers, Internet enabled cellular telephones, Wi-Fi® enabled electronic devices, personal data assistants (PDAs), laptop computers, etc.), personal computers, and server computing devices. In various embodiments, computing devices may be configured with memory and/or storage as well as networking capabilities, such as network transceiver(s) and antenna(s) configured to establish a wide area network (WAN) connection (e.g., a cellular network connection, etc.) and/or a local area network (LAN) connection (e.g., a wired/wireless connection to the Internet via a Wi-Fi® router, etc.). In embodiments, the computing device is a mobile device, such as a cellular telephone, wearable device, or smartphone (e.g., iPhone, Android, Blackberry, Palm, Symbian, or Windows).

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### II Systems & Kits

In an aspect is provided a system for analyzing a tissue sample including a plurality of cells. In embodiments, the system includes: (a) a memory storing instructions; (b) a processor configured to execute the instructions to: i. process data from a first signal signature generated by a first probe set including oligonucleotide probes capable of binding between 20 to 500 different gene sequences where each probe hybridizes to a nucleic acid molecule including a gene sequence; ii. computationally group cells based on the first signal signature to generate groups of cells; iii. process data from a second signal signature generated by a second probe set including oligonucleotide probes capable of binding between 18,000 and 22,000 different gene sequences where each probe hybridizes to a nucleic acid molecule including a gene sequence; and iv. computationally combine the second signal signatures within each group of cells to generate aggregates of signal signatures.

In an aspect is provided a non-transitory computer-readable medium storing instructions that, when executed by a processor, perform a method for analyzing a tissue sample including a plurality of cells. In embodiments, the method includes (a) instructing to contact the tissue sample with a first probe set including a plurality of oligonucleotide probes that hybridize to nucleic acids corresponding to 20 to 500 gene sequences and generate a first signal signature; (b) instructing to group cells based on the first signal signature to generate groups of cells; (c) instructing to contact the tissue sample with a second probe set including a plurality of oligonucleotide probes that hybridize to nucleic acids corresponding to 18,000 to 22,000 gene sequences and generate a second signal signature; and (d) instructing to computationally combine the second signal signatures within each group of cells to generate aggregates of signal signatures. In embodiments, the non-transitory computer-readable medium is a computing device. In embodiments, the computing device is a personal computer system, server computer system, hand-held or laptop device, multiprocessor system, microprocessor-based system, set top box, programmable consumer electronic, network PC, minicomputer system, mainframe computer system, smartphone, or distributed cloud computing environments that include any of the above systems or devices. The computing device can include one or more processors or processing units, a memory architecture that may include RAM and non-volatile memory. The memory architecture may further include removable/non-removable, volatile/non-volatile computer system storage media. Further, the memory architecture may include one or more readers for reading from and writing to a non-removable, non-volatile magnetic media, such as a hard drive, a magnetic disk drive for reading from and writing to a removable, non-volatile magnetic disk, and/or an optical disk drive for reading from or writing to a removable, non-volatile optical disk such as a CD-ROM or DVD-ROM.

In another aspect is provided a non-transitory computer-readable medium storing instructions that, when executed by a processor, perform a method for analyzing a tissue sample (e.g., one or more methods as described here). In embodiments, the method includes computationally grouping, for example using a machine learning model trained to categorize cells of the tissue sample based on morphological features and related signal signatures, cells based on a first signal signature to generate groups of cells of the tissue sample; and computationally combining, for example, using at least the machine learning model, a second signal signature within each group of cells to generate aggregates of signal signatures.

In an aspect is provided a non-transitory computer-readable medium storing instructions that, when executed by a processor, perform a method for analyzing a tissue sample. In embodiments, the method includes computationally grouping cells based on a first signal signature to generate groups of cells of the tissue sample; and computationally combining a second signal signature within each group of cells to generate aggregates of signal signatures.

In another aspect is provided a non-transitory computer-readable medium storing instructions that, when executed by a processor, perform a method for analyzing a tissue sample, the method including: computationally grouping, using at least a machine learning model trained to categorize cells of the tissue sample based on morphological features and related signal signatures, cells based on a first signal signature to generate groups of cells of the tissue sample; and computationally combining, using at least the machine learning model, a second signal signature within each group of cells to generate aggregates of signal signatures. In embodiments, the morphological features include at least one of spatial proximity, geometric analysis, topological analysis, cluster density, connectivity within a defined radius, irregularities in cellular shape and/or size, membrane roughness, cytoplasmic texture, nucleus-to-cytoplasm ratio.

In embodiments, the computationally grouping cells based on the first signal signature includes the machine learning model using image analysis to quantify morphological features of the cells. In embodiments, the computationally grouping cells based on the first signal signature includes the machine learning model using image analysis to quantify morphological features of the cells. In embodiments, the morphological features quantified by image analysis include, but are not limited to, cell size, shape, aspect ratio, nuclear-to-cytoplasmic ratio, texture, edge irregularity, and spatial organization. In embodiments, the machine learning model applies convolutional neural networks (CNNs), support vector machines (SVMs), or decision tree ensembles to extract and classify feature vectors derived from the segmented cell images. n embodiments, the image analysis is performed on image data acquired via brightfield, phase contrast, fluorescence, or differential interference contrast (DIC) microscopy, wherein each modality provides input for morphological assessment. In embodiments, the morphological features are encoded as numerical descriptors and input into a classification or clustering algorithm to assign cells into subpopulations exhibiting similar visual or structural characteristics. In embodiments, the resulting groupings may reflect phenotypic states associated with differentiation, activation, stress response, or disease pathology, inferred through visual signatures detected and interpreted by the machine learning model.

In embodiments, the system includes one or more processing units CPU(s) (also referred to as processors), one or more network interfaces, a user interface including a display and an input module, a non-persistent, a persistent memory, and one or more communication buses for interconnecting these components. The one or more communication buses optionally include circuitry (sometimes called a chipset) that interconnects and controls communications between system components. The non-persistent memory typically includes high-speed random access memory, such as DRAM, SRAM, DDR RAM, ROM, EEPROM, flash memory, whereas the persistent memory typically includes CD-ROM, digital versatile disks (DVD) or other optical storage, magnetic cassettes, magnetic tape, magnetic disk storage or other magnetic storage devices, magnetic disk storage devices, optical disk storage devices, flash memory devices, or other non-volatile solid state storage devices. The persistent memory optionally includes one or more storage devices remotely located from the CPU(s). The persistent memory, and the non-volatile memory device(s) within the non-persistent memory, comprise non-transitory computer readable storage medium. In embodiments, one or more of the above identified elements are stored in one or more of the previously mentioned memory devices, and correspond to a set of instructions for performing a function described above. The above identified modules, data, or programs (e.g., sets of instructions) need not be implemented as separate software programs, procedures, datasets, or modules, and thus various subsets of these modules and data may be combined or otherwise re-arranged in various implementations.

In embodiments, the computing device includes memory in electronic communication with the processor. The memory architecture may include at least one program module implemented as executable instructions that are configured to carry out one or more steps of a method set forth herein. For example, executable instructions may include an operating system, one or more application programs, other program modules, and program data. Generally, program modules may include routines, programs, objects, components, logic, and data structures that perform particular tasks. A computing device can optionally communicate with one or more external devices such as a keyboard, a pointing device (e.g., a mouse), a display, such as a graphical user interface (GUI), or other device that facilitates interaction of a use with the unmanned autonomous vehicle. Similarly, the computing device can communicate with other devices (e.g., via network card, modem, etc.). Such communication can occur via I/O interfaces. In embodiments, the computing system may communicate with one or more networks such as a local area network (LAN), a general wide area network (WAN), and/or a public network (e.g., the Internet) via a suitable network adapter.

In embodiments, the systems and devices generate data that may be used to form an image. In embodiments, the image includes a 2D or 3D representation of the tissue. In some embodiments, one or more of the images include an image of other analytes, such as proteins in a biological sample. In some embodiments, an image is acquired using transmission light microscopy (e.g., bright field transmission light microscopy, dark field transmission light microscopy, oblique illumination transmission light microscopy, dispersion staining transmission light microscopy, phase contrast transmission light microscopy, differential interference contrast transmission light microscopy, emission imaging, etc.). In embodiments, the image is in any file format including but not limited to JPEG/JFIF, TIFF, Exif, PDF, EPS, GIF, BMP, PNG, PPM, PGM, PBM, PNM, WebP, HDR raster formats, HEIF, BAT, BPG, DEEP, DRW, ECW, FITS, FLIF, ICO, ILBM, IMG, PAM, PCX, PGF, JPEG XR, Layered Image File Format, PLBM, SGI, SID, CDS, CPT, PSD, PSP, XCF, PDN, CGM, SVG, PostScript, PCT, WMF, EMF, SWF, XAML, and/or RAW. In embodiments, the image is represented as an array (e.g., matrix) comprising a plurality of pixels, such that the location of each respective pixel in the plurality of pixels in the array (e.g., matrix) corresponds to its original location in the image. In some embodiments, an image is represented as a vector comprising a plurality of pixels, such that each respective pixel in the plurality of pixels in the vector comprises spatial information corresponding to its original location in the image.

In embodiments, a pixel includes one or more pixel values (e.g., intensity value). In embodiments, each respective pixel in the plurality of pixels includes one pixel intensity value, such that the plurality of pixels represents a single-channel image comprising a one-dimensional integer vector comprising the respective pixel values for each respective pixel. For example, an 8-bit single-channel image (e.g., grey-scale) can include 28 or 256 different pixel values (e.g., 0-255). In embodiments, each respective pixel in the plurality of pixels of an image includes a plurality of pixel values, such that the plurality of pixels represents a multi-channel image comprising a multi-dimensional integer vector, where each vector element represents a plurality of pixel values for each respective pixel. For example, a 24-bit 3-channel image (e.g., RGB color) can include 2²⁴ (e.g., 2^{8×3}) different pixel values, where each vector element comprises 3 components, each between 0-255. In some embodiments, an n-bit image includes up to 2ⁿ different pixel values, where n is any positive integer.

In embodiments, each pixel in the plurality of pixels of the image has a pixel size (resolution) between 0.8 pm and 4.0 pm. In embodiments the pixel size is derived by dividing the camera pixel size (resolution) by the magnification of the objective lens of the camera used to capture values for the plurality of pixels. In embodiments, each pixel in the plurality of pixels has a pixel size between 0.4 pm and 5.0 pm. In embodiments, each pixel in the plurality of pixels of the image has a pixel size (resolution) between 0.8 pm and 4.0 pm or between 0.4 pm and 5.0 pm.

In embodiments, the data processor provides the image for display via a display of the computing device. In embodiments, the image is provided for display via a GUI configured within the display of the computing device. In embodiments, the data processor receives an input identifying one or more modifications and/or one or more image analysis steps based on the provided image. For example, the display of the computing device can include a touchscreen display configured to receive a user input identifying a respective pattern of an image of the biological sample on the displayed image. In embodiments, the GUI can be configured to receive a user provided input identifying the modifications and/or one or more image analysis steps.

### III. Methods

In an aspect is provided a method of analyzing a tissue sample including a plurality of cells. In embodiments, the method includes contacting the tissue sample with a first probe set including a plurality of oligonucleotide probes capable of binding a first quantity of different gene sequences, wherein each oligonucleotide probe is capable of hybridizing to a nucleic acid molecule including a gene sequence, and generating a first signal signature for each bound oligonucleotide probe; computationally grouping cells based on the first signal signature to generate groups of cells; contacting the tissue sample with a second probe set including a plurality of oligonucleotide probes capable of binding a second quantity of different gene sequences, wherein each oligonucleotide probe is capable of hybridizing to a nucleic acid molecule including a gene sequence, and generating a second signal signature for each bound oligonucleotide probe; and computationally combining the second signal signatures within each group of cells to generate aggregates of signal signatures, wherein the first quantity is less than the second quantity. In embodiments, the method generates one or more data set(s). For example, the signal signatures may be stored as a data set.

In embodiments, the method includes using the aggregates of signal signatures to determine cellular heterogeneity, spatial organization, functional states of cells and tissues, gene regulation and signaling pathways, disease associations, developmental lineages, interaction networks, immune profiling, therapeutic response predictions, and molecular phenotyping. For example, by analyzing the aggregates of signal signatures, the method can uncover the degree of heterogeneity within the tissue sample, involving identifying different cell types, subtypes, or states, and understanding their distribution and prevalence within the tissue context. Because spatial information is preserved during sample processing, the aggregated signals can help elucidate the spatial organization of cell types within the tissue. By comparing expression profiles, the method enables the inference of functional states of cells, such as activation states in immune cells, differentiation stages in developmental biology, or stress responses in disease contexts. In embodiments, the aggregated data can reveal upregulated or downregulated genes and pathways in specific cell groups, providing insights into the regulatory mechanisms, including understanding signal transduction pathways, transcriptional networks, and epigenetic influences impacting gene expression. In embodiments, analyzing the data aggregates can help identify markers or signatures associated with disease conditions, such as cancer, inflammation, or degenerative diseases, thereby aiding in diagnostic, prognostic, and therapeutic target identification. In embodiments, the signal aggregates can be used to trace cell lineages and developmental trajectories. In embodiments, the aggregated signals can map out interaction networks between cells (i.e., the interactome), identifying which cell types are likely interacting or influencing each other within a tissue. In embodiments, the aggregated signal data can provide detailed insights into the immune cell repertoire, the state of immune activation or suppression, and the presence of specific immune subpopulations, which are critical for conditions like autoimmune diseases, infections, and cancer immunology. In embodiments, aggregated signal data may predict how different cell populations within a tumor or diseased tissue might respond to various treatments based on their molecular profiles. Beyond identifying cell types, the aggregated signal signatures allow for detailed molecular phenotyping, providing a deeper understanding of the molecular characteristics that define each cell group within the tissue.

In embodiments, the method includes contacting the tissue sample with a first probe set including a plurality of oligonucleotide probes capable of binding between 20 to 500 different gene sequences, wherein each oligonucleotide probe is capable of hybridizing to a nucleic acid molecule including a gene sequence, and generating a first signal signature for each bound oligonucleotide probe; computationally grouping cells based on the first signal signature to generate groups of cells; contacting the tissue sample with a second probe set including a plurality of oligonucleotide probes capable of binding between 18,000 and 22,000 different gene sequences, wherein each oligonucleotide probe is capable of hybridizing to a nucleic acid molecule including a gene sequence, and generating a second signal signature for each bound oligonucleotide probe; and computationally combining the second signal signatures within each group of cells to generate aggregates of signal signatures. In embodiments, each group of cells is grouped together based on spatial proximity, metabolic profile, genetic profile, transcriptional similarity, phenotypic similarity, or cell-to-cell interaction similarity.

In another aspect is provided a computer-implemented method for analyzing a tissue sample is provided. In embodiments, the method includes computationally grouping, for example using at least a machine learning model, cells based on a first signal signature to generate groups of cells of the tissue sample; and computationally combining, using at least the machine learning model, a second signal signature within each group of cells to generate aggregates of signal signatures. In embodiments, the machine learning model is trained to categorize cells of the tissue sample based on morphological features and related signal signatures, for example, signal signatures as described herein. In embodiments, the method includes computationally grouping cells based on a first signal signature to generate groups of cells of the tissue sample; and computationally combining a second signal signature within each group of cells to generate aggregates of signal signatures.

In another aspect is provided a computer-implemented method for analyzing electronic images of a tissue sample. In embodiments, the method includes computationally grouping, using a machine learning model, cells based on a first signal signature to generate groups of cells of the tissue sample; and computationally combining, using at least the machine learning model, a second signal signature within each group of cells to generate aggregates of signal signatures. In embodiments, the machine learning model is trained to categorize cells based on the of the tissue sample based on morphological features and related signal signatures.

In embodiments, computationally grouping cells based on the first signal signature includes the machine learning model using image analysis to quantify morphological features of the cells.

In embodiments, a training dataset of the machine learning model includes labeled cellular images with a plurality of morphological features.

In embodiments, the morphological features include at least one of spatial proximity, geometric analysis, topological analysis, cluster density, connectivity within a defined radius, irregularities in cellular shape and/or size, membrane roughness, cytoplasmic texture, nucleus-to-cytoplasm ratio.

In embodiments, the machine learning model includes a graph-based aggregation model including at least one graph-based clustering algorithm, wherein the computationally grouping includes the graph-based aggregation model computationally grouping cells into subgroups using graph-based aggregation.

In embodiments, the machine learning model includes a graph-based aggregation model, and wherein the computationally grouping includes: identifying similar groups of cells using at least unsupervised clustering on a data matrix; and representing distinct cell compositions and/or distinct cell states, using at least the unsupervised clustering with a fixed resolution.

In embodiments, the machine learning model includes a graph-based aggregation model, and wherein the computationally grouping includes: generating, using at least joint transcriptional and proteomic profiles of the graph-based aggregation model, a neighborhood graph; and deriving, using at least the graph-based aggregation model, phenotypic similarity among the group of cells by applying at least unsupervised clustering on the neighborhood graph.

In embodiments, the method includes calculating, using at least the machine learning model and at least one clustering algorithm, a Euclidean distance and/or cosine similarities between pairs of expression vectors of a spatial dataset including locations of cells of the tissue sample.

In embodiments, the method includes computationally classifying, using at least the machine learning model and one or more unsupervised clustering algorithms, cells of the tissue sample into phenotypically and transcriptomically similar groups within a tissue section; and mapping, using at least the machine learning model, locations of neurons alongside transcriptomically similar groups.

In embodiments, the method includes computationally classifying, using at least the machine learning model, a similarity score, and a segmentation algorithm, cells of the tissue sample into segmented phenotypically similar groups.

In embodiments, the machine learning model computationally groups the cells based on the first signal signature using at least k-means clustering.

In embodiments, the machine learning model computationally groups the cells based on the first signal signature using at least unsupervised hierarchical clustering.

In embodiments, the machine learning model computationally groups the cells based on the first signal signature using at least unsupervised dimensionality reduction clustering.

In embodiments, the machine learning model computationally groups the cells based on the first signal signature using at least machine learning clustering.

In an aspect is provided a computer-implemented method for analyzing electronic images a tissue sample, including: clustering, using at least a machine learning model trained to categorize cells of the tissue sample based on morphological features and related signal signatures, cells based on a first signal signature to generate groups of cells of the tissue sample; and computationally combining, using at least the machine learning model, a second signal signature within each group of cells to generate aggregates of signal signatures. In embodiments, the method further includes calculating, using at least the machine learning model and at least one clustering algorithm, a Euclidean distance and/or cosine similarities between pairs of expression vectors of a spatial dataset including locations of cells of the tissue sample.

In embodiments, the method includes computationally classifying, using at least the machine learning model, a similarity score, and a segmentation algorithm, cells of the tissue sample into segmented phenotypically similar groups.

In embodiments, the morphological features include at least one of spatial proximity, geometric analysis, topological analysis, cluster density, connectivity within a defined radius, irregularities in cellular shape and/or size, membrane roughness, cytoplasmic texture, nucleus-to-cytoplasm ratio.

In embodiments, the computationally grouping cells based on the first signal signature includes the machine learning model using image analysis to quantify morphological features of the cells.

In embodiments, a training dataset of the machine learning model includes labeled cellular images with a plurality of morphological features.

Computational grouping may be referred to herein as “clustering”. Clustering is described in Duda and Hart, Pattern Classification and Scene Analysis, 1973, John Wiley & Sons, Inc., New York, (see, for example pages 211-256) which is hereby incorporated by reference in its entirety. Computational grouping may be considered as finding natural groupings in a data set, or a collection information elements. To identify natural groupings, first, a way to measure similarity (and/or dissimilarity) between two elements is determined. This similarity measure is used to ensure that the elements in one cluster are more like one another than they are to elements in other clusters. Second, a mechanism for partitioning the data into clusters using the similarity measure is determined. One way to begin clustering is to define a distance function and to compute the matrix of distances between all pairs of elements in a data set. If distance is a good measure of similarity, then the distance between elements in the same cluster will be significantly less than the distance between elements in different clusters. Worth noting, clustering does not require the use of a distance metric. For example, a nonmetric similarity function s(x, x′) can be used to compare two vectors x and x′. More information on clustering techniques can be found in Kaufman and Rousseeuw, 1990, Finding Groups in Data: An Introduction to Cluster Analysis, Wiley, New York, N.Y.; Everitt, 1993, Cluster analysis (Third Edition), Wiley, New York, N.Y.; and Backer, 1995, Computer Assisted Reasoning in Cluster Analysis, Prentice Hall, Upper Saddle River, N.J.

In embodiments, computational grouping may cluster a plurality of vectors including hierarchical clustering (agglomerative clustering using nearest-neighbor algorithm, farthest-neighbor algorithm, the average linkage algorithm, the centroid algorithm, or the sum-of-squares algorithm), k-means clustering, fuzzy k-means clustering algorithm, and/or Jarvis-Patrick clustering. In embodiments, k-means clustering is used. The goal of k-means clustering is to cluster the signal signature value dataset based upon the principal components into K partitions. In embodiments, no predetermined number of clusters is selected. Instead, clustering is performed until predetermined convergence criteria are achieved.

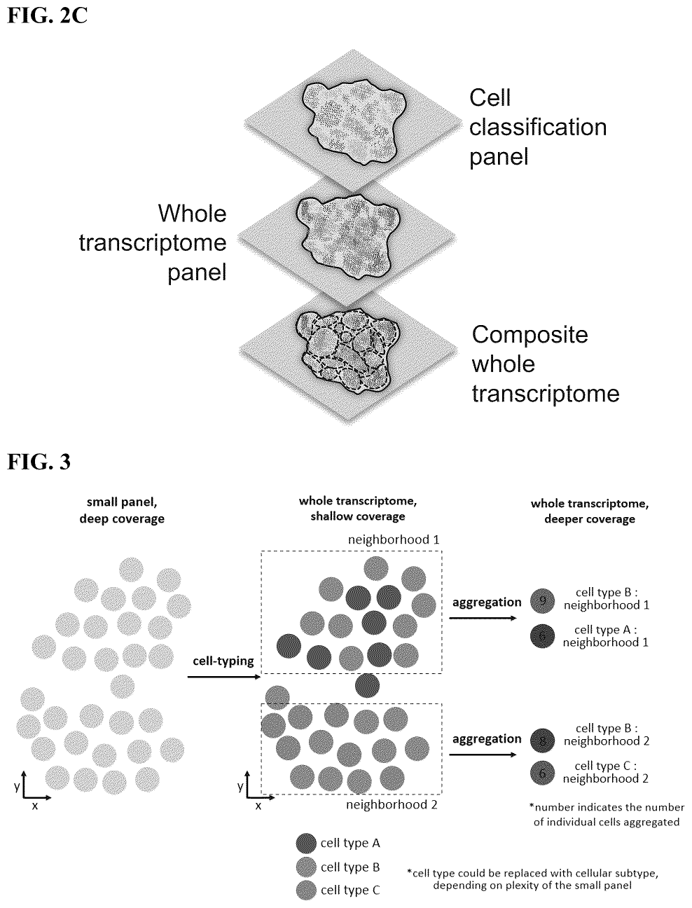

In embodiments, each group of cells is grouped together based on spatial proximity. For example, cells could be grouped based on physical closeness, e.g., as quantified by distance metrics like Euclidean distance (x, y, z coordinates, or a vector in Euclidian space) in a spatial dataset that maps the locations of cells. Spatial statistics and geometric or topological analysis might be used to define thresholds for colocation, such as nearest neighbor distance, cluster density, or connectivity within a defined radius. In embodiments, the method delineated in FIG. 3 involves initially typing cells using a small gene panel with deep coverage to accurately categorize cells into distinct types based on key genetic markers. Following this, the whole transcriptome analysis (i.e., probes set 2) with shallow coverage expands the scope of genetic profiling across all cells, identifying broader transcriptional activities that define the cell's role within the tissue. Subsequently, cells are grouped into neighborhoods based on shared characteristics and spatial proximity, enhancing the biological relevance of the data. Data aggregation within these neighborhoods allows for a deeper analysis of cellular interactions and functions, highlighting the dynamics within the cellular microenvironment. In embodiments, the distance is a Euclidean distance. In embodiments, other distance metrics are used (e.g., Chebyshev distance, Mahalanobis distance, Manhattan distance, etc.).

In embodiments, each group of cells is grouped together based on metabolic profile. Similarity here could involve comparing concentrations of metabolites or patterns of metabolic activity. Statistical methods such as Pearson correlation or principal component analysis (PCA) could help provide a means for quantifying similarity. Principal component analysis (PCA) is a mathematical procedure that reduces a number of correlated variables into a fewer uncorrelated variables called “principal components.” The first principal component is selected such that it accounts for as much of the variability in the data as possible, and each succeeding component accounts for as much of the remaining variability as possible. The purpose of PCA is to discover or to reduce the dimensionality of the dataset, and to identify new meaningful underlying variables. PCA is accomplished by establishing actual data in a covariance matrix or a correlation matrix. The mathematical technique used in PCA is called eigen analysis: one solves for the eigenvalues and eigenvectors of a square symmetric matrix with sums of squares and cross products. The eigenvector associated with the largest eigenvalue has the same direction as the first principal component. The eigenvector associated with the second largest eigenvalue determines the direction of the second principal component. The sum of the eigenvalues equals the trace of the square matrix and the maximum number of eigenvectors equals the number of rows (or columns) of this matrix. In embodiments, the computational grouping includes Pearson's correlation, Spearman's correlation, Kendall's Tau, Cosine similarity, Jaccard similarity, Euclidean distance, or Manhattan distance.

In embodiments, each group of cells is grouped together based on genetic profile. Genetic similarity might be assessed through shared gene expression profiles (e.g., cells containing approximately the same amount number and type of genes), SNP patterns, or mutational similarities.

In embodiments, each group of cells is grouped together based on transcriptional similarity. Transcriptional similarity may be evaluated by comparing cosine similarity or hierarchical clustering based on gene expression levels. In embodiments, transcriptional similarity is evaluated using cosine similarity, a metric that measures the cosine of the angle between two vectors in a multi-dimensional space, where each vector represents the gene expression profile of a cell. Cells are grouped based on the closeness of this cosine value to 1, indicating that the gene expression profiles are more similar. For example, immune cells activated by the same pathogen may cluster tightly as their transcriptional responses, involving upregulation of specific immune response genes, are highly similar. In embodiments, hierarchical clustering is utilized to assess transcriptional similarity, where cells are grouped based on a dendrogram that iteratively merges cells or existing clusters with the highest similarity in gene expression. Hierarchical clustering may use average linkage, where the average distance between all pairs in any two clusters is used to determine the clusters to merge. In embodiments, a combination of cosine similarity and hierarchical clustering is employed to refine the grouping of cells. Initially, cosine similarity helps in creating rough clusters of cells with similar transcriptional profiles. Subsequently, hierarchical clustering further organizes these clusters into a hierarchy, providing a detailed map of transcriptional relationships.

In embodiments, each group of cells is grouped together based on phenotypic similarity. In embodiments, grouped together based on phenotypic similarity includes quantifying measurable cell traits like size, shape, and other morphological features. Image analysis and pattern recognition algorithms could be applied to categorize cells into groups based on these traits. In embodiments, phenotypic similarity is evaluated using advanced image analysis techniques to measure and compare the morphology of cells. Image processing software may be used to quantify various cell traits such as size, shape, granularity, and the complexity of the cell structure. For example, neurons could be grouped based on the length and branching patterns of their dendrites. In embodiments, pattern recognition algorithms are employed to analyze the visual and morphometric data collected through the method described herein. The algorithms, which may include machine learning models such as neural networks or support vector machines, learn to categorize cells based on their morphological features. For example, cancer cells could be differentiated from normal cells in tissue samples based on irregularities in shape and size. In embodiments, a combination of image analysis and pattern recognition algorithms is used to enhance the accuracy and objectivity of grouping cells based on phenotypic similarity. First, image analysis software quantifies detailed morphological features of cells, such as membrane roughness, cytoplasmic texture, and nucleus-to-cytoplasm ratio. Then, pattern recognition algorithms classify these cells into groups based on learned phenotypic patterns.

In embodiments, the neural networks are designed by the modification of neural networks such as AlexNet, VGGNet, GoogLeNet, Graph Convolutional Network, ResNet (residual networks), DenseNet, and Inception networks. In some examples, the enhanced neural networks are designed by modification of ResNet (e.g. ResNet 18, ResNet 34, ResNet 50, ResNet 101, and ResNet 152) or inception networks.

In embodiments, the algorithms can use artificial intelligence, such as one or more machine learning algorithms. In embodiments, the machine learning model (e.g., a metamodel) may be trained by using a learning model and applying learning algorithms (e.g., machine learning algorithms) on a training dataset (e.g., a dataset comprising labeled cellular or tissue images with one or more morphological or phenotypic features). In embodiments, a machine learning model may be the actual trained model that is generated based on the training model.

The machine learning algorithm as disclosed herein may be configured to identify and/or extract one or more morphological features of a cell from the image data. The machine learning algorithm may form a new data set based on the morphological features, and the new data set need not contain the original image data of the cell. In some examples, extracted morphological features can be utilized as new molecular markers for a cell or population of cells. Systems and related applications of this disclosure can be operatively coupled to one or more databases comprising non-morphological data of cells processed (e.g., genomics data, signal signature data, oligonucleotide probe data, spatial transcriptomics data, cellular spatial location data, target biomolecule data, etc.).

Non-limiting examples of machine learning algorithms for training a machine learning model may include supervised learning, unsupervised learning, semi-supervised learning, reinforcement learning, self-learning (also referred to as self-supervised learning), feature learning, anomaly detection, association rules, etc. In some examples, a machine learning model may be trained by using one or more learning models on such training dataset. Non-limiting examples of learning models may include artificial neural networks (e.g., convolutional neural networks, U-net architecture neural network, etc.), backpropagation, boosting, decision trees, support vector machines, regression analysis, Bayesian networks, genetic algorithms, kernel estimators, conditional random field, random forest, ensembles of machine learning models, minimum complexity machines (MCM), probably approximately correct learning (PACT), etc.

In some embodiments, unsupervised and self-supervised approaches may be used. For the example of unsupervised, an embedding for a cell image may be generated. For example, the embedding may be a representation of the image in a space with reduced dimensions than the original image data whereby such embeddings can be used to cluster images similar to one another. Thus, the labeler may be configured to batch-label. In some examples, for the example of self-supervised learning, additional meta information (e.g., additional non-morphological information) can be used for labeling of image data of cells.

In some examples, for clustering-based labeling of image data, as disclosed herein, an expanding training data set can be used. With the expanding training data set, one or more revisions of labeling (e.g., manual relabeling) can be needed to, e.g., avoid the degradation of model performance due to the accumulated effect of mislabeled images. Such manual relabeling can be intractable on a large scale and ineffective when done on a random subset of the data. Thus, to systematically surface images for potential relabeling, for example, similar embedding-based clustering can be used to identify labeled images that may cluster with members of other classes. Such examples are likely to be enriched for incorrect or ambiguous labels, which can be removed (e.g., automatically or manually).

In any of the examples disclosed herein, the associated model(s) may be validated (e.g., for the ability to demonstrate accurate cell classification performance). Non-limiting examples of validation metrics that may be utilized may include, but are not limited to, threshold metrics (e.g., accuracy, F-measure, Kappa, Macro-Average Accuracy, Mean-Class-Weighted Accuracy, Optimized Precision, Adjusted Geometric Mean, Balanced Accuracy, etc.), the ranking methods and metrics (e.g., receiver operating characteristics (ROC) analysis or “ROC area under the curve (ROC AUC)”), and the probabilistic metrics (e.g., root-mean-squared error). For example, the model(s) may be determined to be balanced or accurate when the ROC AUC is greater than about 0.5, greater than about 0.55, greater than about 0.6, greater than about 0.65, greater than about 0.7, greater than about 0.75, greater than about 0.8, greater than about 0.85, greater than about 0.9, greater than about 0.91, greater than about 0.92, greater than about 0.93, greater than about 0.94, greater than about 0.95, greater than about 0.96, greater than about 0.97, greater than about 0.98, greater than about 0.99, or more.

As noted further in this disclosure, the output of the model may include, or may consist essentially of, or may consist of, at least one multidimensional vector. Elements of the vector(s) for a given image may correspond to the values of respective features that the model extracted from that image. In some examples, the machine learning model extracts n ML-based features from each image (where n is a positive integer), and outputs an array of length n, which array may be considered to be an n-dimensional vector. In one example, the ML-based features are not human-interpretable. In one example, because the ML-based features are identified using machine learning, AI, or both, the features are not human-interpretable. For example, the elements of the vector generated by the machine learning encoder may have numeric values, such as [0.1 4 2.3 . . . 10], that correspond to the quantitative “amount” of certain features that the machine learning encoder has identified as being present or not in a given image.

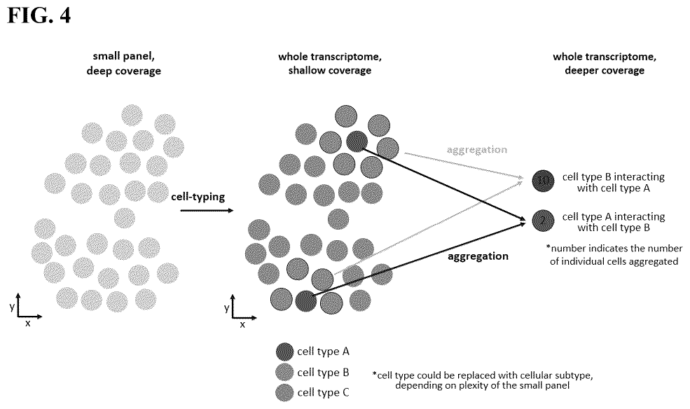

In embodiments, each group of cells is grouped together based on cell-to-cell interaction similarity. Network analysis techniques could be used to group cells that show similar interaction patterns. For example, FIG. 4 provides a visualization as to how cells may be grouped and analyzed based on their interaction patters and transcriptomic data. In embodiments, using network analysis techniques, cells are grouped not only by their transcriptional profiles but also by their interaction patterns. As depicted in FIG. 4, cells initially undergo cell-typing using a deeply covered small panel, allowing precise identification of cell types. Subsequently, cells are subjected to whole transcriptome analysis with shallow coverage to capture a broader range of genetic expressions across a larger set of genes. An advantage of this approach involves the aggregation of data where cells that exhibit similar interaction patterns—such as cell type B frequently interacting with cell type A—are grouped together. This aggregation is quantified, as shown by the number of cells aggregated in each interaction type, highlighting the most prevalent cellular interactions within the sample.

In embodiments, a Leiden-based graph algorithm may be used to computationally analyze or transpose the gene expression data. A Leiden algorithm constructs a graph where each cell represents a node, and edges between them are weighted by similarities in their expression profiles, typically measured through metrics such as Euclidean distances or cosine similarities. The Leiden algorithm then iteratively refines the community detection, ensuring that the resultant clusters are highly interconnected internally, yet distinctly separated from other groups. This approach is particularly effective in capturing the nuanced structure of cellular heterogeneity, providing robust partitions even in complex and densely interconnected datasets.

The description of the terms below is merely exemplary and is not intended to limit the terms in any way. In some examples, the machine learning model may include a hybrid architecture that incorporates aspects of both a CNN, a graph neural network, SVM, random forest, etc. The machine learning algorithms of this disclosure may be implemented in multiple ways. For example, according to one embodiment, the algorithm may be implemented by any one or any combination of (1) machine learning algorithms and/or architectures, such as neural network methods, e.g., convolutional neural networks (CNNs) and recurrent neural networks (RNNs); (2) training methodologies, such as Multiple Instance Learning, Reinforcement Learning, Active Learning, etc.; (3) attribute/feature extraction including but not limited to any one or any combination of estimated percentage of tissue in slide, base statistics on RGB, HSV or other color-space, and presence of issues or imaging artifacts such as blobs, spots, bubbles, tissue folds, abnormal staining, etc.; (4) using measure(s) of uncertainty in the model predictions over other metrics as a proxy for needing additional information; and (5) the output or associated metrics from models trained on a different task.

According to one or more embodiments, any of the above algorithms, architectures, methodologies, attributes, and/or features may be combined with any or all of the other algorithms, architectures, methodologies, attributes, and/or features. For example, any of the machine learning algorithms and/or architectures (e.g., neural network methods, convolutional neural networks (CNNs), recurrent neural networks (RNNs), etc.) may be trained with any of the training methodologies (e.g., Multiple Instance Learning, Reinforcement Learning, Active Learning, etc.).

In embodiments, computationally grouping cells based on the first signal signature includes k-means clustering, hierarchical clustering, dimensionality reduction clustering, or machine learning clustering. The machine learning algorithm as disclosed herein may utilize one or more clustering algorithms to determine that objects (e.g., features) in the same cluster may be more similar (in one or more morphological features) to each other than those in other clusters. The machine learning algorithm may utilize a plurality of models, e.g., in equal weights or in different weights. In some examples, the graph-based models may include graph-based clustering algorithms that use modularity. Non-limiting examples of the clustering algorithms used in computational grouping based on the first signal signature of this disclosure can include, but are not limited to, connectivity models (e.g., hierarchical clustering), centroid models (e.g. K-means algorithm), distribution models (e.g., expectation-maximization algorithm), density models (e.g., density-based spatial clustering of applications with noise (DBSCAN), ordering points to identify the clustering structure (OPTICS)), subspace models (e.g., biclustering), group models, graph-based models (e.g., highly connected subgraphs (HCS) clustering algorithms), single graph models, and neural models (e.g., using unsupervised neural network). In embodiments, computationally grouping cells based on the first signal signature includes using k-means clustering to partition the cells into clusters based on their signal signature similarities. In embodiments, computationally grouping cells based on the first signal signature includes applying hierarchical clustering to organize the cells into a tree-based structure reflecting the hierarchical similarities among their signal signatures. In embodiments, computationally grouping cells based on the first signal signature includes employing dimensionality reduction clustering techniques, such as t-SNE or PCA, to visualize and analyze patterns in the data that may not be immediately apparent in higher-dimensional space. In embodiments, computationally grouping cells based on the first signal signature includes utilizing machine learning clustering algorithms, which may involve supervised or unsupervised learning models to classify cell types and states based on their complex signal signature profiles. In embodiments, the method includes computationally grouping (e.g., clustering) of all or a subset of the cells including k-means clustering with K set to a predetermined value between one and twenty-five. In embodiments, computational grouping may include mapping, curvilinear components analysis, stochastic neighbor embedding, Isomap, maximum variance unfolding, locally linear embedding, or a Laplacian Eigenmap.

In some examples, unsupervised and self-supervised approaches may be used to expedite the method and/or operations.

In embodiments, the probes of the first set are capable of binding between 75 and 150 different gene sequences. In embodiments, the probes are capable of binding between 25 and 75 different gene sequences. In embodiments, the probes are capable of binding between 30 and 100 different gene sequences. In embodiments, the probes are capable of binding between 40 and 120 different gene sequences. In embodiments, the probes are capable of binding between 50 and 150 different gene sequences. In embodiments, the probes are capable of binding between 60 and 180 different gene sequences. In embodiments, the probes are capable of binding between 70 and 200 different gene sequences. In embodiments, the probes are capable of binding between 80 and 220 different gene sequences. In embodiments, the probes are capable of binding between 90 and 250 different gene sequences. In embodiments, the probes are capable of binding between 100 and 300 different gene sequences. In embodiments, the probes are capable of binding between 150 and 400 different gene sequences.

In embodiments, the oligonucleotide probes of the first probe set are capable of binding to nucleic acid molecules including a CD3D gene sequence, CD3E gene sequence, CD4 gene sequence, CD8A gene sequence, CD8B gene sequence, CD19 gene sequence, MS4A1 gene sequence, CR2 gene sequence, CDH1 gene sequence, KRT18 gene sequence, KRT8 gene sequence CD14 gene sequence, ITGAM gene sequence, CD33 gene sequence, MPO gene sequence, PECAMI gene sequence, VWF gene sequence, CDH5 gene sequence, CD38 gene sequence, SDC1 gene sequence, PRDM1 gene sequence, FCGR3B gene sequence, ELANE gene sequence, CD68 gene sequence, ADGRE1 gene sequence, HLA-DRA gene sequence, CD163 gene sequence, NCAM1 gene sequence, FCGR3A gene sequence, NCR1 gene sequence, ITGAX gene sequence, IL3RA gene sequence, CLEC4L gene sequence, ACP5 gene sequence, CTSK gene sequence, CALCR gene sequence, ALPL gene sequence, BGLAP gene sequence, TNFSF11 gene sequence, COL2A1 gene sequence, ACAN gene sequence, and/or a SOX9 gene sequence.

In embodiments, the oligonucleotide probes are capable of binding to nucleic acid molecules including a CD3D gene sequence, CD3E gene sequence, CD4 gene sequence, CD8A gene sequence, CD8B gene sequence, CD19 gene sequence, MS4A1 gene sequence (encodes CD20 protein), CR2 gene sequence (encodes CD21 protein), CDH1 gene sequence (encodes E-cadherin protein), KRT18 gene sequence, KRT8 gene sequence CD14 gene sequence, ITGAM gene sequence (encodes CD11b protein), CD33 gene sequence, MPO gene sequence (encodes myeloperoxidase protein), PECAMI gene sequence (encodes CD31 protein), VWF gene sequence (encodes von Willebrand factor protein), CDH5 gene sequence (encodes VE-cadherin protein), CD38 gene sequence, SDC1 gene sequence (encodes CD138 protein), PRDM1 gene sequence (encodes Blimp-1 protein), FCGR3B gene sequence (encodes CD16b protein), ELANE gene sequence (encodes elastase protein), CD68 gene sequence, ADGRE1 gene sequence (encodes F4/80), HLA-DRA gene sequence, CD163 gene sequence, NCAM1 gene sequence (encodes CD56 protein), FCGR3A gene sequence (encodes CD16a protein), NCR1 gene sequence (encodes NKp46 protein), ITGAX gene sequence (encodes CD11c protein), IL3RA gene sequence (encodes CD123 protein), CLEC4L gene sequence, ACP5 gene sequence (encodes TRAP protein), CTSK gene sequence (encodes Cathepsin K protein), CALCR gene sequence (encodes Calcitonin receptor protein), ALPL gene sequence (encodes Alkaline phosphatase protein), BGLAP gene sequence (encodes osteocalcin protein), TNFSF11 gene sequence (encodes RANKL protein), COL2A1 gene sequence (encodes Collagen type II protein), ACAN gene sequence (encodes Aggrecan protein), and/or a SOX9 gene sequence.

In embodiments, the oligonucleotide probes are capable of binding to nucleic acid molecules including a CD3D gene sequence, CD3E gene sequence, CD4 gene sequence, CD8A gene sequence, or a CD8B gene sequence. Detection of CD3D, CD3E, CD4, CD8A, and/or CD8B is typically associated with T cells, and may be useful for identifying and classifying the respective cell type. In embodiments, the oligonucleotide probes are capable of binding to nucleic acid molecules including a CD2, CD5, CD7, CD28, CTLA4, CD45RA, CD45RO, TCRA, TCRB, GZMB, or FOXP3 gene sequence.

In embodiments, the oligonucleotide probes are capable of binding to nucleic acid molecules including a CD19 gene sequence, MS4A1 gene sequence, or a CR2 gene sequence. Detection of CD19, MS4A1, and/or CR2 is typically associated with B cells, and may be useful for identifying and classifying the respective cell type. In embodiments, the oligonucleotide probes are capable of binding to nucleic acid molecules including a CD22, CD79A, CD79B, CD40, BAFFR, PAX5, BLK, BCL6, IGHM, IGLL1, CD38, CD138, CD5, FCRL4, CD72, or AICDA gene sequence.

In embodiments, the oligonucleotide probes are capable of binding to nucleic acid molecules including a CDH1 gene sequence, KRT18 gene sequence, or a KRT8 gene sequence. Detection of CDH1, KRT18, and/or KRT8 is typically associated with epithelial cells, and may be useful for identifying and classifying the respective cell type. Epithelial cells are key to studies on tissue barriers, organ morphology, and carcinomas, where their identification helps delineate cellular roles and transformations in various tissues. In embodiments, the oligonucleotide probes are capable of binding to nucleic acid molecules including an EPCAM, OCLN, CLDN1, TJP1, MUC1, KRT19, KRT7, DSP, CD24, SNAI1, or a VIM gene sequence.

In embodiments, the oligonucleotide probes are capable of binding to nucleic acid molecules including a CD14 gene sequence, ITGAM gene sequence, CD33 gene sequence, or a MPO gene sequence. Detection of CD14, ITGAM, CD33, and/or MPO is typically associated with myeloid cells, and may be useful for identifying and classifying the respective cell type. In embodiments, the oligonucleotide probes are capable of binding to nucleic acid molecules including a CD11b, CD16, CD64, CD15, LYZ, C3AR1, CSF1R, CCR2, HLA-DR, S100A9, ARG1, CD163, CD68, TLR2, or a TLR4 gene sequence.

In embodiments, the oligonucleotide probes are capable of binding to nucleic acid molecules including a PECAMI gene sequence, VWF gene sequence, or a CDH5 gene sequence. Detection of PECAMI, VWF, and/or CDH5 is typically associated with endothelial cells, and may be useful for identifying and classifying the respective cell type. Endothelial cells commonly line blood vessels. In embodiments, the oligonucleotide probes are capable of binding to nucleic acid molecules including a ENG, FLT1, KDR, NOS3, SELE, SELL, ICAM2, THBD, ROBO4, ESAM, FOXC2, VEGFA, ANGPT1, ANGPT2, or TIE2 gene sequence.

In embodiments, the oligonucleotide probes are capable of binding to nucleic acid molecules including a CD38 gene sequence, SDC1 gene sequence, or a PRDM1 gene sequence. Detection of CD38, SDC1, and/or PRDM1 is typically associated with plasma cells, and may be useful for identifying and classifying the respective cell type. In embodiments, the oligonucleotide probes are capable of binding to nucleic acid molecules including a CD138, BLIMP1, XBP1, IRF4, MZB1, FCRL5, JCHAIN, IGHG1, IGHA1, IGHE, BCMA, IL6ST, CD27, CD45, or a PAX5 gene sequence.

In embodiments, the oligonucleotide probes are capable of binding to nucleic acid molecules including a FCGR3B gene sequence, ELANE gene sequence, or a MPO gene sequence. Detection of FCGR3B, ELANE, and/or MPO is typically associated with neutrophils, and may be useful for identifying and classifying the respective cell type. In embodiments, the oligonucleotide probes are capable of binding to nucleic acid molecules including a CEACAM8, S100A8, S100A9, S100A12, CD11b, CD15, CD16, CD66b, BPI, CXCR1, CXCR2, LTF, DEFA1, DEFA4, or a GCSFR gene sequence.

In embodiments, the oligonucleotide probes are capable of binding to nucleic acid molecules including a CD68 gene sequence, ADGRE1 gene sequence, HLA-DRA gene sequence, or a CD163 gene sequence. Detection of CD68, ADGRE1, HLA-DRA, and/or CD163 is typically associated with macrophages, and may be useful for identifying and classifying the respective cell type. In embodiments, the oligonucleotide probes are capable of binding to nucleic acid molecules including a CD14, CD11c, MRC1, CSF1R, CD64, CCR2, CD204, TREM2, CD11b, CX3CR1, Dectin-1, CD80, CD86, IRF5, or F4/80 gene sequence.

In embodiments, the oligonucleotide probes are capable of binding to nucleic acid molecules including a NCAM1 gene sequence, FCGR3A gene sequence, or a NCR1 gene sequence. Detection of NCAM1, FCGR3A, and/or NCR1 is typically associated with natural killer cells, and may be useful for identifying and classifying the respective cell type. In embodiments, the oligonucleotide probes are capable of binding to nucleic acid molecules including a KIR2DL1, KIR3DL1, KIR2DS4, CD16B, CD56, CD57, NKG2D, NKG2A, NKp46, NKp30, NKp44, CD94, 2B4, DNAM-1, or a CD69 gene sequence.

In embodiments, the oligonucleotide probes are capable of binding to nucleic acid molecules including an ITGAX gene sequence, IL3RA gene sequence, or a CLEC4L gene sequence. Detection of ITGAX, IL3RA, and/or CLEC4L is typically associated with dendritic cells, and may be useful for identifying and classifying the respective cell type. In embodiments, the oligonucleotide probes are capable of binding to nucleic acid molecules including a CD11c, CD1c, CD141, CD209, CLEC9A, XCR1, FLT3, CCR7, CD40, CD86, HLA-DR, SLAN, TLR3, TLR7, or a IRF8 gene sequence.

In an aspect is provided a method of detecting a biomolecule in or on a cell or tissue. In embodiments, the method includes immobilizing a cell or tissue including a biomolecule to a solid support; contacting the biomolecule in or on the cell or tissue with a detection agent (e.g., a probe) including a label; detecting the label, thereby detecting the biomolecule. In embodiments, the method includes imaging the tissue section. In embodiments, the detection agent is a biomolecule-specific binding agent. In embodiments, the biomolecule-specific binding agent is a protein-specific binding agent. In embodiments, the biomolecule-specific binding agent is an oligonucleotide-specific binding agent. In embodiments, the biomolecule-specific binding agent is capable of binding to a cluster of differentiation (CD) marker, integrin, selectin, cadherin, cytokine receptor, chemokine receptor, Toll-like receptor (TLR), ion channel, transmembrane protein, lipoprotein, glycoprotein, cell surface protein, transport protein, intracellular organelle, or transcription factor. In embodiments, the intracellular organelle includes actin, carbohydrate, centrosomes and centrioles, chloroplasts (in plant cells and some protists), cytoskeleton, endoplasmic reticulum, endosome, Golgi apparatus, intermediate filaments, lysosome, microfilaments, microtubules, mitochondria, nuclear envelope, nuclear pores, nucleoid, nucleolus, nucleus, peroxisome, phosphatidylserine, plasma membrane, ribosomes, rough endoplasmic reticulum, smooth endoplasmic reticulum, transferrin receptor, transport vesicles, and/or vacuoles. In embodiments, the biomolecule specific binding agent is capable of binding to a biomolecule in the mitogen-activated protein kinase (MAPK) pathway, PI3K/AKT/mTOR pathway, Wnt/β-catenin pathway, intrinsic (mitochondrial) pathway, extrinsic (death receptor) pathway, caspase cascade, Notch signaling pathway, hedgehog signaling pathway, TGF-β (transforming growth factor Beta) pathway, JAK/STAT pathway, G-protein coupled receptor (GPCR) pathway, calcium signaling pathway, glycolysis, citric acid cycle (Krebs Cycle), oxidative phosphorylation, lipid metabolism pathway, amino acid metabolism, Toll-like receptor (TLR) pathway, NF-κB signaling pathway, complement pathway, nucleotide excision repair (NER), base excision repair (BER), mismatch repair (MMR), cyclin-dependent kinase (CDK) pathway, Rb (retinoblastoma) pathway, p53 pathway, unfolded protein response (UPR), heat shock response pathway, oxidative stress pathway, BMP (bone morphogenetic protein) pathway, FGF (fibroblast growth factor) pathway, Sonic Hedgehog pathway, neurotrophin signaling pathway, synaptic transmission pathway, axon guidance pathways, insulin signaling pathway, thyroid hormone pathway, steroid hormone pathway, VEGF (vascular endothelial growth factor) pathway, DNA methylation pathway, histone modification pathway, or angiogenesis. In embodiments, the biomolecule specific binding agent is capable of binding to a biomolecule on the surface of or in a B cell, Mature B Cell, Follicular B cell, Marginal Zone B cell, Short lived plasma cell, Memory B cell, Long lived plasma cell, B1 cell, Breg, Germinal Center B cell, Macrophage, Monocyte, M1 macrophage, M2 macrophage, Dendritic Cell, Plasmacytoid dendritic cell, Monocyte-derived dendritic cell, T cell, T Follicular Helper, Th1, Th2, Th9, Th17, Th22, Treg, platelet (activated), platelet (rested), natural killer cell, neutrophil, basophil, eosinophil, mast cell, astrocyte, neuron, glial cell, lymphocyte, myeloid cell, granulocytes, neural cells, stem cells, endothelial cells, epithelial cells, mesenchymal stem cell, hematopoietic stem cell, embryonic stem, stromal cell, erythrocyte, fibroblast, or apoptotic cell.

In embodiments, the detection agent is an oligonucleotide-specific binding agent capable of hybridizing to a target oligonucleotide sequence in a tissue section. In embodiments, the detection agent is an oligonucleotide. In embodiments, the detection agent is an oligonucleotide, wherein the oligonucleotide includes: a) a first region at a 3′ end that is hybridized to a first complementary region of the polynucleotide, and b) a second region at a 5′ end that is hybridized to a second complementary region of the polynucleotide, wherein the second complementary region is 5′ with respect to the first complementary region. In embodiments, the method includes i) circularizing the oligonucleotide agent to generate a circular oligonucleotide and ligating the oligonucleotide-specific binding agent; ii) amplifying the circular oligonucleotide by extending an amplification primer hybridized to the circular oligonucleotide with a strand-displacing polymerase, wherein the amplification primer extension generates an extension product including multiple complements of the circular oligonucleotide; and iii) sequencing the extension product of step (ii). In embodiments, circularizing the oligonucleotide-specific binding agent includes extending the 3′ end of the oligonucleotide-specific binding agent (using a polymerase to incorporate one or more nucleotides) along the target nucleic acid to generate a complementary sequence and ligating the extended 3′ end of the oligonucleotide-specific binding agent to the 5′ end of the oligonucleotide-specific binding agent. In embodiments, the circular oligonucleotide includes a barcode sequence. In embodiments, circularizing in step i) further includes extending the 3′ end of the oligonucleotide primer (e.g., extending the 3′ end of the primer using a polymerase (e.g., a Thermus thermophilus (Tth) DNA polymerase) to incorporate one or more nucleotides) along the target nucleic acid to generate a complementary sequence (e.g., complementary to the target nucleic acid, for example a target RNA sequence) prior to ligating the complementary sequence to the 5′ end of the oligonucleotide primer. In embodiments, the oligonucleotide is an oligonucleotide primer.

In embodiments, the oligonucleotide includes at least one target-specific region. In embodiments, the oligonucleotide includes two target-specific regions. In embodiments, the oligonucleotide includes at least one flanking-target region (i.e., an oligonucleotide sequence that flanks the region of interest). In embodiments, the oligonucleotide includes two flanking-target regions. A target-specific region is a single stranded polynucleotide that is at least 50% complementary, at least 75% complementary, at least 85% complementary, at least 90% complementary, at least 95% complementary, at least 98%, at least 99% complementary, or 100% complementary to a portion of a nucleic acid molecule that includes a target sequence (e.g., a gene of interest). In embodiments, the target-specific region is capable of hybridizing to at least a portion of the target sequence. In embodiments, the target-specific region is substantially non-complementary to other target sequences present in the sample. In embodiments, the oligonucleotide is a padlock probe. Padlock probes are specialized ligation probes, examples of which are known in the art, see for example Nilsson M, et al. Science. 1994; 265(5181):2085-2088), and has been applied to detect transcribed RNA in cells, see for example Christian A T, et al. Proc Natl Acad Sci USA. 2001; 98(25):14238-14243, both of which are incorporated herein by reference in their entireties.

Typically, padlock probes hybridize to adjacent sequences and are then ligated together to form a circular oligonucleotide. In embodiments, the oligonucleotide hybridize to sequences adjacent to the target nucleic acid sequence resulting in a gap (e.g., a gap spanning the length of the target nucleic acid sequence). The construction of the oligonucleotide allows for selective targeting, enabling detection of specific targets within the cell or tissue section. In embodiments, the method further includes amplifying and sequencing the oligonucleotide.

In embodiments, the label is a fluorescent moiety that has a maximum excitation wavelength between 350-400 nm, between 400-450 nm, between 450-500 nm, between 500-550 nm, between 550-600 nm, between 600-650 nm, between 650-700 nm, or between 700-750 nm. In embodiments, the label is a fluorescent moiety that has a maximum emission wavelength between 400-450 nm, between 450-500 nm, between 500-550 nm, between 550-600 nm, between 600-650 nm, between 650-700 nm, between 700-750 nm, between 750-800 nm, or between 800-850 nm.

In embodiments, detecting a biomolecule in or on a cell or tissue includes detecting a plurality of different targets within an optically resolved volume of a cell or tissue immobilized onto the first solid support described herein. In embodiments, the method includes i) associating a different oligonucleotide barcode from a known set of barcodes with each of the plurality of targets; ii) sequencing each barcode to obtain a multiplexed signal in the cell or tissue; iii) demultiplexing the multiplexed signal by comparison with the known set of barcodes; and iv) detecting the plurality of targets by identifying the associated barcodes detected in the cell or tissue. In embodiments, the method includes detecting a plurality of targets (e.g., a nucleic acid sequence or a protein) within an optically resolved volume of a sample (e.g., a voxel). In embodiments, the method includes i) associating an oligonucleotide barcode with each of the plurality of targets; ii) sequencing each barcode to obtain a multiplexed signal; and iii) demultiplexing the multiplexed signal to obtain a set of signals corresponding to barcodes with a specified Hamming distance; thereby detecting a plurality of targets within an optically resolved volume of a sample.

In embodiments, detecting a biomolecule in or on a cell or tissue includes detecting a plurality of different nucleic acid sequences within an optically resolved volume of cell or tissue immobilized onto the first solid support described herein, wherein the method includes i) associating a different oligonucleotide barcode from a known set of barcodes with each of the plurality of targets, wherein associating an oligonucleotide barcode with each of the plurality of targets includes hybridizing a padlock probe to two adjacent nucleic acid sequences of the target, wherein the padlock probe is a single-stranded polynucleotide having a 5′ and a 3′ end, and wherein the padlock probe includes a primer binding sequence from a known set of primer binding sequences; ii) sequencing each barcode to obtain a multiplexed signal in the cell or tissue; iii) demultiplexing the multiplexed signal by comparison with the known set of barcodes; and iv) detecting the plurality of targets by identifying the associated barcodes detected in the cell.

In embodiments, detecting a biomolecule in or on a cell or tissue includes detecting a plurality of proteins (e.g., different proteins) within an optically resolved volume of a cell or tissue immobilized onto the first solid support described herein, wherein the method includes i) associating a different oligonucleotide barcode from a known set of barcodes with each of the plurality of targets, wherein associating an oligonucleotide barcode with each of the plurality of targets includes contacting each of the targets with a specific binding reagent, wherein the specific binding reagent includes an oligonucleotide barcode; ii) hybridizing a padlock probe to two adjacent nucleic acid sequences of the barcode, wherein the padlock probe is a single-stranded polynucleotide having a 5′ and a 3′ end, and wherein the padlock probe includes a primer binding sequence from a known set of primer binding sequences; iii) sequencing each barcode to obtain a multiplexed signal in the cell or tissue; iv) demultiplexing the multiplexed signal by comparison with the known set of barcodes; and v) detecting the plurality of targets by identifying the associated barcodes detected in the cell or tissue.

In embodiments, the method includes detecting biomolecules in a tissue, the method including: (i) binding a polynucleotide probe to a nucleic acid molecule in the tissue; amplifying the polynucleotide probe to form an amplification product; and binding a fluorescently labeled nucleotide to the first amplification product. In embodiments, the method includes binding a sequencing primer and binding the fluorescently labeled nucleotide to the primer. In embodiments, the method includes incorporating the fluorescently labeled nucleotide into the primer, wherein the primer is bound to the amplification product. In embodiments, the method includes binding a stain and detecting the stain. A stain is a chemical agent used to selectively color components of biological tissues or cells to enhance their visibility under a microscope. Stains typically bind to specific cellular structures or organelles, such as proteins, nucleic acids, lipids, or carbohydrates, allowing for the differentiation and identification of these structures. In embodiments, the stain is a fluorescent stain (e.g., an intrinsic stain). Intrinsic or fluorescent stains are chemical compounds that possess the inherent ability to emit fluorescence when exposed to specific wavelengths of light, thereby enabling the visualization of biological structures without the need for additional staining agents; examples include eosin, which absorbs light in the blue-green part of the spectrum (around 490-520 nm) and emits light in the green-yellow part of the spectrum (around 520-550 nm), and Hoechst stains, which bind to DNA and emit blue fluorescence around 461 nm. In embodiments, detecting includes directing an excitation light to the cell or tissue and detecting an emission light from the stain.

In embodiments, the method includes contacting the cell or tissue including the template polynucleotide with an oligonucleotide-specific binding agent including a first target hybridization sequence and a second target hybridization sequence; hybridizing the first target hybridization sequence to the template polynucleotide and hybridizing the second target hybridization sequence to the template polynucleotide; ligating the first target hybridization sequence to the second target hybridization sequence to form a circular polynucleotide; amplifying the circular polynucleotide to form an amplification product; and hybridizing a first sequencing primer to the amplification product, and sequencing the first target hybridization sequence or the second target hybridization sequence.

In embodiments, the first probe set further includes a plurality of protein-specific binding agents. In embodiments, the protein-specific binding agent is an antibody, single-chain Fv fragment (scFv), affimer, single-domain antibody (sdAb), or antibody fragment-antigen binding (Fab). In embodiments, the protein-specific binding agent is an antibody, single-chain Fv fragment (scFv), antibody fragment-antigen binding (Fab), affimer, etc. In embodiments, the protein-specific binding agent is an antibody. In embodiments, the protein-specific binding reagent is a single-chain Fv fragment (scFv). In embodiments, the protein-specific binding reagent is an antibody fragment-antigen binding (Fab). In embodiments, the protein-specific binding reagent is an affimer.

In embodiments when the target are proteins and/or carbohydrates, the method includes contacting the proteins with a protein-specific binding agent, wherein the protein-specific binding agent includes an oligonucleotide barcode (e.g., a target polynucleotide is attached to the protein-specific binding agent). In embodiments, the protein-specific binding agent includes an antibody, single-chain Fv fragment (scFv), or antibody fragment-antigen binding (Fab). In embodiments, the protein-specific binding agent is a peptide, a cell penetrating peptide, an aptamer, an antibody, an antibody fragment, a light chain antibody fragment, a single-chain variable fragment (scFv), a lipid, a lipid derivative, a phospholipid, a fatty acid, a triglyceride, a glycerolipid, a glycerophospholipid, a sphingolipid, a saccharolipid, a polyketide, a polylysine, polyethyleneimine, diethylaminoethyl (DEAE)-dextran, cholesterol, or a sterol moiety. In embodiments, the protein-specific binding agent interacts (e.g., contacts, or binds) with one or more protein-specific binding agents on the cell surface. Carbohydrate-specific antibodies are known in the art, see for example Kappler, K., Hennet, T. Genes Immun 21, 224-239 (2020). In embodiments, the target polynucleotide is polynucleotide attached to a protein-specific binding agent. In embodiments, the protein-specific binding agent is an antibody, single-chain Fv fragment (scFv), or antibody fragment-antigen binding (Fab).

In embodiments, the protein-specific binding agents each include an oligonucleotide moiety covalently attached to the protein-specific binding agent. In embodiments, the oligonucleotide is attached to a protein-specific binding agent (e.g., an antibody) via a linker (e.g., a bioconjugate linker). In embodiments, the oligonucleotide is attached to the protein-specific binding agent via a linker formed by reacting a first bioconjugate reactive moiety (e.g., the bioconjugate reactive moiety includes an amine moiety, aldehyde moiety, alkyne moiety, azide moiety, carboxylic acid moiety, dibenzocyclooctyne (DBCO) moiety, tetrazine moiety, epoxy moiety, isocyanate moiety, furan moiety, maleimide moiety, thiol moiety, or transcyclooctene (TCO) moiety) with a second bioconjugate reactive moiety). In embodiments, the oligonucleotide includes a barcode, wherein the barcode is a known sequence associated with the protein-specific binding agent. In embodiments, the barcode is at least 5, 6, 7, 8, 9, 10, 11, 12, 13, 14, or 15 nucleotides in length. In embodiments, the barcode is 5, 6, 7, 8, 9, 10, 11, 12, 13, 14, or 15 nucleotides in length.

Specific antibodies tagged with known oligonucleotide sequences can be synthesized by using bifunctional crosslinkers reactive towards thiol (via maleimide) and amine (via NHS) moieties. For example, a 5′-thiol-modified oligonucleotide could be conjugated to a crosslinker via maleimide chemistry and purified. The oligos with a 5′-NHS-ester would then be added to a solution of antibodies and reacted with amine residues on the antibodies surface to generate tagged antibodies capable of binding analytes with target epitopes. These tagged antibodies include oligonucleotide sequence(s). The one or more oligonucleotide sequences may include a barcode, binding sequences (e.g., primer binding sequence or sequences complementary to hybridization regions), and/or unique molecular identifier (UMI) sequences.

In embodiments, specific binding entails a binding affinity, expressed as a K_{D} (such as a K_{D} measured by surface plasmon resonance at an appropriate temperature, such as 37° C.). In embodiments, the K_{D} of a specific binding interaction is less than about 100 nM, 50 nM, 10 nM, 1 nM, 0.05 nM, or lower. In embodiments, the K_{D} of a specific binding interaction is about 0.01-100 nM, 0.1-50 nM, or 1-10 nM. In embodiments, the K_{D} of a specific binding interaction is less than 10 nM. The binding affinity of an antibody can be readily determined by one of ordinary skill in the art (for example, by Scatchard analysis). A variety of immunoassay formats can be used to select antibodies specifically immunoreactive with a particular antigen. For example, solid-phase ELISA immunoassays are routinely used to select monoclonal antibodies specifically immunoreactive with an analyte. See Harlow and Lane, ANTIBODIES: A LABORATORY MANUAL, Cold Springs Harbor Publications, New York, (1988) for a description of immunoassay formats and conditions that can be used to determine specific immunoreactivity. Typically, a specific or selective reaction will be at least twice background signal to noise and more typically more than 10 to 100 times greater than background.

In embodiments, the protein-specific binding agents are capable of binding to CD3, CD4, CD8, TCR, CD19, CD20, CD21, E-cadherin, cytokeratin, EpCAM, CD14, CD11b, CD33, CD31, von Willebrand factor, VE-cadherin, CD138, Blimp-1, CD15, CD16, myeloperoxidase, elastase, CD68, F4/80, HLA-DR, CD163, CD56, NKp46, CD11c, CD123, HLA-DR, CD207, TRAP, Cathepsin K, calcitonin receptor, alkaline phosphatase, osteocalcin, collagen type II, aggrecan, and/or SOX9.

In embodiments, the protein-specific binding agents are capable of specifically binding to CD3, CD4, CD8, or a TCR (T cell receptor). Detection of CD3, CD4, CD8, and/or a TCR (T cell receptor) is typically associated with T cells, and may be useful for identifying and classifying the respective cell type. In embodiments, the protein-specific binding agents are capable of specifically binding to CD5, CD7, CD25, CD28, CD45RO, CD45RA, CD69, CTLA-4, PD-1, FoxP3, OX40, 4-1BB, LAG-3, TIM-3, or Granzyme B. In embodiments, the protein-specific binding agents are capable of specifically binding to CD2, CD27, CD57, CD154, CD127, CCR7, CCR5, CXCR3, CD161, TCR Vα24-Jα18, TCRγδ, SLAMF1, CD137L, CD30, or KLRG1.

In embodiments, the protein-specific binding agents are capable of specifically binding to CD19, CD20, or CD21. Detection of CD19, CD20, and/or CD21 is typically associated with B cells, and may be useful for identifying and classifying the respective cell type. In embodiments, the protein-specific binding agents are capable of specifically binding to CD22, CD24, CD23, CD40, CD79a, CD79b, CD5, CD38, CD138, IgM, IgD, BAFF-R, Fas, BCMA, or TACI.

In embodiments, the protein-specific binding agents are capable of specifically binding to E-cadherin, cytokeratin, or EpCAM. Detection of E-cadherin, cytokeratin, and/or EpCAM is typically associated with epithelial cells, and may be useful for identifying and classifying the respective cell type. In embodiments, the protein-specific binding agents are capable of specifically binding to Claudin, Occludin, ZO-1, Cytokeratin-18, Cytokeratin-19, Desmoplakin, Alpha-smooth muscle actin, Mucin 1, Vimentin, Laminin, Integrin alpha-6, Asialoglycoprotein receptor 1, Fibronectin, or Collagen Type IV.

In embodiments, the protein-specific binding agents are capable of specifically binding to CD14, CD11b, CD33, or myeloperoxidase. Detection of CD14, CD11b, CD33, and/or myeloperoxidase is typically associated with myeloid cells, and may be useful for identifying and classifying the respective cell type. In embodiments, the protein-specific binding agents are capable of specifically binding to CD15, CD16, CD64, CD115, CD117, CD163, HLA-DR, CD11c, CD36, CD102, CD66b, CD68, CD105, CD142, or CD300A.

In embodiments, the protein-specific binding agents are capable of specifically binding to CD31 (PECAMI), von Willebrand factor, or VE-cadherin. Detection of CD31 (PECAMI), von Willebrand factor, and/or VE-cadherin is typically associated with endothelial cells, and may be useful for identifying and classifying the respective cell type. In embodiments, the protein-specific binding agents are capable of specifically binding to ICAM-1, VCAM-1, Selectin E, Selectin P, FGF-2, Tie-1, Tie-2, Angiopoietin-1, Angiopoietin-2, eNOS, Thrombomodulin, Endoglin, Robo4, VEGFR1, or VEGFR2.

In embodiments, the protein-specific binding agents are capable of specifically binding to CD138 or Blimp1. Detection of CD138 and/or is typically associated with plasma cells, and may be useful for identifying and classifying the respective cell type. In embodiments, the protein-specific binding agents are capable of specifically binding to CD38, BCMA, XBP-1, IRF4, MUM1/IRF4, J chain, CD319, CD27, CD45, Syndecan-2, IL-6R, CXCR4, PAX5, APRIL, or TACI.

In embodiments, the protein-specific binding agents are capable of specifically binding to CD15, CD16, elastase. Detection of CD15, CD16, and/or elastase is typically associated with neutrophils, and may be useful for identifying and classifying the respective cell type. In embodiments, the protein-specific binding agents are capable of specifically binding to CD11b, CD66b, CD63, CD62L, Myeloperoxidase, Lysozyme, CD32, CD35, CD177, CD14, G-CSF Receptor, CXCR1, CXCR2, Annexin A1, or Neutrophil Elastase.

In embodiments, the protein-specific binding agents are capable of specifically binding to CD68, HLADR, or CD163. Detection of CD68, HLADR, and/or CD163 is typically associated with macrophages, and may be useful for identifying and classifying the respective cell type. In embodiments, the protein-specific binding agents are capable of specifically binding to CD11b, CD14, CD16, CD64, CD204, CD206, CD11c, CD36, F4/80, MerTK, TLR4, SIRPα, Dectin-1, TREM-2, or CX3CR1.

In embodiments, the protein-specific binding agents are capable of specifically binding to CD56, CD16, or NKp46. Detection of CD56, CD16, and/or NKp46 is typically associated with natural killer cells, and may be useful for identifying and classifying the respective cell type. In embodiments, the protein-specific binding agents are capable of specifically binding to NKG2D, NKG2A, CD57, 2B4, DNAM-1, NKp30, NKp44, NKp80, CD94, NKG2C, KIR2DL1, KIR2DS4, KIR3DL1, KIR3DS1, or LIR-1.

In embodiments, the protein-specific binding agents are capable of specifically binding to CD11c, CD123, HLADR, or CD207. Detection of CD11c, CD123, HLADR, and/or CD207 is typically associated with dendritic cells, and may be useful for identifying and classifying the respective cell type. In embodiments, the protein-specific binding agents are capable of specifically binding to CD1c, CD141, CD209, CD40, CD83, CD86, CCR7, CLEC12A, XCR1, FLT3, SIRP-alpha, CD274, OX40L, ICAM-1, or MHC Class II.

In embodiments, the protein-specific binding agents are capable of specifically binding to TRAP (tartrateresistant acid phosphatase), Cathepsin K, or calcitonin receptor. Detection of TRAP (tartrateresistant acid phosphatase), Cathepsin K, or calcitonin receptor is typically associated with osteoclasts, and may be useful for identifying and classifying the respective cell type. In embodiments, the protein-specific binding agents are capable of specifically binding to RANK, RANKL, OSCAR, MMP-9, Carbonic Anhydrase II, V-ATPase, Integrin β3, C-Src, NFATc1, DC-STAMP, ATP6VOD2, Acp5, CK-B, Integrin αvβ5, or CD44.

In embodiments, the protein-specific binding agents are capable of specifically binding to Alkaline phosphatase or Osteocalcin. Detection of Alkaline phosphatase and/or Osteocalcin is typically associated with a osteoblasts, and may be useful for identifying and classifying the respective cell type. In embodiments, the protein-specific binding agents are capable of specifically binding to Bone Sialoprotein, Collagen Type I, Runx2, SPARC, BMP-2, FGF-23, Sclerostin, Cbfa1, Osterix, Integrin-binding sialoprotein, Decorin, Matrix Gla Protein, Fibronectin, Vascular Endothelial Growth Factor, or TGF-beta.

In embodiments, the protein-specific binding agents are capable of specifically binding to Collagen type II, Aggrecan, or SRYBox 9 (SOX9). Detection of Collagen type II, Aggrecan, and/or SRYBox 9 (SOX9) is typically associated with a chondrocytes, and may be useful for identifying and classifying the respective cell type. In embodiments, the protein-specific binding agents are capable of specifically binding to Osteopontin, Bone Sialoprotein, Osteonectin, RANK Ligand, Osteoprotegerin, Fibroblast Growth Factor-23, Phosphol, Bone Morphogenetic Protein 6, Endosteal, or Alkaline Phosphatase.

In embodiments, the first probe set includes a first subset of oligonucleotide probes including a first sequencing primer binding sequence and a second subset of oligonucleotide probes including a second sequencing primer binding sequence, wherein the first and second sequencing primer binding sequences are different. Different sequencing primers enable detection cycles to be batched.

In embodiments, the first probe set includes 2 to 12 different subsets of oligonucleotide probes, wherein each subset of oligonucleotide probes includes a different sequencing primer binding sequence. In embodiments, the first probe set includes a plurality of oligonucleotide probes, wherein a first subset of the plurality of oligonucleotide probes includes a first sequencing primer binding sequence, a second subset includes a second sequencing primer binding sequence different from the first, a third subset includes a third sequencing primer binding sequence different from the first and second, a fourth subset includes a fourth sequencing primer binding sequence different from the first, second, and third, a fifth subset includes a fifth sequencing primer binding sequence, a sixth subset includes a sixth sequencing primer binding sequence, a seventh subset includes a seventh sequencing primer binding sequence, an eighth subset includes an eighth sequencing primer binding sequence, a ninth subset includes a ninth sequencing primer binding sequence, a tenth subset includes a tenth sequencing primer binding sequence, an eleventh subset includes an eleventh sequencing primer binding sequence, and a twelfth subset includes a twelfth sequencing primer binding sequence, each sequencing primer binding sequence being designed to facilitate specific hybridization and selective detection.

In embodiments, the first probe set includes a plurality of oligonucleotide probes, wherein a first subset of the plurality of oligonucleotide probes includes a first sequencing primer binding sequence. A second subset includes a plurality of oligonucleotide probes, wherein each of the oligonucleotide probes includes the second sequencing primer binding sequence. A third subset includes a plurality of oligonucleotide probes, wherein each of the oligonucleotide probes includes the third sequencing primer binding sequence. A fourth subset includes a plurality of oligonucleotide probes, wherein each of the oligonucleotide probes includes the fourth sequencing primer binding sequence. A fifth subset includes a plurality of oligonucleotide probes, wherein each of the oligonucleotide probes includes the fifth sequencing primer binding sequence. A sixth subset includes a plurality of oligonucleotide probes, wherein each of the oligonucleotide probes includes the sixth sequencing primer binding sequence. A seventh subset includes a plurality of oligonucleotide probes, wherein each of the oligonucleotide probes includes the seventh sequencing primer binding sequence. An eighth subset includes a plurality of oligonucleotide probes, wherein each of the oligonucleotide probes includes the eighth sequencing primer binding sequence. A ninth subset includes a plurality of oligonucleotide probes, wherein each of the oligonucleotide probes includes the ninth sequencing primer binding sequence. A tenth subset includes a plurality of oligonucleotide probes, wherein each of the oligonucleotide probes includes the tenth sequencing primer binding sequence. An eleventh subset includes a plurality of oligonucleotide probes, wherein each of the oligonucleotide probes includes the eleventh sequencing primer binding sequence. A twelfth subset includes a plurality of oligonucleotide probes, wherein each of the oligonucleotide probes includes the twelfth sequencing primer binding sequence.

In embodiments, each oligonucleotide probe includes a barcode sequence. Barcoding can be used to determine which polynucleotides in a mixture are associated with a particular targets. In embodiments, an oligonucleotide probe is associated with a particular barcode, such that identifying the barcode identifies the probe with which it is associated. Because the probe specifically binds to a target, identifying the barcode thus identifies the target.

In embodiments, each oligonucleotide probe includes a barcode sequence. In embodiments, the barcode (i.e., the barcode sequence) is at least 5, 6, 7, 8, 9, 10, 11, 12, 13, 14, or 15 nucleotides in length. In embodiments, the barcode is 5, 6, 7, 8, 9, 10, 11, 12, 13, 14, or 15 nucleotides in length. In embodiments, the barcode is 10 to 15 nucleotides in length. In embodiments, the barcode is at least about 1, 2, 3, 4, 5, 6, 7, 8, 9, 10, 15, 20, 25, 30, 35, 40, 45, 50 or more nucleotides in length. In embodiments, the barcode can be at most about 300, 200, 100, 90, 80, 70, 60, 50, 40, 30, 20, 15, 12, 10, 9, 8, 7, 6, 5, 4 or fewer or more nucleotides in length. In embodiments, the barcode includes between about 5 to about 8, about 5 to about 10, about 5 to about 15, about 5 to about 20, about 10 to about 150 nucleotides. In embodiments, the barcode includes between 5 to 8, 5 to 10, 5 to 15, 5 to 20, 10 to 150 nucleotides. In embodiments, the barcode is 10 nucleotides. In embodiments, the barcode may include a unique sequence (e.g., a barcode sequence) that gives the barcode its identifying functionality. The unique sequence may be random or non-random. The random sequence can be of any suitable length, and there may be one or more than one present. As non-limiting examples, the random sequence may have a length of 10 to 40, 10 to 30, 10 to 20, 25 to 50, 15 to 40, 15 to 30, 20 to 50, 20 to 40, or 20 to 30 nucleotides.

In embodiments, the method includes measuring an amount of one or more of the targets by counting the one or more associated barcodes. In embodiments, the method further includes counting the one or more associated barcodes in an optically resolved volume. In embodiments, the number of unique targets detected within an optically resolved volume of a sample is about 3, 10, 30, 50, or 100. In embodiments, the number of unique targets detected within an optically resolved volume of a sample is about 1 to 10. In embodiments, the number of unique targets detected within an optically resolved volume of a sample is about 5 to 10. In embodiments, the number of unique targets detected within an optically resolved volume of a sample is about 1 to 5. In embodiments, the number of unique targets detected within an optically resolved volume of a sample is at least 3, 10, 30, 50, or 100. In embodiments, the number of unique targets detected within an optically resolved volume of a sample is less than 3, 10, 30, 50, or 100. In embodiments, the number of unique targets detected within an optically resolved volume of a sample is about 1, 2, 3, 4, 5, 6, 7, 8, 9, 10, 20, 50, 100, 500, 1,000, 5,000, 10,000, or 200,000. In embodiments, the methods allow for detection of a single target of interest. In embodiments, the methods allow for multiplex detection of a plurality of targets of interest. The use of oligonucleotide barcodes with unique identifier sequences as described herein allows for simultaneous detection of 2, 3, 4, 5, 6, 7, 8, 9, 10, 20, 30, 40, 50, 60, 70, 80, 90, 100, 200, 300, 400, 500, 600, 700, 800, 900, 1,000, 1,500, 2,000, 2,500, 3,000, 3,500, 4,000, 4,500, 5,000, 5,500, 6,000, 6,500, 7,000, 7,500, 8,000, 8,500, 9,000, 9,500, 10,000 or more than 10,000 unique targets within a single cell.

In embodiments, the barcode is known (i.e., the nucleic sequence is known before sequencing) and is sorted into a basis-set according to their Hamming distance. Oligonucleotide barcodes (e.g., barcode sequences included in an oligonucleotide) can be associated with a target of interest by knowing, a priori, the target of interest, such as a gene sequence or protein. In embodiments, each barcode sequence is selected from a known set of barcode sequences. In embodiments, each of the known set of barcode sequences is associated with a target hybridization sequence from a known set of target hybridization sequences. In embodiments, a first barcode sequence is associated with a first target hybridization sequence, and wherein a second barcode sequence is associated with a second target hybridization sequence (e.g., wherein the second target hybridization sequence is included in an oligonucleotide targeting a different target nucleic acid than the first target hybridization sequence). In embodiments, the same barcode sequence is associated with a plurality of oligonucleotides targeting different sequences of the same target nucleic acid (e.g., the same target polynucleotide).

In embodiments, sequencing includes encoding the sequencing read into a codeword. Useful encoding schemes include those developed for telecommunications, coding theory and information theory such as those set forth in Hamming, Coding and Information Theory, 2^{nd} Ed. Prentice Hall, Englewood Cliffs, N.J. (1986) and Moon T K. Error Correction Coding: Mathematical Methods and Algorithms. ed. 1st Wiley: 2005., each of which are incorporated herein by reference. A useful encoding scheme uses a Hamming code. A Hamming code can provide for signal (and therefore sequencing and barcode) distinction. In this scheme, signal states detected from a series of nucleotide incorporation and detection events (i.e., while sequencing the oligonucleotide barcode) can be represented as a series of the digits to form a codeword, the codeword having a length equivalent to the number incorporation/detection events. The digits can be binary (e.g. having a value of 1 for presence of signal and a value of 0 for absence of the signal) or digits can have a higher radix (e.g., a ternary digit having a value of 1 for fluorescence at a first wavelength, a value of 2 for fluorescence at a second wavelength, and a value of 0 for no fluorescence at those wavelengths, etc.). Barcode discrimination capabilities are provided when codewords can be quantified via Hamming distances between two codewords (i.e., barcode 1 having codeword 1, and barcode 2 having codeword 2, etc.).

In embodiments, the barcodes in the known set of barcodes have a specified Hamming distance. In embodiments, the Hamming distance is 4 to 15. In embodiments, the Hamming distance is 8 to 12. In embodiments, the Hamming distance is 10. In embodiments, the Hamming distance is 0 to 100. In embodiments, the Hamming distance is 0 to 15. In embodiments, the Hamming distance is 0 to 10. In embodiments, the Hamming distance is 1 to 10. In embodiments, the Hamming distance is 5 to 10. In embodiments, the Hamming distance is 1 to 100. In embodiments, the Hamming distance between any two barcode sequences of the set is at least 2, 3, 4, or 5. In embodiments, the Hamming distance between any two barcode sequences of the set is at least 3. In embodiments, the Hamming distance between any two barcode sequences of the set is at least 4.

In embodiments, demultiplexing the multiplexed signal includes a linear decomposition of the multiplexed signal. Any of a variety of techniques may be employed for decomposition of the multiplexed signal. Examples include, but are not limited to, Zimmerman et al. Chapter 5: Clearing Up the Signal: Spectral Imaging and Linear Unmixing in Fluorescence Microscopy; Confocal Microscopy: Methods and Protocols, Methods in Molecular Biology, vol. 1075 (2014); Shirawaka H. et al.; Biophysical Journal Volume 86, Issue 3, March 2004, Pages 1739-1752; and S. Schlachter, et al, Opt. Express 17, 22747-22760 (2009); the content of each of which is incorporated herein by reference in its entirety. In embodiments, multiplexed signal includes overlap of a first signal and a second signal and is computationally resolved, for example, by imaging software.

In embodiments, generating a signal signature includes hybridizing a fluorescently labeled oligonucleotide to the oligonucleotide probe, or an amplification product thereof, and detecting an emission light from the fluorescently labeled oligonucleotide. In embodiments, detecting includes hybridizing an oligonucleotide associated with a detectable label to the oligonucleotide probe, or an amplification product thereof, and identifying the detectable label. In embodiments, detecting includes two-dimensional (2D) or three-dimensional (3D) fluorescent microscopy. Suitable imaging technologies are known in the art, as exemplified by Larsson et al., Nat. Methods (2010) 7:395-397 and associated supplemental materials, the entire content of which is incorporated by reference herein in its entirety. In embodiments of the methods provided herein, the imaging is accomplished by confocal microscopy. Confocal fluorescence microscopy involves scanning a focused laser beam across the sample, and imaging the emission from the focal point through an appropriately-sized pinhole. This suppresses the unwanted fluorescence from sections at other depths in the sample. In embodiments, the imaging is accomplished by multi-photon microscopy (e.g., two-photon excited fluorescence or two-photon-pumped microscopy). Unlike conventional single-photon emission, multi-photon microscopy can utilize much longer excitation wavelength up to the red or near-infrared spectral region. This lower energy excitation requirement enables the implementation of semiconductor diode lasers as pump sources to significantly enhance the photostability of materials. Scanning a single focal point across the field of view is likely to be too slow for many sequencing applications. To speed up the image acquisition, an array of multiple focal points can be used. The emission from each of these focal points can be imaged onto a detector, and the time information from the scanning mirrors can be translated into image coordinates. Alternatively, the multiple focal points can be used just for the purpose of confining the fluorescence to a narrow axial section, and the emission can be imaged onto an imaging detector, such as a CCD, EMCCD, or s-CMOS detector. A scientific grade CMOS detector offers an optimal combination of sensitivity, readout speed, and low cost. One configuration used for confocal microscopy is spinning disk confocal microscopy. In 2-photon microscopy, the technique of using multiple focal points simultaneously to parallelize the readout has been called Multifocal Two-Photon Microscopy (MTPM). Several techniques for MTPM are available, with applications typically involving imaging in biological tissue. In embodiments of the methods provided herein, the imaging is accomplished by light sheet fluorescence microscopy (LSFM). In embodiments, detecting includes 3D structured illumination (3DSIM). In 3DSIM, patterned light is used for excitation, and fringes in the Moiré pattern generated by interference of the illumination pattern and the sample, are used to reconstruct the source of light in three dimensions. In order to illuminate the entire field, multiple spatial patterns are used to excite the same physical area, which are then digitally processed to reconstruct the final image. See York, Andrew G., et al. “Instant super-resolution imaging in live cells and embryos via analog image processing.” Nature methods 10.11 (2013): 1122-1126 which is incorporated herein by reference. In embodiments, detecting includes selective planar illumination microscopy, light sheet microscopy, emission manipulation, pinhole confocal microscopy, aperture correlation confocal microscopy, volumetric reconstruction from slices, deconvolution microscopy, or aberration-corrected multifocus microscopy. In embodiments, detecting includes digital holographic microscopy (see for example Manoharan, V. N. Frontiers of Engineering: Reports on Leading-edge Engineering from the 2009 Symposium, 2010, 5-12, which is incorporated herein by reference). In embodiments, detecting includes confocal microscopy, light sheet microscopy, or multi-photon microscopy.

In embodiments, detecting includes bright field microscopy. For example, in bright field microscopy, sample illumination occurs via transmitted white light, i.e. illuminated from below and observed from above. Limitations include low contrast of most biological samples and low apparent resolution due to the blur of out of focus material. The simplicity of the technique and the minimal sample preparation required are significant advantages.

In embodiments, a signal signature is a fluorescent emission. For example, a signal signature may be generated by detecting an excited fluorophore associated with the target. In embodiments, generating a signal signature includes detecting a series of fluorescent emissions associated with the target sequence (e.g., a barcode sequence, or a sequence useful for identifying the target). In embodiments, detecting includes fluorescent microscopy. In fluorescence microscopy, a sample is illuminated with light of a wavelength which excites fluorescence in the sample. The fluoresced light, which is usually at a longer wavelength than the illumination, is then imaged through a microscope objective. Two filters may be used in this technique; an illumination (or excitation) filter which ensures the illumination is near monochromatic and at the correct wavelength, and a second emission (or barrier) filter which ensures none of the excitation light source reaches the detector. Alternatively, these functions may both be accomplished by a single dichroic filter.

In embodiments, generating a signal signature includes sequencing. In embodiments, sequencing includes sequencing by synthesis, sequencing by binding, sequencing by ligation, or pyrosequencing. In embodiments, sequencing includes extending a sequencing primer by incorporating a labeled nucleotide or labeled nucleotide analogue, and detecting the label to generate a signal for each incorporated nucleotide or nucleotide analogue, wherein the sequencing primer is hybridized to the extension product. In embodiments, the sequencing primer includes a sequence of the subject sequence.

In embodiments, the method includes sequencing the oligonucleotide and/or the amplification products. A variety of sequencing methodologies can be used such as sequencing-by synthesis (SBS), pyrosequencing, sequencing by ligation (SBL), or sequencing by hybridization (SBH). Pyrosequencing detects the release of inorganic pyrophosphate (PPi) as particular nucleotides are incorporated into a nascent nucleic acid strand (Ronaghi, et al., Analytical Biochemistry 242(1), 84-9 (1996); Ronaghi, Genome Res. 11(1), 3-11 (2001); Ronaghi et al. Science 281(5375), 363 (1998); U.S. Pat. Nos. 6,210,891; 6,258,568; and. 6,274,320, each of which is incorporated herein by reference in its entirety). In pyrosequencing, released PPi can be detected by being converted to adenosine triphosphate (ATP) by ATP sulfurylase, and the level of ATP generated can be detected via light produced by luciferase. In this manner, the sequencing reaction can be monitored via a luminescence detection system. In both SBL and SBH methods, target nucleic acids, and amplicons thereof, are subjected to repeated cycles of oligonucleotide delivery and detection. SBL methods, include those described in Shendure et al. Science 309:1728-1732 (2005); U.S. Pat. Nos. 5,599,675; and 5,750,341, each of which is incorporated herein by reference in its entirety; and the SBH methodologies are as described in Bains et al., Journal of Theoretical Biology 135(3), 303-7 (1988); Drmanac et al., Nature Biotechnology 16, 54-58 (1998); Fodor et al., Science 251(4995), 767-773 (1995); and WO 1989/10977, each of which is incorporated herein by reference in its entirety.

In SBS, extension of a nucleic acid primer along a nucleic acid template is monitored to determine the sequence of nucleotides in the template. The underlying chemical process can be catalyzed by a polymerase, wherein fluorescently labeled nucleotides are added to a primer (thereby extending the primer) in a template dependent fashion such that detection of the order and type of nucleotides added to the primer can be used to determine the sequence of the template. In embodiments, sequencing includes annealing and extending a sequencing primer to incorporate a detectable label that indicates the identity of a nucleotide in the target polynucleotide, detecting the detectable label, and repeating the extending and detecting of steps. In embodiments, the methods include sequencing one or more bases of a target nucleic acid by extending a sequencing primer hybridized to a target nucleic acid (e.g., an amplification product produced by the amplification methods described herein). In embodiments, sequencing may be accomplished by a sequencing-by-synthesis (SBS) process. In embodiments, sequencing includes a sequencing by synthesis process, where individual nucleotides are identified iteratively, as they are polymerized to form a growing complementary strand. In embodiments, nucleotides added to a growing complementary strand include both a label and a reversible chain terminator that prevents further extension, such that the nucleotide may be identified by the label before removing the terminator to add and identify a further nucleotide. Such reversible chain terminators include removable 3′ blocking groups such as blocking groups containing azide, disulfide, or allyl moieties, for example as described in U.S. Pat. Nos. 7,541,444, 7,057,026, 10,738,072, 11,174,281, and 11,878,993, each of which are incorporated by reference herein. Once such a modified nucleotide has been incorporated into the growing polynucleotide chain complementary to the region of the template being sequenced, there is no free 3′—OH group available to direct further sequence extension and therefore the polymerase cannot add further nucleotides. Once the identity of the base incorporated into the growing chain has been determined, the 3′ reversible terminator may be removed to allow addition of the next successive nucleotide. By ordering the products derived using these modified nucleotides it is possible to deduce the DNA sequence of the oligonucleotide target nucleic acid sequence.

In embodiments, sequencing includes a plurality of sequencing cycles. In embodiments, sequencing includes 20 to 100 sequencing cycles. In embodiments, sequencing includes 50 to 100 sequencing cycles. In embodiments, sequencing includes 50 to 300 sequencing cycles. In embodiments, sequencing includes 50 to 150 sequencing cycles. In embodiments, sequencing includes at least 10, 20, 30 40, or 50 sequencing cycles. In embodiments, sequencing includes at least 10 sequencing cycles. In embodiments, sequencing includes 10 to 20 sequencing cycles. In embodiments, sequencing includes 10, 11, 12, 13, 14, or 15 sequencing cycles. In embodiments, sequencing includes (a) extending a sequencing primer by incorporating a labeled nucleotide, or labeled nucleotide analogue and (b) detecting the label to generate a signal for each incorporated nucleotide or nucleotide analogue.

In embodiments, sequencing includes sequentially extending a plurality of sequencing primers (e.g., sequencing a first region of a target nucleic acid followed by sequencing a second region of a target nucleic acid, followed by sequencing N regions, where N is the number of sequencing primers in the known sequencing primer set). In embodiments, sequencing includes generating a plurality of sequencing reads.

In embodiments, sequencing includes extending a sequencing primer to generate a sequencing read. In embodiments, sequencing includes extending a sequencing primer by incorporating a labeled nucleotide, or labeled nucleotide analogue and detecting the label to generate a signal for each incorporated nucleotide or nucleotide analogue. In embodiments, the labeled nucleotide or labeled nucleotide analogue further includes a reversible terminator moiety. In embodiments, the labeled nucleotide or labeled nucleotide analogue further includes a reversible terminator moiety. In embodiments, the reversible terminator moiety is attached to the 3′ oxygen of the nucleotide and is independently

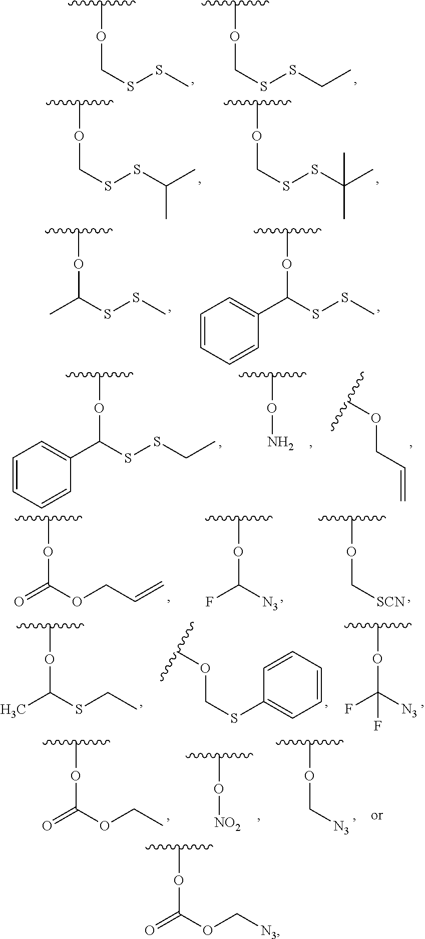

wherein the 3′ oxygen is explicitly depicted in the above formulae. Additional examples of reversible terminators may be found in U.S. Pat. No. 6,664,079, Ju J. et al. (2006) Proc Natl Acad Sci USA 103(52):19635-19640.; Ruparel H. et al. (2005) Proc Natl Acad Sci USA 102(17):5932-5937.; Wu J. et al. (2007) Proc Natl Acad Sci USA 104(104):16462-16467; Guo J. et al. (2008) Proc Natl Acad Sci USA 105(27): 9145-9150 Bentley D. R. et al. (2008) Nature 456(7218):53-59; or Hutter D. et al. (2010) Nucleosides Nucleotides & Nucleic Acids 29:879-895, which are incorporated herein by reference in their entirety for all purposes. In embodiments, generating a signal signature includes hybridizing a sequencing primer to the oligonucleotide probe, or an amplification product thereof, incorporating a fluorescently labeled nucleotide into the sequencing primer, and detecting an emission light from the fluorescently labeled nucleotide.

In embodiments, sequencing includes sequentially sequencing a plurality of different targets by initiating sequencing with different sequencing primers. For example, a first oligonucleotide probe includes a first primer binding site (a nucleic acid sequence complementary to a first sequencing primer) and optionally a first barcode sequence or barcode nucleotide. In a similar manner, a second and third oligonucleotide probe include a second primer binding site (a nucleic acid sequence complementary to a second, different, sequencing primer) and a third primer binding site (a nucleic acid sequence complementary to a third, different from both Primer 1 and Primer 2, sequencing primer), respectively. During the first round of sequencing (e.g., following probe circularization and amplification), using primer 1, the probe hybridized to the first nucleic acid molecule is detected. In the second round of sequencing, primer 2 can hybridize and sequence an identifying sequence of the probe (e.g., a barcode sequence or nucleotide) hybridized to a second nucleic acid molecule. Similarly, in the third round of sequencing, primer 3 can hybridize and sequence the probe hybridized to the third nucleic acid molecule.

In embodiments, generating a sequencing read includes determining the identity of the nucleotides in the template polynucleotide (or complement thereof). In embodiments, a sequencing read, e.g., a first sequencing read or a second sequencing read, includes determining the identity of a portion (e.g., 1, 2, 5, 10, 20, 50 nucleotides) of the total template polynucleotide. In embodiments the first sequencing read determines the identity of 5-10 nucleotides and the second sequencing read determines the identity of more than 5-10 nucleotides (e.g., 11 to 200 nucleotides). In embodiments the first sequencing read determines the identity of more than 5-10 nucleotides (e.g., 11 to 200 nucleotides) and the second sequencing read determines the identity of 5-10 nucleotides. In embodiments, following the generation of a sequencing read, subsequent extension is performed using a plurality of standard (e.g., non-modified) dNTPs until the complementary strand is copied. In other embodiments, following the generation of a sequencing read, subsequent extension is performed using a plurality of dideoxy nucleotide triphosphates (ddNTPs) to prevent further extension of the first sequencing read product during a second sequencing read. In embodiments, following the identification of at least 5-10 (e.g., 11 to 200 nucleotides, or up to 1000 nucleotides), subsequent extension is performed using a plurality of standard (e.g., non-modified) dNTPs until the complementary strand is copied. In embodiments, following the identification of at least 5-10 (e.g., 11 to 200 nucleotides, or up to 1000 nucleotides), subsequent extension is performed using a plurality of dideoxy nucleotide triphosphates (ddNTPs) to prevent further extension of the sequencing read product.

In embodiments, sequencing includes sequencing by synthesis, sequencing by binding, or sequencing by ligation. In embodiments, sequencing includes extending a sequencing primer by incorporating a labeled nucleotide or labeled nucleotide analogue, and detecting the label to generate a signal for each incorporated nucleotide or nucleotide analogue, wherein the sequencing primer is hybridized to the amplification product.

In embodiments, tissue includes liver tissue, kidney tissue, bone tissue, lung tissue, thymus tissue, adrenal tissue, skin tissue, bladder tissue, colon tissue, spleen tissue, or brain tissue. In embodiments, the tissue includes liver tissue. In embodiments, the tissue includes kidney tissue. In embodiments, the tissue includes bone tissue. In embodiments, the tissue includes lung tissue. In embodiments, the tissue includes thymus tissue. In embodiments, the tissue includes adrenal tissue. In embodiments, the tissue includes skin tissue. In embodiments, the tissue includes bladder tissue. In embodiments, the tissue includes colon tissue. In embodiments, the tissue includes spleen tissue. In embodiments, the tissue includes brain tissue.

In an aspect is provided a computer-implemented method for analyzing a tissue sample including a plurality of cells. In embodiments, the method include (a) receiving data corresponding to a first signal signature generated by contacting the tissue sample with a first probe set including a plurality of oligonucleotide probes, wherein each oligonucleotide probe is capable of hybridizing to a nucleic acid molecule including one of 20 to 500 different gene sequences; (b) computationally grouping cells based on the first signal signature to generate groups of cells; (c) receiving data corresponding to a second signal signature generated by contacting the tissue sample with a second probe set including a plurality of oligonucleotide probes, wherein each oligonucleotide probe is capable of hybridizing to a nucleic acid molecule including one of 18,000 to 22,000 different gene sequences; and (d) computationally combining the second signal signatures within each group of cells to generate aggregates of signal signatures.

In another aspect is provided a method for analyzing the transcriptome of a tissue. In embodiments, the whole transcriptome includes substantially all of the RNA molecules, expressed from the genome of an organism or specific cell type at a given time. In embodiments, the whole transcriptome includes the complete set of transcripts, including coding and non-coding elements, that are produced in a cell or tissue. In embodiments, the whole transcriptome refers to the dataset (i.e., the aggregate of signals) obtained from the method described herein.

In another aspect is provided a method for identifying a morphological pattern of a tissue. The method includes, at a computer system comprising one or more processing cores, a memory, and a display, obtaining a data set associated with a plurality of detected target biomolecules having a spatial arrangement. In embodiments, the method further includes obtaining a corresponding cluster assignment in a plurality of clusters, of each respective detected target biomolecule in the plurality of detected target biomolecules of the dataset. The corresponding cluster assignment is based, at least in part, on the corresponding plurality of the respective detected target biomolecules, or a corresponding plurality of dimension reduction components derived, at least in part, from the corresponding plurality of detected target biomolecules. In embodiments, the method further includes visualizing, on a visualization system (e.g., a computer with a display), the tissue sample. In embodiments, the visualization system includes a display on the computer system comprising one or more processing cores and a memory. In embodiments, the visualization system is a display on a device.

### EXAMPLES

### Example 1. In-Situ Neighborhood-Based Assessment

The architectural organization of tissues is characterized by the specific spatial distribution of various cell types, forming patterns that are both complex and predictable. The human body includes over 100 trillion cells and is organized into more than 250 different organs and tissues. The development and organization of complex organs are far from understood and there is a need to dissect the expression of genes expressed in such tissues using quantitative methods to investigate and determine the genes that control the development and function of such tissues. The organs are a mixture of differentiated cells that enable all bodily functions. Consequently, cell function is dependent on the position of the cell within a particular tissue structure and the interactions it shares with other cells within that tissue, both directly and indirectly. Hence, there is a need to disentangle how these interactions influence each cell within a tissue at the transcriptional level.

Transcripts (i.e., RNA) are a proxy for protein abundance, because the rates of RNA translation and degradation will influence the amount of protein produced from any one transcript. Tissue specificity is derived by precise regulation of protein levels in space and time, and different tissues in the body acquire their unique characteristics by controlling not which proteins are expressed but how much of each protein is produced. Indeed, transcriptome and proteome correlations have been compared demonstrating that the majority of all genes were shown to be expressed. However, global profiling of mRNA in cells representative of the whole transcriptome is hindered by the optical density of transcripts in cells. For example, each mRNA occupies a diffraction limited domain in the image and there are approximately tens to hundreds of thousands of mRNAs per cell, depending on the cell type. Thus, optical crowding prevents mRNAs from being resolved and has impeded implementations of spatial profiling experiments.

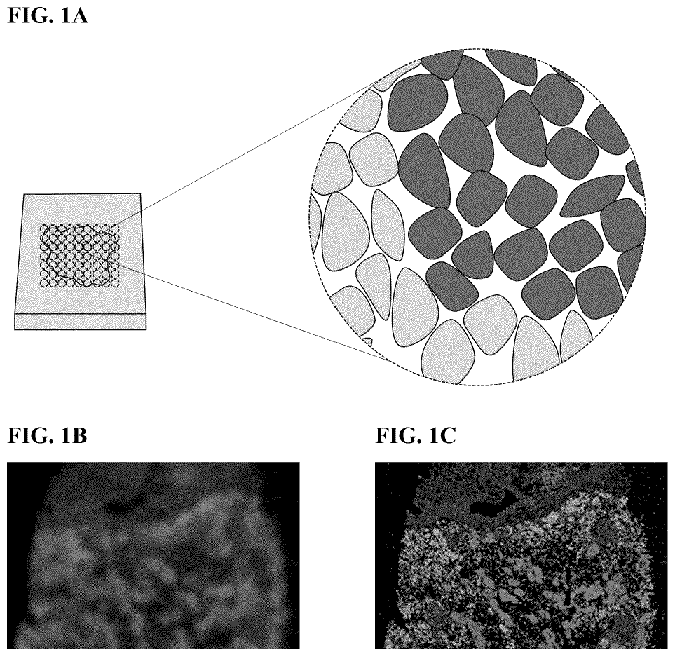

Current approaches using spatial barcoding techniques (e.g., Visium™, Slide_seg™ and Stereo-seq™) aggregate information from a tissue type into capture spots approximately 100 μm in diameter. See for example FIG. 1A. For example, all cells within the barcoded spot area (˜100 um diameter) gets lumped together and assigned a score based on the dominant cell type. Illustrated in FIG. 1A is a tissue sample detected with a typical spatial barcode method, wherein each circle represents a 100 μm patch of barcoded capture oligonucleotides. FIG. 1B illustrates spatial barcoding as applied to a kidney tissue section, where all cells within the barcoded spot area (˜100 um diameter) get lumped together, resulting in features from collecting tubules would be averaged together with reads from distal tubules, and glomeruli would be lumped together with blood vessels and proximal tubules. However, the spot resolution in cellular size does not equal single-cell level. Differing from single-cell sequencing technologies, the spots of the same size and fixed position cannot precisely capture the actual different-sized and randomly located single cells, which partially cover multiple cells in close proximity simultaneously, making spot-based spatial gene expression essentially fail to achieve the single-cell level regardless of spot size. This contrasts with the methods described herein, illustrated in FIG. 1C.

Using existing spatial barcoding techniques, the aggregation of the sequencing reads from the single 100 μm patch blurs the boundary of two distinct cell types, depicted as a light and dark shaded collection of cells, and would incorrectly assign the transcript information from the dominant cell type. These approaches typically yield clusters that primarily consist of groups of transcriptomically similar domains, lacking the ability to establish a clear connection between these clusters and morphological structures within the cell or tissue.

In addressing the aforementioned challenges, disclosed herein is a novel approach that leverages the collective transcriptomic information from clusters of phenotypically similar cells within a defined tissue section. In embodiments, the method includes in two steps designed to enhance read depth and overcome the limitations of current single-cell analysis techniques. At single-cell resolution, the method includes identifying cells that are similar within a neighborhood. For example, utilizing computational algorithms and biomarker analysis, the method initially identifies cells that exhibit similar phenotypic and transcriptomic profiles within their local neighborhood. This step ensures that the aggregation of reads will be representative of specific cell types or states, thus maintaining the biological relevance of the analysis. Following the identification of similar cells (e.g., via a similarity score), the reads of the ensembled cells are aggregated to achieve a collective read depth sufficient for full transcriptome analysis. The method amalgamates the depth of targeted gene panels with the breadth of whole-transcriptome probing. The method not only circumvents the read depth limitations of individual cells but also introduces a novel way to achieve transcriptome-scale insights without the need for extensive methodological alterations or the application of expansion microscopy.

Cellular Neighborhood Niche/Phenotypic similarity at high depth. A neighborhood is the milieu of a cell where its potential biological interactions occur with other cells and extracellular material. For example, a neighborhood of an epithelial cell may include the interstitium with resident stromal and immune cells, matrix, nerves and vasculature. Initially, cells are classified into phenotypically and transcriptomically similar groups within a tissue section, utilizing a gene panel targeting approximately 20-200 selected genes at high depth—e.g., by using a high concentration of probes, and/or using multiple probe targets per gene. Various clustering approaches are contemplated, for example the spatial clustering methods (SpaGCN, SEDR, BayesSpace, DeepST, GraphST, GRAPHDeep, and STAGATE). For example, unsupervised clustering may be performed on the data matrix to identify similar groups of spots, possibly representing distinct cell compositions/states, such as using a Leiden graph-based clustering with a fixed resolution (resolution=0.8). Exploring the cellular neighborhood involves assigning a label to measured spatial profiles (i.e., the abundances of measured molecules at a specific location), usually corresponding to a cell (sub)type or a functional state. The discrete labels are assigned based on known cell-type markers. This classification employs unsupervised clustering techniques such as UMAP and tSNE, or alternative similarity metrics, and may be further refined by incorporating biomarkers or protein detection to further inform a similarity score. Tools, such as Tangram, STELLAR, CellTrek, SPOTlight, robust cell type decomposition (RCTD) mixtures and cell2location, can also be used to infer the cell type identity of cells or spots within tissue. The regions sharing a similarity score (i.e., neighborhoods) could be segmented using known cell-segmentation algorithms and classified by type and/or state, reflecting their distinct cellular identities or states. This classification is paramount, as the condition and role of a cell are often dictated by its milieu and the nature of its interactions with neighboring cells. For example, an approach to derive phenotypic similarity among cells would be to generate a neighborhood graph using joint transcriptional and proteomic profiles, then apply a clustering method to the neighborhood graph. For example, see FIG. 3. The resulting clusters represent phenotypically similar cells, which could then be used in conjunction with spatial location or cell-cell interaction information (see FIG. 4) to guide count aggregation. The fidelity of the clustering can later be visualized by applying UMAP to the neighborhood graph in order to reduce it down to 2-dimensions and overlaying cells colored by their cluster identity onto the UMAP embedding.

Unsupervised clustering is a widely adopted strategy for identifying spatial domains in spatial transcriptomics data. For example, BayesSpace and SpatialPCA employ Hidden-Markov random field to enforce physically proximal cells belonging to the same regions by assigning a higher probability to proximal cells. These algorithms achieve perform well when cell types are well separated, that is the division boundary is very clear. SpaGCN and STAGATE employ graph neural networks to learn the topological structure of cells.

An example of a neighborhood is defined by a radius around a centroid. A cell's centroid is often set as its nucleus to agnostically determine the neighborhood of every cell in the tissue. An alternative approach to identify a neighborhood is to deconvolute the component cell types of each spot using vectors to estimate the identity of the underlying cells. Patterns of cell type and cell state frequency and distribution can be grouped to identify neighborhood clusters of similar cell types using a dimensionality reduction algorithm called uniform manifold approximation and projection (UMAP).

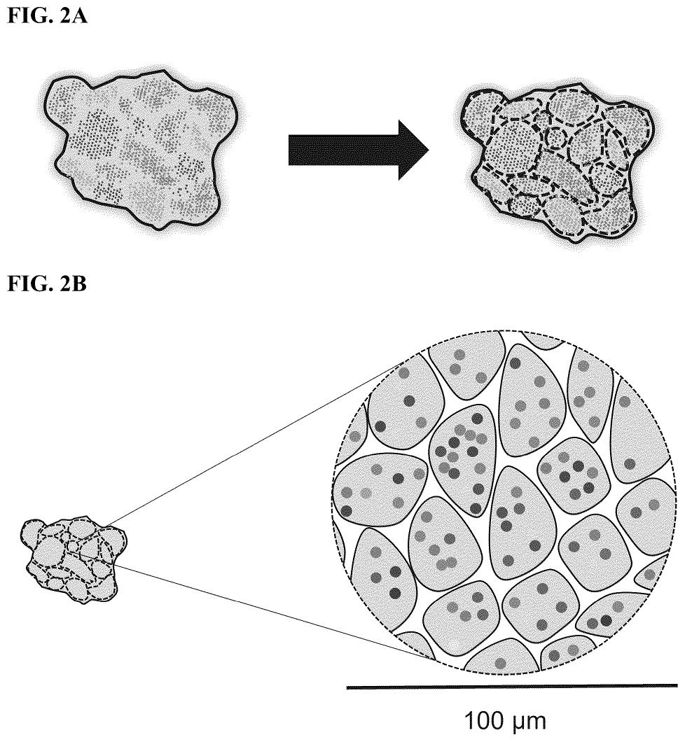

Alternatively, similar cells could be grouped together if they fall within a specified distance for example, about 100 μm. Determining the cellular neighborhood using a high depth gene panel allows for precise identification of cellular neighborhoods, defined by shared gene expression patterns, which can be segmented or grouped by proximity within a specified distance. See for example, FIG. 2A. Visualization tools are Vitessce, Squidpy, and/or Giotto may be used in this regard.

Whole transcriptome at low depth. Concurrently, the entire tissue section is probed for all genes (e.g., using probes for approximately 22,000 genes, referred to as the WT panel) at lower coverage and detect the genes. See for example, FIG. 2B. Collectively, the information gained from the cell classification panel and the whole transcriptome panel enables an in depth understanding of the whole transcriptome of the tissue sample, illustrated in FIG. 2C. While each individual cell might only have about 100 reads using the WT panel, if the reads are summed up for an area of say approximately 100 cells, there would be 10,000 reads for the neighborhood. By aggregating the reads from approximately 100 cells within each identified neighborhood, the necessary depth is achieved for full transcriptome analysis, accumulating around 10,000 reads per neighborhood. This vast improvement over existing methodologies enables us to maintain single-cell resolution while deriving a comprehensive transcriptomic profile from a collective ensemble of similar cells.

As an example WT panel, in embodiments, the WT panel includes approximately 66,000 probes, targeting three sequences per gene. This not only ensures robust coverage but also facilitates the identification of nonspecific or ineffective binding through cross-correlation among targets. To accommodate the extensive probe set without overwhelming cellular capacity, a lower probe concentration is utilized and multiple sequencing primers are implemented (e.g., develop a set of probes using a first sequencing primer, a second set of probes using a second sequencing primer, etc.) to manage imaging density. For example, cells and their surrounding milieu (e.g., a tissue section) are attached to a substrate surface, fixed, and permeabilized. Targeted oligonucleotide probes designed for RNA detection are then annealed to an endogenous nucleic acid (e.g., a mRNA molecule). For example, mRNA is targeted with a set of oligonucleotides targeting one or more regions of interest (e.g., up to 24, or up to 48 regions per gene). In embodiments, each gene is targeted by 6, 9, or 12 different probes. Following hybridization of each oligonucleotide probe, the ends of the probe may be ligated together. Alternatively, the target sequence may be incorporated into the probe by extending the 3′ end with reverse transcriptase such as M-MLV or SSIV RT, to generate an extended oligonucleotide probe including a copy of the target sequence, which may be ligated together to form a circular oligonucleotide. An amplification primer amplifies all circular oligonucleotides in the sample, and subsets of the amplification products are sequentially detected using the appropriate sequencing primer for the subset.

In embodiments, the WT panel uses probes to yield sequence reads with a minimum of 2-base differences (i.e., a Hamming distance), significantly reducing the likelihood of misassignment in 15-base reads, and allowing for a vast combinatorial sequence space that supports precise identification and quantification of transcripts. For example, if generating 15-base reads, about 4¹⁵ (or about 10⁹) different sequences are possible. Instituting a Hamming distance requirement of 2 changes the calculation significantly from simply 415. The Hamming distance of 2 means that any two chosen sequences must differ by at least 2 bases. This constraint reduces the number of valid combinations because not every sequence is allowable; each sequence must be sufficiently different from every other sequence to meet the Hamming distance requirement. The Gilbert-Varshamov bound provides a way to estimate the number of codewords (in this case, sequences) that can exist within a certain Hamming distance. For a sequence space where each position can have one of four possible values (as in DNA sequences), and given a sequence length n and minimum Hamming distance d, the bound can be approximated, but the exact formula can get quite involved. If greater spacing between probes is necessary, another option to further reduce chance of mis-assignment includes extending the read length to 20 bases.

The approach described herein surpasses the capabilities of commercially available platforms (e.g., Visium) by preserving single-cell resolution and accurately reflecting the transcriptomic diversity within tissues. In contrast to Visium, the method described herein eliminates the averaging of dissimilar cells found within the same barcoded spot area, enabling a more nuanced understanding of tissue composition and function. Furthermore, the method offers additional benefits including protein readouts, increased area and throughput, and a simplified workflow, setting a new standard for spatial transcriptomic analysis. By combining high-depth gene analysis with comprehensive whole-transcriptome probing, our approach not only addresses the current limitations in spatial biology research but also opens new avenues for the detailed exploration of cellular function and interaction within complex tissue environments.

### Example 2: Hierarchical Clustering of Neuronal Cell Types Based on Tiered Gene Expression Profiling in Brain Tissue

Performing gene expression analysis in brain tissue helps elucidate the diversity of neuron types based on their transcriptional profiles. For this approach, the tissue sample is contacted with two distinct probe sets. The first probe set comprises oligonucleotide probes designed to selectively bind to 100 gene sequences crucial for neurotransmitter synthesis, receptor expression, and neuronal signaling, including genes (e.g., TH (Tyrosine Hydroxylase), TAC1 (Tachykinin Precursor 1), CHAT (Choline O-Acetyltransferase), SLC6A4 (Serotonin Transporter), GAD1 (Glutamate Decarboxylase 1), MAOA (Monoamine Oxidase A), BDNF (Brain-Derived Neurotrophic Factor), NRG1 (Neuregulin 1), DRD2 (Dopamine Receptor D2), GRIN2B (Glutamate Ionotropic Receptor NMDA Type Subunit 2B), CNR1 (Cannabinoid Receptor 1), HTR2A (5-Hydroxytryptamine Receptor 2A). Consecutively, or simultaneously, a second, more comprehensive probe set that can bind between 5,000 and 12,000 different gene sequences, offering a broader perspective on the cellular transcriptome. The second probe set targets genes not necessarily specific for neurons. Each oligonucleotide probe in both sets hybridizes to its corresponding nucleic acid molecule within the neurons, generating unique signal signatures that reflect the presence and quantity of mRNA for each targeted gene.

The resultant data from both probe sets may be represented as vectors, each containing expression values corresponding to the targeted genes. Grouping this information as vectors may aid to identify transcriptional similarities among neurons. For example, consider three neurons exhibiting the following profiles from the first probe set: Neuron A: [1.2, 0.5, 0.0, . . . , 1.8]; Neuron B: [1.1, 0.4, 0.1, . . . , 1.9]; and Neuron C: [2.5, 2.1, 1.0, . . . , 2.0].

Using clustering algorithms such as k-means or hierarchical clustering, the Euclidean distances or cosine similarities are calculated between each pair of expression vectors. Neurons A and B, displaying smaller distances between their expression profiles, are grouped together suggesting they may represent similar neuron types, possibly excitatory neurons. In contrast, Neuron C, with its significantly different profile, suggests it might be an inhibitory neuron. After initial groupings are determined based on the first probe set, the comprehensive data from the second probe set further refines these groups by adding depth to our understanding of each neuron's transcriptional landscape, enabling the aggregation of the extensive signal signatures within each previously defined group, enhancing the specificity of the analysis.

In addition to transcript similarity, incorporating spatial proximity information can significantly enrich the analysis, particularly in understanding the functional architecture of the brain. By mapping the physical locations of neurons alongside their transcriptional profiles, spatial relationships are explored as to how cellular communication and network dynamics are influenced. For instance, neurons that are closely located and exhibit similar gene expression patterns may form functional clusters that participate in specific neurological processes. This proximity-based grouping could reveal new insights into the structural and functional connectivity of the brain, providing a more holistic view of how neuronal circuits govern behavior and cognitive processes. Utilizing advanced imaging techniques to accurately map neuron locations, combined with our detailed transcriptomic data, enables a comprehensive spatial and molecular analysis that could uncover the principles of neuronal organization and interaction within complex neural networks.

The use of both probe sets not only streamlines the experimental workflow but also enriches the data, enabling a nuanced analysis of gene expression at the group level. The methods described herein allows for the identification of shared transcriptional features and unique gene expression patterns within the groups, providing deeper insights into their functions and interactions within the brain.

### Example 3: Clustering of Epithelial and Immune Cell Interactions Based on Tiered Gene Expression Profiling in Colon Tissue

Conducting transcript expression analysis in colon tissue is pivotal for understanding the interactions between epithelial cells and immune cells. For this approach, one contacts the tissue sample with two distinct probe sets, optionally sequentially, or simultaneously. The first probe set includes oligonucleotide probes designed to selectively bind to 150 to 500 gene sequences for cellular metabolism, adhesion, and immune response, in addition to biomarkers for functional and regulatory pathways, and cell type markers. The targeted genes for the first probe set include genes known to be involved in processes such as adhesion, metabolism, and immune responses: CDH1, TLR4, NFKB1, CTNNB1, ITGAM, PTEN, TP53, GAPDH, STAT3, JUN, ICAM1, VCAM1, CD44, MMP9, CXCL8, IL6, IL1B, TNF, FOXP3, CD4, CD8A, CD19, CD14, HLA-DR, CCL2, CXCR4, CCL5, ARG1, NOS2, PDL1, CTLA4, GSK3B, AKT1, PIK3CA, SOD2, CAT, BCL2, CASP8, FASLG, TRAF6, MAPK14, NFATC1, IRF3, MYD88, SYK, BTK, CD40, CD80, IFNG, IL10, IL2, IL12B, IL17A, IL4, IL23A, IFNA1, IFNB1, TGFBI, SMAD3, PTGS2, COX2, MCP1, RORC, FOXP1, IDO1, GATA3, TBX21, CCR7, CXCL10, CXCL9, CCR5, CD86, ICOS, VDR, HLA-B, HLA-C, HLA-G, PDCD1, CTLA4, TIM3, LAG3, KLRK1, GZMB, PRF1, FAS, TRAIL, TOLLIP, BCL6, AIRE, FOXP2, SOCS1, SOCS3, CASP10, NLRP3, PYCARD, TLR2, SIGLEC8, CCR6, IL13, IL22, IL7, IL9, IL15, IL18, IL27, IL33, TNFSF10, IL21, IL17C, IL22RA1, CD40LG, IL10RA, OSMR, TNFRSF11B, TNFRSF9, ICOSLG, PD1, TIGIT, XCL1, ID02, IL17F, IL1R2, ILIRAP, CCL11, CCL13, CCL17, CCL19, CCL21, CCL22, CXCL5, CXCL11, CXCL12, CX3CL1, LTB, BAFF, APRIL, MICA, MICB, FASLG, TRADD, RIPK1, MLKL, CASP1, NLRP1, AIM2, PYHINI, CARD9, MALT1, BIRC3, and TNIP1.

Various advanced clustering approaches are contemplated, including spatial clustering methods like SpaGCN, SEDR, BayesSpace, DeepST, GraphST, GRAPHDeep, and STAGATE. For instance, unsupervised clustering may be conducted on the data matrix to identify groups of detected biomolecules, potentially representing distinct cell compositions or states, such as employing a Leiden graph-based clustering with a fixed resolution (resolution=0.8) to form a cellular neighborhood of shared characteristics. Exploring the cellular neighborhood involves assigning discrete labels to measured spatial profiles, typically corresponding to a cell (sub)type or a functional state. The labels are assigned based on cell-type markers or detected functional markers. This classification employs sophisticated unsupervised clustering techniques such as UMAP and tSNE, or alternative similarity metrics, and may be further refined by incorporating biomarkers or protein detection to enrich the similarity score. Regions sharing a similarity score, identified as neighborhoods, could be segmented using recognized cell-segmentation algorithms and classified by type and/or state, reflecting their unique cellular identities or states.

A second, more extensive, probe set, capable of binding between 10,000 and 18,000 different gene sequences, targets a broader array of genes, providing a comprehensive view of the cellular transcriptome. The approach ensures that while each individual cell might only yield about 100 reads using the first probe set, aggregating the reads from approximately 100 cells within each previously identified neighborhood allows us to achieve a significant depth. Specifically, for each neighborhood, around 10,000 reads can be accumulated, thereby attaining the necessary depth for a comprehensive transcriptome analysis.

The hybridization of each oligonucleotide probe to its corresponding nucleic acid molecule within the cells generates unique signal signatures. These signatures are then captured and represented as vectors, each containing expression values for the targeted genes. This vector representation forms the basis for constructing a graph where each cell represents a node, and edges between nodes are weighted by similarities in their expression profiles. For example: Epithelial Cell A might exhibit a profile [0.8, 0.7, 0.0, . . . , 1.0], Macrophage B might show [1.5, 1.4, 2.0, . . . , 1.8], and Lymphocyte C could display [1.2, 1.1, 1.5, . . . , 2.0].

Using the Leiden algorithm, this graph can be analyzed to detect communities of cells, optimizing modularity to ensure that cells within the same community (or cluster) have more substantial and denser connections amongst themselves compared to cells in different communities. This method is sensitive to even subtle variations in gene expression, allowing us to discern distinct cellular communities based on their transcriptional profiles. For instance, the Leiden algorithm might identify that Epithelial Cell A and Lymphocyte C, having closer expression profiles, belong to the same community, suggesting potential interaction or co-localization in a specific physiological or pathophysiological context. Conversely, Macrophage B, with its distinctively different expression profile indicative of an active immune response, might be isolated into a separate community, highlighting its role in a different or more acute inflammatory process.

Integrating spatial proximity information into this analysis significantly enriches our understanding, particularly in identifying the functional architecture of the tissue. By mapping the physical locations of these cells alongside their transcriptional profiles, spatial relationships are explored to understand how they influence cellular communication and network dynamics. This proximity-based grouping provides new insights into the structural and functional connectivity of the colon, offering a holistic view of how cellular interactions govern physiological and pathological processes.

### Example 4. Cluster, Group, Re-Cluster

Tissues are typically composed of many cell types (sub-populations) located at various positions to perform corresponding biological functions. Thus, it is of great significance to simultaneously exploit the expression and spatial information of cells, which is the foundation for understanding the underlying mechanisms of biology systems. For example, the combination of expression and spatial information of cells provides an effective strategy to precisely characterize the heterogeneity within a tissue. Single-cell RNA sequencing (scRNA-seq) and in situ RNA detection modalities dramatically advanced our understanding of cellular diversity and functionality within complex biological tissues. These technologies provide high-resolution profiles of gene expression at the individual cell level, facilitating the discovery of novel cell types, states, and lineage dynamics. However, both approaches frequently encounter a common limitation: low transcript counts per cell, which are particularly prevalent in in situ experiments. This issue results in poor signal-to-noise ratios (SNR), which significantly hampers the accurate characterization and classification of cell populations. The challenge is accentuated in heterogeneous tissue samples, where the distinct transcriptomic signatures needed for robust cell identification are often diluted.

While various unsupervised clustering techniques and graph-based models seek to address these data sparsity issues, they still struggle with the inherent limitations of sparse and noisy data sets, leading to less resolved clustering outcomes. Importantly, the spatial context of transcriptomic data, often underutilized in conventional analyses, presents a promising avenue for enhancing cell type classification. This context builds on the biological insight that cells within similar spatial proximities frequently share functional traits. Thereby, a methodological shift towards integrating spatial and transcriptomic information is essential for surmounting the obstacles presented by low transcript abundance in single-cell studies.

To address the challenges of low transcript counts and poor signal-to-noise ratios in single-cell RNA sequencing and in situ RNA detection, a novel computational and methodological strategy is proposed that leverages the spatial proximity and transcriptomic similarity of cells. The approach begins with standard unsupervised clustering to initially group cells based on their baseline transcriptomic profiles. Subsequent to this preliminary grouping, the method introduces a spatially-aware aggregation step, wherein each cell is considered within a defined radius (e.g., 50-100 um) to identify neighboring cells. Only neighbors that exhibit a high degree of similarity in their gene expression profiles, determined through a specific Euclidean distance or other relevant metrics, are selected. The reads from these similar neighboring cells are then aggregated to the target cell, effectively enhancing the transcript data for each analyzed cell. This aggregation not only increases the effective number of reads per cell but also improves the precision of gene expression measurements. For example, the initial clustering analysis may be performed using Seurat V3.2 following standard procedures. In short, data normalization, transformation, and selection of variable genes may be performed using the SCTransform function with default settings. Principal component analysis (PCA) may be performed on the top 150 genes using the RunPCA function, and the first 30 principal components may be used for Shared Nearest Neighbor (SNN) graph construction using the FindNeighbors function. Clusters are identified using the FindClusters function. A Uniform Manifold Approximation and Projection (UMAP) can be used to visualize the data in a reduced two-dimensional space. In embodiments, using the transcript data (i.e., the detected transcripts from the first probe set) a graph is created (e.g., performing graph construction in the resulting embedding space) using the transcript data, then prune the edges based on a spatial distance cutoff or further weight the edges inversely with spatial distance. Alternatively, one could reverse the order of operations as well, that is, create the graph based on spatial data, then refine edges based on transcriptional similarity. Leiden clustering (Traag et al. Sci. Rep. 2019; 9:5233) would be applied on the final graph, although other methods (Louvain, model-based clustering, and k-means) are also provided as options. In embodiments, to capture the spatial structure in the data, we may convert the relative spatial relationship between detected targets into a topological component of the graph G, represented via an undirected matrix A. To accomplish this, we can compute the Euclidean distance dᵢⱼ between targetᵢ and targetⱼ and determine an appropriate threshold 6.

Post-aggregation, the reads are normalized based on the number of contributing cells to maintain proportional expression levels. For handling potential issues arising from non-integer transcript numbers during aggregation, a practical solution involves scaling the transcript counts (e.g., multiplying by a factor of 10) and rounding off, thus simplifying the computational process without significant loss of data integrity. The enriched data sets are then subjected to a second round of clustering, with the expectation of achieving more distinct and biologically meaningful cell population segregation. An iterative tuning process may be integrated, wherein the parameters for spatial and transcriptomic distance thresholds are adjusted dynamically. This iterative refinement helps in fine-tuning the clustering results, ensuring that the expressional profiles of major cell clusters converge effectively, thereby enhancing the overall resolution and clarity of cell type differentiation.

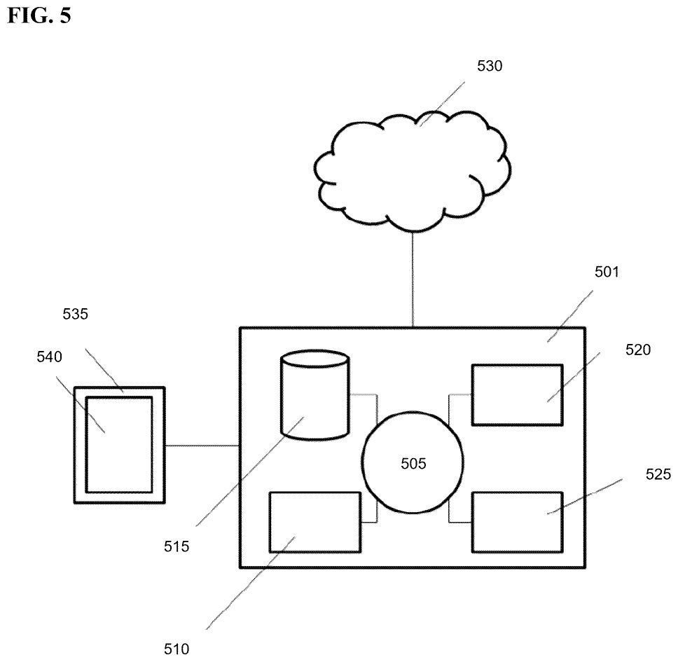

FIG. 5 shows an example computer system that can implement methods provided herein. For example, the present disclosure provides computer systems that are programmed to implement methods of the disclosure. FIG. 5 shows a computer system 501 that is programmed or otherwise configured to analyze a tissue sample including a plurality of cells. The computer system 501 can regulate various aspects of components of the system of the present disclosure. The computer system 501 can be an electronic device of a user or a computer system that is remotely located with respect to the electronic device. The electronic device can be a mobile electronic device.

The computer system 501 includes a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet. The computer system 501 can communicate with one or more remote computer systems through the network 530. For instance, the computer system 501 can communicate with a remote computer system of a user. Examples of remote computer systems include personal computers (e.g., portable PC), slates, or tablets (e.g., Apple® iPad, Samsung® Galaxy Tab), telephones, Smart phones (e.g., Apple® iPhone, Android-enabled device, Blackberry), or personal digital assistants. The user can access the computer system 501 via the network 530.

FIG. 5 shows an example computer system that can implement methods provided herein. For example, the present disclosure provides computer systems that are programmed to implement methods of the disclosure. FIG. 5 shows a computer system 501 that is programmed or otherwise configured to analyze a tissue sample including a plurality of cells. The computer system 501 can regulate various aspects of components of the system of the present disclosure. The computer system 501 can be an electronic device of a user or a computer system that is remotely located with respect to the electronic device. The electronic device can be a mobile electronic device.

The computer system 501 includes a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet.

The computer system 501 can communicate with one or more remote computer systems through the network 530. For instance, the computer system 501 can communicate with a remote computer system of a user. Examples of remote computer systems include personal computers (e.g., portable PC), slates, or tablets (e.g., Apple® iPad, Samsung® Galaxy Tab), telephones, Smart phones (e.g., Apple® iPhone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processor adapted to execute the code, or can be compiled during runtime. The code can be supplied in a programming language that can be selected to enable the code to execute in a pre compiled or as-compiled fashion.

Examples of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk.

“Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media (e.g., computer-readable media) include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535 that comprises a user interface (UI) 540 for tissue sample analysis. Examples of UIs include, without limitation, a graphical user interface (GUI) and web-based user interface. Methods and systems of the present disclosure can be implemented by way of one or more algorithms. An algorithm can be implemented by way of software upon execution by the central processing unit 505.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processor adapted to execute the code, or can be compiled during runtime. The code can be supplied in a programming language that can be selected to enable the code to execute in a pre compiled or as-compiled fashion.

Examples of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk.

As another example, the computer storage media may be implemented using magnetic or optical technology. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

According to certain embodiments, the above-described data feeds may be stored in databases such as database servers that store master data as well as logging and trace information. The databases may also provide an API and/or API access (e.g., for open source) to the web server for data interchange based on JSON specifications. According to certain embodiments, the database servers may be optimally designed for storing large amounts of data, responding quickly to incoming requests, having a high availability and historizing master data.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor (e.g., a processor chip, single/multi-processor architectures, sequential (Von Neumann)/parallel architectures, and specialized circuits, etc.), or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of the present disclosure may provide for a computer program product, including a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Various aspects described herein may be implemented using standard programming and/or engineering techniques to produce software, firmware, hardware, and/or any combination thereof to control a computing device to implement the disclosed subject matter. A computer-readable medium may include, for example: a magnetic storage device such as a hard disk, a floppy disk or a magnetic strip; an optical storage device such as a compact disk (CD) or digital versatile disk (DVD); a smart card; and a flash memory device such as a card, stick or key drive, or embedded component. Additionally, it should be appreciated that a carrier wave may be employed to carry computer-readable electronic data including those used in transmitting and receiving electronic data such as streaming video or in accessing a computer network such as the Internet or a local area network (LAN). Of course, a person of ordinary skill in the art will recognize many modifications may be made to this configuration without departing from the scope or spirit of the claimed subject matter.

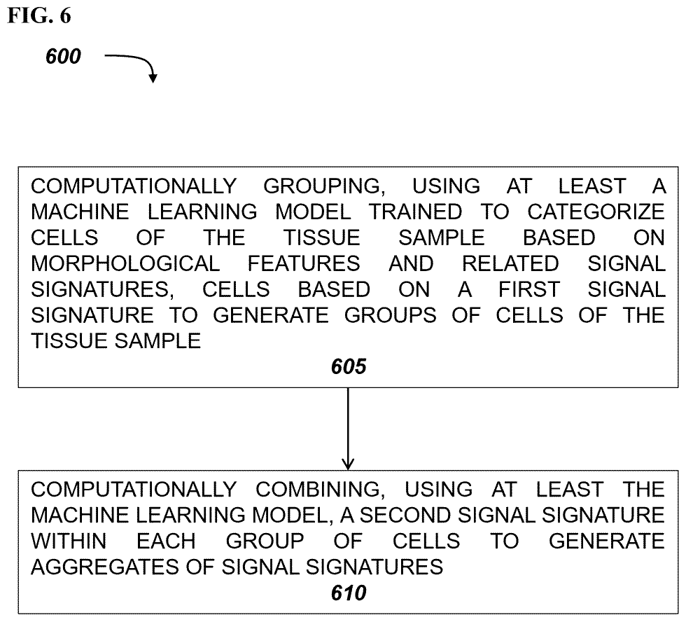

FIG. 6 is a computer implemented method 600 according to aspects of this disclosure. Step 605 of method 600 can include computationally grouping, using at least a machine learning model trained to categorize cells of the tissue sample based on morphological features and related signal signatures, cells based on a first signal signature to generate groups of cells of the tissue sample. Step 610 of method 600 can include computationally combining, using at least the machine learning model, a second signal signature within each group of cells to generate aggregates of signal signatures.

It is also to be understood that the mention of one or more steps of method 600 does not preclude the presence of additional method steps or intervening method steps between those steps expressly identified. Steps of method 600 may be performed in a different order than those described herein without departing from the scope of the disclosed technology.

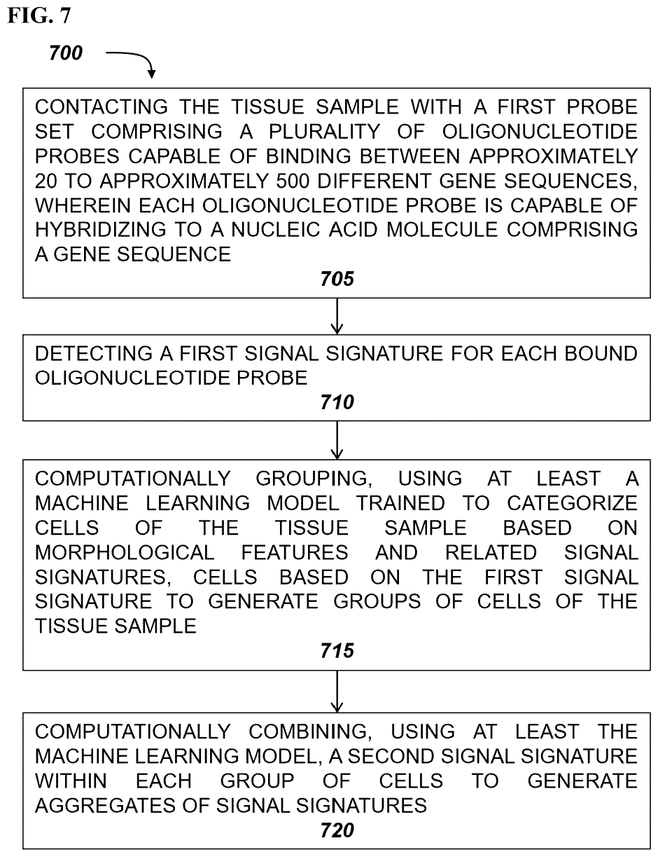

FIG. 7 is a computer implemented method 700 according to aspects of this disclosure. Step 705 of method 700 can include contacting the tissue sample with a first probe set comprising a plurality of oligonucleotide probes capable of binding between approximately 20 to approximately 500 different gene sequences, wherein each oligonucleotide probe is capable of hybridizing to a nucleic acid molecule comprising a gene sequence. Step 710 of method 700 can include detecting a first signal signature for each bound oligonucleotide probe. Step 715 of method 700 can include computationally grouping, using at least a machine learning model trained to categorize cells of the tissue sample based on morphological features and related signal signatures, cells based on the first signal signature to generate groups of cells of the tissue sample. Step 720 of method 700 can include computationally combining, using at least the machine learning model, a second signal signature within each group of cells to generate aggregates of signal signatures.

It is also to be understood that the mention of one or more steps of method 700 does not preclude the presence of additional method steps or intervening method steps between those steps expressly identified. Steps of method 700 may be performed in a different order than those described herein without departing from the scope of the disclosed technology.

Certain embodiments and implementations of the disclosed technology are described above with reference to a block diagram of systems and/or computer program products according to example embodiments or implementations of the disclosed technology. It will be understood that one or more blocks of the block diagram, and combinations of blocks in the block diagrams can be implemented by computer-executable program instructions. Likewise, some blocks of the block diagrams may not necessarily need to be performed all of the functions described herein and may perform additional functions according to some embodiments or implementations of the disclosed technology.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

As discussed herein, “cloud” or “cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As discussed herein, “transmit” may include sending electronic data from one system component to another over a network connection. Additionally, as used herein, “data” may include encompassing information such as commands, queries, files, data for storage, and the like in digital or any other form.

While certain embodiments of the present disclosure have been described in connection with what is presently considered to be the most practical and various embodiments, it is to be understood that the present disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The specific configurations, choice of materials and the size and shape of various elements can be varied according to particular design specifications or constraints requiring a system or method constructed according to the principles of the disclosed technology. Such changes are intended to be embraced within the scope of the disclosed technology. The presently disclosed embodiments, therefore, are considered in all respects to be illustrative and not restrictive. It will therefore be apparent from the foregoing that while particular forms of the disclosure have been illustrated and described, various modifications can be made without departing from the spirit and scope of the disclosure and all changes that come within the meaning and range of equivalents thereof are intended to be embraced therein.

### Example 5. Integration and Clustering of Spatial Transcriptomics and Proteomics Data

Collection of multi-modal, high-dimensional data from spatial platforms offers unique opportunities to correlate spatial organization with cellular state, a capability that is critical for elucidating disease characteristics. In order to extract meaningful biological patterns and signals that inform both hypothesis generation and experimental validation, robust analytical methodologies are required.

In current practice within single-cell RNA sequencing, high-dimensional cell-by-gene count matrices are subjected to clustering on a dimensionally reduced representation. Typically, normalized and log-transformed counts are used to compute principal components. A neighborhood graph is then generated from the pairwise nearest-neighbor distances derived from these principal components. This graph forms the input for two key analytic processes: a two-dimensional embedding for visualization and graph-based clustering for community detection. While there are many algorithms available for these tasks, single cell transcriptomics commonly uses UMAP (Uniform Manifold Approximation and Projection) for visualization and the Leiden community detection algorithm for clustering purposes (McInnes et al., (2018). UMAP: Uniform Manifold Approximation and Projection. Journal of Open Source Software, 3(29), 861; and raag, V. A., Aldecoa, R., & Delvenne, J.-C. (2015). Detecting communities using asymptotical surprise. Physical Review E, 92(2), 022816).

For the purpose of analyzing multi-modal data, the leiden algorithm can be applied to two or more neighborhood graphs that were computed independently for different data modalities of the same set of observations (each graph representing the same vertex set but differing in edge definition) in a process known as multiplex community detection. However, this approach suffers from several drawbacks. First, constructing distinct graphs for different modalities necessitates careful weighting, due to inherent differences in data distributions, and makes it challenging to determine which parameter set yields an optimal clustering result. Second, conventional clustering quality metrics, such as the Silhouette score, rely on low-dimensional Euclidean representations that are not uniformly available across all modalities (Peter J. Rousseeuw (1987). “Silhouettes: a Graphical Aid to the Interpretation and Validation of Cluster Analysis” Computational and Applied Mathematics. 20: 53-65). Consequently, the lack of a unified visual representation complicates the interpretation of the clustering outcomes.

Embodiments of the present invention address these issues by integrating all modalities into a single neighborhood graph, thereby allowing simultaneous community detection and visualization from a unified basis. In one embodiment, UMAP is employed to achieve this integration. UMAP reduces high-dimensional data to an n-dimensional Euclidean space while preserving both local and global relationships within the data. Owing to its capacity to maintain non-linear relationships, UMAP is particularly well suited for integrating disparate modalities provided that appropriate normalization and transformation steps are applied. In this embodiment, each data modality is first normalized and log-transformed; if significant outliers persist, additional scaling may be applied to mitigate their influence. Subsequently, a principal component analysis (PCA) is computed separately for each modality, mirroring standard practices in RNA sequencing workflows, and the resulting PCA scores are concatenated to form a composite dataset. In situations where one modality (for example, the protein data) is of lower resolution or quality, the corresponding PCA values may be weighted lower to ensure that the higher-quality modality dominates the integrated representation.

Two distinct UMAP embeddings are then generated: (1) A two-dimensional embedding dedicated solely to visualization, and (2) an n-dimensional embedding (with exemplary embodiments utilizing, for instance, 50 dimensions) that serves as the basis for graph construction. The neighborhood graph is built using Euclidean distances computed within the UMAP space, and partitioning of this graph is subsequently performed using the Leiden algorithm. The end result is a unified visualization in which cell-to-cell relationships across multiple modalities are represented in a single coordinate system, with unsupervised clustering annotations overlaid to facilitate both qualitative interpretation and quantitative analysis.

Data Preprocessing and Normalization. In embodiments, each data modality is independently normalized, log-transformed, and optionally rescaled to mitigate outlier influence. In embodiments, normalization includes per-cell scaling followed by logarithmic transformation (e.g., log 1p), consistent with standard RNA-seq practices. In embodiments, additional quantile normalization or variance stabilization may be applied to account for heteroscedastic noise in certain modalities.

Dimensionality Reduction via PCA. In embodiments, principal component analysis (PCA) is separately performed on each modality. In embodiments, the number of principal components retained for each modality is user-defined, based on variance-explained thresholds or scree plot criteria. In embodiments, PCA scores from each modality are concatenated into a single feature matrix for downstream embedding. In embodiments, a weighting scheme is applied to each modality's PCA scores prior to concatenation, wherein lower-quality modalities (e.g., noisy protein data) are downweighted to preserve the fidelity of higher-quality modalities.

UMAP Embedding. In embodiments, the composite PCA matrix is subjected to two separate UMAP reductions: (i) A two-dimensional embedding for visualization; (ii0 An n-dimensional embedding (e.g., 50 dimensions) for neighborhood graph construction. In embodiments, the n-dimensional UMAP output preserves both local and global relationships across modalities and is computed using cosine or Euclidean distance metrics.

Construction and Partitioning of Neighborhood Graph. In embodiments, a k-nearest neighbor (kNN) graph is constructed using distances in the high-dimensional UMAP space. In embodiments, the graph is partitioned using the Leiden algorithm, yielding unsupervised clusters that reflect integrated multi-modal similarity.

Visualization and Annotation. In embodiments, the two-dimensional UMAP embedding is annotated with clustering results from the Leiden algorithm to facilitate qualitative interpretation. In embodiments, cluster identities may be projected back onto individual modalities for differential feature analysis (e.g., marker gene identification). In embodiments, the integrated framework described herein generates a range of outputs that facilitate both exploratory data analysis and rigorous downstream inference. These outputs fall into three principal categories: (1) visual embeddings, (2) graph-theoretic data structures, and (3) quantitative annotations.

Low-Dimensional Embeddings. In embodiments, a two-dimensional embedding is produced for visualization, wherein each point corresponds to a single sample or cell, and spatial proximity encodes integrated similarity across all data modalities. In embodiments, the two-dimensional embedding is annotated with cluster assignments, enabling intuitive identification of cell types, states, or sample subgroups. In embodiments, the embedding supports overplotting of metadata attributes (e.g., disease status, batch, cell cycle phase) for quality control and biological interpretation.

High-Dimensional UMAP Embedding. In embodiments, a high-dimensional embedding (e.g., 50D) is output, wherein the coordinates serve as an integrated, non-linear representation suitable for machine learning tasks. In embodiments, this high-dimensional embedding is used to construct a neighborhood graph, where each node represents a cell or sample and each edge represents proximity in the integrated UMAP space. In embodiments, the output includes a weighted adjacency matrix or edge list, wherein each edge has an associated distance or similarity score.

Graph-Based Clustering and Partitioning. In embodiments, the Leiden algorithm outputs a discrete cluster assignment for each cell or sample, which is returned as a categorical vector. In embodiments, these clusters may be mapped back to individual data modalities to identify discriminative features (e.g., differentially expressed genes or proteins). In embodiments, the output includes cluster-level statistics such as cluster sizes, within-cluster variance, silhouette scores or modularity scores.

Quantitative Representations and Export Formats. In embodiments, the outputs are provided in machine-readable formats including .csv or .tsv files for cluster labels and embeddings; and/or .mtx, .h5ad, or .loom formats for graph and expression matrices; and/or JSON or GML files for graph structures. In embodiments, the outputs can be ingested by downstream visualization tools such as Seurat, Scanpy, or Cytoscape for further analysis.

### Numbered Embodiments

Embodiment P1. A method of analyzing a tissue sample comprising a plurality of cells, said method comprising: contacting the tissue sample with a first probe set comprising a plurality of oligonucleotide probes capable of binding between 20 to 500 different gene sequences, wherein each oligonucleotide probe is capable of hybridizing to a nucleic acid molecule comprising a gene sequence, and generating a first signal signature for each bound oligonucleotide probe; computationally grouping cells based on the first signal signature to generate groups of cells; contacting the tissue sample with a second probe set comprising a plurality of oligonucleotide probes capable of binding between 18,000 and 22,000 different gene sequences, wherein each oligonucleotide probe is capable of hybridizing to a nucleic acid molecule comprising a gene sequence, and generating a second signal signature for each bound oligonucleotide probe; and computationally combining the second signal signatures within each group of cells to generate aggregates of signal signatures.

Embodiment P2. The method of Embodiment P1, wherein each group of cells is grouped together based on spatial proximity, metabolic profile, genetic profile, transcriptional similarity, phenotypic similarity, or cell-to-cell interaction similarity.

Embodiment P3. The method of Embodiments P1 or P2, wherein the first probe set further comprises a plurality of protein-specific binding agents.

Embodiment P4. The method of and one of Embodiments P1 to P3, wherein the oligonucleotide probes of the first probe set are capable of binding to nucleic acid molecules comprising a CD3D gene sequence, CD3E gene sequence, CD4 gene sequence, CD8A gene sequence, CD8B gene sequence, CD19 gene sequence, MS4A1 gene sequence, CR2 gene sequence, CDH1 gene sequence, KRT18 gene sequence, KRT8 gene sequence CD14 gene sequence, ITGAM gene sequence, CD33 gene sequence, MPO gene sequence, PECAMI gene sequence, VWF gene sequence, CDH5 gene sequence, CD38 gene sequence, SDC1 gene sequence, PRDM1 gene sequence, FCGR3B gene sequence, ELANE gene sequence, CD68 gene sequence, ADGRE1 gene sequence, HLA-DRA gene sequence, CD163 gene sequence, NCAM1 gene sequence, FCGR3A gene sequence, NCR1 gene sequence, ITGAX gene sequence, IL3RA gene sequence, CLEC4L gene sequence, ACP5 gene sequence, CTSK gene sequence, CALCR gene sequence, ALPL gene sequence, BGLAP gene sequence, TNFSF11 gene sequence, COL2A1 gene sequence, ACAN gene sequence, and/or a SOX9 gene sequence.

Embodiment P5. The method of and one of Embodiments P1 to P3, wherein the first probe set comprises a first subset of oligonucleotide probes comprising a first sequencing primer binding sequence and a second subset of oligonucleotide probes comprising a second sequencing primer binding sequence, wherein the first and second sequencing primer binding sequences are different.

Embodiment P6. The method of and one of Embodiments P1 to P3, wherein the first probe set comprises 2 to 12 different subsets of oligonucleotide probes, wherein each subset of oligonucleotide probes comprises a different sequencing primer binding sequence.

Embodiment P7. The method of Embodiment P3, wherein the protein-specific binding agents are capable of binding to CD3, CD4, CD8, TCR, CD19, CD20, CD21, E-cadherin, cytokeratin, EpCAM, CD14, CD11b, CD33, CD31, von Willebrand factor, VE-cadherin, CD138, Blimp-1, CD15, CD16, myeloperoxidase, elastase, CD68, F4/80, HLA-DR, CD163, CD56, NKp46, CD11c, CD123, HLA-DR, CD207, TRAP, Cathepsin K, calcitonin receptor, alkaline phosphatase, osteocalcin, collagen type II, aggrecan, and/or SOX9.

Embodiment P8. The method of Embodiment P2, wherein each group of cells is grouped together based on cell-to-cell interaction similarity.

Embodiment P9. The method of any one of Embodiments P1 to P8, wherein the protein-specific binding agents each comprise an oligonucleotide moiety covalently attached to the protein-specific binding agent.

Embodiment P10. The method of any one of Embodiments P1 to P9, wherein generating a signal signature comprises hybridizing a fluorescently labeled oligonucleotide to the oligonucleotide probe, or an amplification product thereof, and detecting an emission light from the fluorescently labeled oligonucleotide.

Embodiment P11. The method of any one of Embodiments P1 to P9, wherein generating a signal signature comprises sequencing.

Embodiment P12. The method of any one of Embodiments P1 to P9, wherein generating a signal signature comprises hybridizing a sequencing primer to the oligonucleotide probe, or an amplification product thereof, incorporating a fluorescently labeled nucleotide into the sequencing primer, and detecting an emission light from the fluorescently labeled nucleotide.

Embodiment P13. The method of any one of Embodiments P1 to P9, wherein generating a signal signature comprises detecting a series of fluorescent emissions associated with the first sequence.

Embodiment P14. The method of any one of Embodiments P1 to P13, wherein each oligonucleotide probe comprises a barcode sequence.

Embodiment P15. The method of any one of Embodiments P1 to P14, wherein the tissue comprises liver tissue, kidney tissue, bone tissue, lung tissue, thymus tissue, adrenal tissue, skin tissue, bladder tissue, colon tissue, spleen tissue, or brain tissue.

Embodiment P16. The method of any one of Embodiments P1 to P15, wherein computationally grouping cells based on the first signal signature comprises k-means clustering, hierarchical clustering, dimensionality reduction clustering, or machine learning clustering.

Embodiment P17. A computer-implemented method for analyzing a tissue sample comprising a plurality of cells, the method comprising: (a) receiving data corresponding to a first signal signature generated by contacting the tissue sample with a first probe set comprising a plurality of oligonucleotide probes, wherein each oligonucleotide probe is capable of hybridizing to a nucleic acid molecule comprising one of 20 to 500 different gene sequences; (b) computationally grouping cells based on the first signal signature to generate groups of cells; (c) receiving data corresponding to a second signal signature generated by contacting the tissue sample with a second probe set comprising a plurality of oligonucleotide probes, wherein each oligonucleotide probe is capable of hybridizing to a nucleic acid molecule comprising one of 18,000 to 22,000 different gene sequences; and (d) computationally combining the second signal signatures within each group of cells to generate aggregates of signal signatures.

Embodiment P18. A non-transitory computer-readable medium storing instructions that, when executed by a processor, perform a method for analyzing a tissue sample comprising a plurality of cells, the method comprising: (a) instructing to contact the tissue sample with a first probe set comprising a plurality of oligonucleotide probes that hybridize to nucleic acids corresponding to 20 to 500 gene sequences and generate a first signal signature; (b) instructing to group cells based on the first signal signature to generate groups of cells; (c) instructing to contact the tissue sample with a second probe set comprising a plurality of oligonucleotide probes that hybridize to nucleic acids corresponding to 18,000 to 22,000 gene sequences and generate a second signal signature; and (d) instructing to computationally combine the second signal signatures within each group of cells to generate aggregates of signal signatures.

Embodiment P19. A system for analyzing a tissue sample comprising a plurality of cells, the system comprising: (a) a memory storing instructions; (b) a processor configured to execute the instructions to: i. process data from a first signal signature generated by a first probe set comprising oligonucleotide probes capable of binding between 20 to 500 different gene sequences where each probe hybridizes to a nucleic acid molecule comprising a gene sequence; ii. computationally group cells based on the first signal signature to generate groups of cells; iii. process data from a second signal signature generated by a second probe set comprising oligonucleotide probes capable of binding between 18,000 and 22,000 different gene sequences where each probe hybridizes to a nucleic acid molecule comprising a gene sequence; and iv. computationally combine the second signal signatures within each group of cells to generate aggregates of signal signatures.

Embodiment P20. A method of analyzing a tissue sample comprising a plurality of cells, said method comprising: contacting the tissue sample with a first probe set comprising a plurality of oligonucleotide probes capable of binding between 20 to 500 different gene sequences, wherein each oligonucleotide probe is capable of hybridizing to a nucleic acid molecule comprising a gene sequence, and detecting a first signal signature for each bound oligonucleotide probe; computationally grouping cells based on the first signal signature to generate groups of cells; within each group of cells, computationally grouping cells into subgroups based on a distance between two or more detected signal signatures.

Embodiment P21. The method of Embodiment P20, wherein computationally grouping cells into subgroups comprises graph-based aggregation.

Embodiment P22. The method of Embodiment P20, further comprising iterating the grouping cells into subgroups over a range of distances.

Embodiment P23. The method of Embodiment P20, wherein the range of distances comprises 20 μm to 100 μm.

Embodiment R1. A computer-implemented method for analyzing a tissue sample, comprising: computationally grouping, using a machine learning model, cells based on a first signal signature to generate groups of cells of the tissue sample; and computationally combining, using at least the machine learning model, a second signal signature within each group of cells to generate aggregates of signal signatures.

Embodiment R2. The computer-implemented method of Embodiment R1, wherein the machine learning model trained to categorize cells based on the of the tissue sample based on morphological features and related signal signatures.

Embodiment R3. The computer-implemented method of Embodiments R1 or R2, wherein the machine learning model comprises a graph-based aggregation model comprising at least one graph-based clustering algorithm, wherein the computationally grouping comprises the graph-based aggregation model computationally grouping cells into subgroups using graph-based aggregation.

Embodiment R4. The computer-implemented method of any one of Embodiments R1 to R3, wherein the machine learning model comprises a graph-based aggregation model, and wherein the computationally grouping comprises: identifying similar groups of cells using at least unsupervised clustering on a data matrix; and representing distinct cell compositions and/or distinct cell states, using at least the unsupervised clustering with a fixed resolution.

Embodiment R5. The computer-implemented method of any one of Embodiments R1 to R4, wherein the machine learning model comprises a graph-based aggregation model, and wherein the computationally grouping comprises: generating, using at least joint transcriptional and proteomic profiles of the graph-based aggregation model, a neighborhood graph; and deriving, using at least the graph-based aggregation model, phenotypic similarity among the group of cells by applying at least unsupervised clustering on the neighborhood graph.

Embodiment R6. The computer-implemented method of any one of Embodiments R1 to R5, further comprising: calculating, using at least the machine learning model and at least one clustering algorithm, a Euclidean distance and/or cosine similarities between pairs of expression vectors of a spatial dataset comprising locations of cells of the tissue sample.

Embodiment R7. The computer-implemented method of any one of Embodiments R1 to R6, further comprising: computationally classifying, using at least the machine learning model and one or more unsupervised clustering algorithms, cells of the tissue sample into phenotypically and transcriptomically similar groups within a tissue section; and mapping, using at least the machine learning model, locations of neurons alongside transcriptomically similar groups.

Embodiment R8. The computer-implemented method of any one of Embodiments R1 to R7, wherein the machine learning model computationally groups the cells based on the first signal signature using at least k-means clustering.

Embodiment R9. The computer-implemented method of any one of Embodiments R1 to 8, wherein the machine learning model computationally groups the cells based on the first signal signature using at least unsupervised hierarchical clustering.

Embodiment R10. The computer-implemented method of any one of Embodiments R1 to R9, wherein the machine learning model computationally groups the cells based on the first signal signature using at least unsupervised dimensionality reduction clustering.

Embodiment R11. The computer-implemented method of any one of Embodiments R1 to R10, wherein the machine learning model computationally groups the cells based on the first signal signature using at least machine learning clustering.

Embodiment R12. The computer-implemented method of any one of Embodiments R1 to R11, comprising: receiving data corresponding to the first signal signature generated by contacting the tissue sample with a first probe set comprising a plurality of oligonucleotide probes.

Embodiment R13. The computer-implemented method of Embodiment R12, wherein the plurality of oligonucleotide probes each comprise a barcode sequence.

Embodiment R14. The computer-implemented method of Embodiment R12 or R13, wherein each oligonucleotide probe is capable of hybridizing to a nucleic acid molecule comprising one of approximately 18,000 to approximately 22,000 different gene sequences.

Embodiment R15. The computer-implemented method of Embodiment R12 or R13, wherein each oligonucleotide probe is capable of hybridizing to a nucleic acid molecule comprising one of approximately 20 to approximately 500 different gene sequences.

Embodiment R16. The computer-implemented method of Embodiment R12 or R13, wherein an oligonucleotide probe of the plurality of oligonucleotide probes is capable of binding to nucleic acid molecules comprising a CD3D gene sequence, CD3E gene sequence, CD4 gene sequence, CD8A gene sequence, CD8B gene sequence, CD19 gene sequence, MS4A1 gene sequence, CR2 gene sequence, CDH1 gene sequence, KRT18 gene sequence, KRT8 gene sequence CD14 gene sequence, ITGAM gene sequence, CD33 gene sequence, MPO gene sequence, PECAMI gene sequence, VWF gene sequence, CDH5 gene sequence, CD38 gene sequence, SDC1 gene sequence, PRDM1 gene sequence, FCGR3B gene sequence, ELANE gene sequence, CD68 gene sequence, ADGRE1 gene sequence, HLA-DRA gene sequence, CD163 gene sequence, NCAM1 gene sequence, FCGR3A gene sequence, NCR1 gene sequence, ITGAX gene sequence, IL3RA gene sequence, CLEC4L gene sequence, ACP5 gene sequence, CTSK gene sequence, CALCR gene sequence, ALPL gene sequence, BGLAP gene sequence, TNFSF11 gene sequence, COL2A1 gene sequence, ACAN gene sequence, and/or a SOX9 gene sequence.

Embodiment R17. The computer-implemented method of any one of Embodiments R12 to R16, wherein the first probe set comprises a first subset of oligonucleotide probes comprising a first sequencing primer binding sequence, and a second subset of oligonucleotide probes comprising a second sequencing primer binding sequence, wherein the first and second sequencing primer binding sequences are different.

Embodiment R18. The computer-implemented method of any one of Embodiments R12 to 16, wherein the first probe set comprises 2 to 12 different subsets of oligonucleotide probes, wherein each subset of oligonucleotide probes comprises a different sequencing primer binding sequence.

Embodiment R19. The computer-implemented method of any one of Embodiments R12 to 18, wherein the first probe set further comprises a plurality of protein-specific binding agents capable of binding to CD3, CD4, CD8, TCR, CD19, CD20, CD21, E-cadherin, cytokeratin, EpCAM, CD14, CD11b, CD33, CD31, von Willebrand factor, VE-cadherin, CD138, Blimp-1, CD15, CD16, myeloperoxidase, elastase, CD68, F4/80, HLA-DR, CD163, CD56, NKp46, CD11c, CD123, HLA-DR, CD207, TRAP, Cathepsin K, calcitonin receptor, alkaline phosphatase, osteocalcin, collagen type II, aggrecan, and/or SOX9.

Embodiment R20. The computer-implemented method of any one of Embodiments R12 to R19, wherein the first probe set further comprises a plurality of protein-specific binding agents that each comprise an oligonucleotide moiety covalently attached to the protein-specific binding agent.

Embodiment R21. The computer-implemented method of any one of Embodiments R1 to R20, wherein the computationally grouping cells based on the first signal signature to generate groups of cells of the tissue sample is based at least on one or more of spatial proximity, metabolic profile, genetic profile, transcriptional similarity, phenotypic similarity, and cell-to-cell interaction similarity.

Embodiment R22. The computer-implemented method of any one of Embodiments R1 to R20, wherein the computationally grouping cells based on the first signal signature to generate groups of cells of the tissue sample is based at least on cell-to-cell interaction similarity.

Embodiment R23. The computer-implemented method of any one of Embodiments R1 to R22, wherein the first signal signature or the second signal signature is generated by hybridizing a fluorescently labeled oligonucleotide to the oligonucleotide probe and detecting an emission light from the fluorescently labeled oligonucleotide.

Embodiment R24. The computer-implemented method of any one of Embodiments R1 to R22, wherein the first signal signature and/or the second signal signature is generated by a process that comprises sequencing.

Embodiment R25. The computer-implemented method of any one of Embodiments R1 to R22, wherein the first signal signature and/or the second signal signature is generated by detecting a series of fluorescent emissions associated with the first sequence, wherein each oligonucleotide probe comprises a barcode sequence.

Embodiment R26. The computer-implemented method of any one of Embodiments R1 to R25, wherein the tissue sample comprises liver tissue, kidney tissue, bone tissue, lung tissue, thymus tissue, adrenal tissue, skin tissue, bladder tissue, colon tissue, spleen tissue, or brain tissue.

Embodiment R27. A method of analyzing a tissue sample comprising a plurality of cells, said method comprising: contacting the tissue sample with a first probe set comprising a plurality of oligonucleotide probes capable of binding between approximately 20 to approximately 500 different gene sequences, wherein each oligonucleotide probe is capable of hybridizing to a nucleic acid molecule comprising a gene sequence; detecting a first signal signature for each bound oligonucleotide probe; computationally grouping, using at least a machine learning model trained to categorize cells of the tissue sample based on morphological features and related signal signatures, cells based on the first signal signature to generate groups of cells of the tissue sample; and computationally combining, using at least the machine learning model, a second signal signature within each group of cells to generate aggregates of signal signatures.

Embodiment R28. The method of Embodiment R27, wherein the machine learning model comprises a graph-based aggregation model comprising at least one graph-based clustering algorithm, wherein the computationally grouping comprises the graph-based aggregation model computationally grouping cells into subgroups using graph-based aggregation.

Embodiment R29. The method of Embodiment R27, further comprising iterating the groups of cells into subgroups over a range of distances.

Embodiment R30. The method of Embodiment R29, wherein the range of distances is between approximately 20 μm to approximately 100 μm.

Embodiment R31. A computer-implemented method for analyzing a tissue sample, comprising: clustering, using at least a machine learning model, cells based on a first signal signature to generate groups of cells of the tissue sample; and computationally combining, using at least the machine learning model, a second signal signature within each group of cells to generate aggregates of signal signatures.

Embodiment R32. The computer-implemented method of Embodiment R31, wherein the machine learning model is trained to categorize cells of the tissue sample based on morphological features and related signal signatures.

Embodiment R33. The computer-implemented method of Embodiments R31 or R32, further comprising: calculating, using at least the machine learning model and at least one clustering algorithm, a Euclidean distance and/or cosine similarities between pairs of expression vectors of a spatial dataset comprising locations of cells of the tissue sample.

Embodiment R34. A non-transitory computer-readable medium storing instructions that, when executed by a processor, perform a method for analyzing a tissue sample, the method comprising: computationally grouping, using at least a machine learning model, cells based on a first signal signature to generate groups of cells of the tissue sample; and computationally combining, using at least the machine learning model, a second signal signature within each group of cells to generate aggregates of signal signatures.

Embodiment R35. The non-transitory computer-readable medium of Embodiment R34, wherein the machine learning model is trained to categorize cells of the tissue sample based on morphological features and related signal signatures.

Embodiment R36. A system for analyzing a tissue sample, the system comprising: (a) a memory storing instructions; (b) a processor configured to execute the instructions to: computationally grouping, using at least a machine learning model, cells based on a first signal signature to generate groups of cells of the tissue sample; and computationally combining, using at least the machine learning model, a second signal signature within each group of cells to generate aggregates of signal signatures.

Embodiment R37. The system of Embodiment R36, wherein the machine learning model is trained to categorize cells of the tissue sample based on morphological features and related signal signatures.

Embodiment R38. A computer-implemented method for analyzing a tissue sample, comprising: computationally classifying, using at least a machine learning model, cells of the tissue sample into phenotypically and transcriptomically similar groups within a tissue section; utilizing a gene panel targeting approximately 20-200 selected genes using multiple probe targets per gene; and assigning, using at least the machine learning model, a label to measured spatial profiles at a location and corresponding to a cell type or a functional state.

Embodiment R39. The computer-implemented method of Embodiment R38, wherein the machine learning model is trained to categorize cells of the tissue sample based on morphological features and using one or more unsupervised clustering algorithms.

Embodiment R40. The computer-implemented method of Embodiment R38, further comprising: generating, using at least the machine learning model and the classified phenotypically and transcriptomically similar groups, a neighborhood graph.

Embodiment R41. The computer-implemented method of Embodiment R38, further comprising: mapping, using at least the machine learning model, locations of neurons alongside transcriptomically similar groups.

What is claimed is:

1. A computer-implemented method for analyzing electronic images of a tissue sample, comprising:
computationally grouping, using a machine learning model, cells based on a first signal signature to generate groups of cells of the tissue sample; and
computationally combining, using at least the machine learning model, a second signal signature within each group of cells to generate aggregates of signal signatures.

2. The computer-implemented method of claim 1, wherein the machine learning model is trained to categorize cells of the issue sample based on morphological features and related signal signatures.

3. The computer-implemented method of claim 1, wherein computationally grouping cells based on the first signal signature comprises the machine learning model using image analysis to quantify morphological features of the cells.

4. The computer-implemented method of claim 1, wherein a training dataset of the machine learning model comprises labeled cellular images with a plurality of morphological features.

5. The computer-implemented method of claim 4, wherein the morphological features comprise at least one of spatial proximity, geometric analysis, topological analysis, cluster density, connectivity within a defined radius, irregularities in cellular shape and/or size, membrane roughness, cytoplasmic texture, nucleus-to-cytoplasm ratio.

6. The computer-implemented method of claim 1, wherein the machine learning model comprises a graph-based aggregation model comprising at least one graph-based clustering algorithm, wherein the computationally grouping comprises the graph-based aggregation model computationally grouping cells into subgroups using graph-based aggregation.

7. The computer-implemented method of claim 1, wherein the machine learning model comprises a graph-based aggregation model, and wherein the computationally grouping comprises:
identifying similar groups of cells using at least unsupervised clustering on a data matrix; and representing distinct cell compositions and/or distinct cell states, using at least the unsupervised clustering with a fixed resolution.

8. The computer-implemented method of claim 1, wherein the machine learning model comprises a graph-based aggregation model, and wherein the computationally grouping comprises:
generating, using at least joint transcriptional and proteomic profiles of the graph-based aggregation model, a neighborhood graph; and
deriving, using at least the graph-based aggregation model, phenotypic similarity among the group of cells by applying at least unsupervised clustering on the neighborhood graph.

9. The computer-implemented method of claim 1, further comprising calculating, using at least the machine learning model and at least one clustering algorithm, a Euclidean distance and/or cosine similarities between pairs of expression vectors of a spatial dataset comprising locations of cells of the tissue sample.

10. The computer-implemented method of claim 1, further comprising:
computationally classifying, using at least the machine learning model and one or more unsupervised clustering algorithms, cells of the tissue sample into phenotypically and transcriptomically similar groups within a tissue section; and
mapping, using at least the machine learning model, locations of neurons alongside transcriptomically similar groups.

11. The computer-implemented method of claim 1, further comprising:
computationally classifying, using at least the machine learning model, a similarity score, and a segmentation algorithm, cells of the tissue sample into segmented phenotypically similar groups.

12. The computer-implemented method of claim 1, wherein the machine learning model computationally groups the cells based on the first signal signature using at least k-means clustering.

13. The computer-implemented method of claim 1, wherein the machine learning model computationally groups the cells based on the first signal signature using at least unsupervised hierarchical clustering.

14. The computer-implemented method of claim 1, wherein the machine learning model computationally groups the cells based on the first signal signature using at least unsupervised dimensionality reduction clustering.

15. The computer-implemented method of claim 1, wherein the machine learning model computationally groups the cells based on the first signal signature using at least machine learning clustering.

16. A computer-implemented method for analyzing electronic images a tissue sample, comprising:
clustering, using at least a machine learning model trained to categorize cells of the tissue sample based on morphological features and related signal signatures, cells based on a first signal signature to generate groups of cells of the tissue sample; and
computationally combining, using at least the machine learning model, a second signal signature within each group of cells to generate aggregates of signal signatures.

17. The computer-implemented method of claim 16, further comprising:
calculating, using at least the machine learning model and at least one clustering algorithm, a Euclidean distance and/or cosine similarities between pairs of expression vectors of a spatial dataset comprising locations of cells of the tissue sample.

18. The computer-implemented method of claim 16, further comprising:
computationally classifying, using at least the machine learning model, a similarity score, and a segmentation algorithm, cells of the tissue sample into segmented phenotypically similar groups.

19. The computer-implemented method of claim 16, wherein the morphological features comprise at least one of spatial proximity, geometric analysis, topological analysis, cluster density, connectivity within a defined radius, irregularities in cellular shape and/or size, membrane roughness, cytoplasmic texture, nucleus-to-cytoplasm ratio.

20. The computer-implemented method of claim 16, wherein the computationally grouping cells based on the first signal signature comprises the machine learning model using image analysis to quantify morphological features of the cells.

21. The computer-implemented method of claim 16, wherein a training dataset of the machine learning model comprises labeled cellular images with a plurality of morphological features.

22. A non-transitory computer-readable medium storing instructions that, when executed by a processor, perform a method for analyzing a tissue sample, the method comprising:
computationally grouping, using at least a machine learning model trained to categorize cells of the tissue sample based on morphological features and related signal signatures, cells based on a first signal signature to generate groups of cells of the tissue sample; and
computationally combining, using at least the machine learning model, a second signal signature within each group of cells to generate aggregates of signal signatures.

23. The non-transitory computer-readable medium of claim 22, wherein the morphological features comprise at least one of spatial proximity, geometric analysis, topological analysis, cluster density, connectivity within a defined radius, irregularities in cellular shape and/or size, membrane roughness, cytoplasmic texture, nucleus-to-cytoplasm ratio.

24. The non-transitory computer-readable medium of claim 22, wherein the computationally grouping cells based on the first signal signature comprises the machine learning model using image analysis to quantify morphological features of the cells.
